(19) United States
(12) Patent Application Publication
(10) Pub. No.: US 2018/0285936 A1
(43) Pub. Date: Oct. 4, 2018

(54) INTELLIGENT VISUAL OBJECT MANAGEMENT SYSTEM

(71) Applicant: Swoup, LLC, New York, NY (US)

(72) Inventors: Philip M. Parrotta, JR., New York, NY (US); Aletia Trakakis, Nicosia (CY); Nikolas Kairinos, Limassol (CY)

(73) Assignee: Swoup, LLC, New York, NY (US)

(21) Appl. No.: 15/933,170

(22) Filed: Mar. 22, 2018

Related U.S. Application Data
(60) Provisional application No. 62/474,968, filed on Mar. 22, 2017.

(51) Int. Cl. G06Q 30/02; G06F 3/0484; G06Q 30/06; G06F 3/01

(52) U.S. Cl. CPC G06Q 30/0269; G06F 3/04842; G06Q 30/0256; G06Q 30/0229; G06F 3/017; G06Q 30/0643

(57) ABSTRACT

The inventors have recognized that improved management systems are required for visual objects. Stated broadly, various aspects and embodiments are directed to systems and methods for aggregating, curating, organizing, executing, and exchanging visual objects. Some embodiments relate to modeling user behavior and analyzing user behavior to drive more efficient processing involving visual objects. Other aspects include automatically monitoring user actions to build and maintain a continuously evolving, and more accurate data model of a user's visual object preferences. Additionally, various aspects relate to systems and methods for integration with third party services that allow users to automatically capture differences resulting from activation of visual objects.

### RELATED APPLICATIONS

This application claims priority under 35 U.S.C. § 119(e) to U.S. Provisional Application Ser. No. 62/474,968 filed on Mar. 22, 2017, which is herein incorporated by reference in its entirety.

### BACKGROUND

Various conventional systems attempt to provide simplified management operations. Unfortunately, many conventional approaches fail to address a number of shortcomings.

### SUMMARY

According to various embodiments, external computer systems use visual objects to modify execution of operations. Visual objects can be collected, stored, and then activated at the time of an operation to apply the modification to the operation. Visual objects can be provided by external computer systems to user computing devices. Visual objects can also be searched in databases online, or from physical sources.

According to some aspects, the inventors have recognized that improved management systems are required for visual objects. Stated broadly, various aspects and embodiments are directed to systems and methods for aggregating, curating, organizing, executing, and exchanging visual objects. Some embodiments relate to modeling user behavior and analyzing user behavior to drive more efficient processing involving visual objects and their execution. Other aspects include automatically monitoring user actions to build and maintain a continuously evolving, and more accurate data model of a user's visual object preferences. Additionally, various aspects relate to systems and methods for integration with third party systems that allow users to automatically capture differences resulting from activation of visual objects.

Various embodiments provide an intelligent visual object management system that can be configured to generate a model of a user for use in matching one or more visual objects to the user. In some embodiments, the intelligent visual object management system includes an artificial intelligence/machine learning system for matching the visual object(s) to a user of a computing device. The artificial intelligence/machine learning system may also be referred to as “machine learning system” herein. The system can be configured to determine a test variable for a visual object for display on the computing device. The visual object management system can be configured to incorporate internal factor parameters, external factor parameters, and/or cognitive parameters for matching the visual object(s) to the user.

In some embodiments, the intelligent visual object management system provides a user interface that enables real time tracking of user actions that previously could not be tracked with detail and accuracy. Various conventional systems fail to track information about one or more visual objects that a user does not interact with. In some embodiments, the system can be configured to use stored tracking data about the user and apply the tracking data algorithmically to further execution. In some embodiments, the system is configured to train a machine learning system (e.g., an artificial intelligence or machine learning model of the machine learning system) using data collected, update the machine learning system using data, and execute the machine learning system to dynamically match visual objects to a user for display in a user interface shown to a user. In matching the visual object(s) to the user, the system can be configured to input information about a respective visual object to the machine learning system to determine values of the internal factor parameters, external factor parameters, and/or cognitive parameters. The system can be configured to use the values of the parameters to calculate a value of the test variable according to which the system can match the visual object to the user. Various conventional systems fail to tie internal factors, external (e.g., to the system) factors, and cognitive parameters to a dynamic model that can be executed by the system to select objects for display in the user interface. The conventional systems, in turn, are unable to use these factors to make determinations with respect to visual objects.

According to one aspect, a system is provided. The system comprises: at least one processor; an analytics component, executed by the at least one processor, configured to: receive at least one user selection of at least one visual object displayed on a client device, wherein the at least one visual object is configured to: detail a modification to an operation; and trigger application of the modification to the operation responsive to being activated; generate a model for identifying visual objects to display on the client device based on the at least one user selection; an execution component, executed by the at least one processor, configured to: map the selected at least one visual object to an operation between the client device and a first computer system to trigger activation of the at least one visual object; receive, from the first computer system, operation data after the activation of the at least one visual object; dynamically determine, using the operation data, a difference between an original execution of the operation and the modified execution of the operation; and transmit, to a second computer system, program instructions that, when executed by the second computer system, trigger capturing of the difference based on the modified execution.

According to one embodiment, the system further comprises a user interface component, executed by the at least one processor, configured to: generate a user interface screen on the display of the client device showing the at least one visual object; and receive the at least one user selection via the user interface screen. According to one embodiment, the at least one processor is configured to store the at least one visual object in a data store responsive to receiving the at least one user selection. According to one embodiment, the system further comprises a networking component, executed by the at least one processor, configured to: receive, from the client device, a user input triggering communication of a visual object to a second user; and communicating the visual object to a second client device responsive to receiving the request. According to one embodiment, the at least one processor is configured to receive a communication indicating a visual object communicated from a second client device. According to one embodiment, the at least one processor is configured to store an identification of a user data profile associated with the first computer system. According to one embodiment, the at least one processor is configured to store a mapping of the at least one visual object to the user data profile associated with the first computer system. According to one embodiment, mapping the selected at least one visual object to the operation to trigger activation of the at least one visual object comprises: mapping the at least one visual object to the operation based on the stored mapping of the at least one visual object to the user data profile associated with the first computer system. According to one embodiment, the execution component is further configured to communicate, to the first computer system, information identifying the mapping of the at least one visual object to the user data profile associated with the first computer system.

According to another aspect, at least one non-transitory computer readable medium storing processor-executable instructions is provided. The instructions when executed by at least one processor cause the at least one processor to perform a method comprising: receiving at least one user selection of at least one visual object displayed on a client device, wherein the at least one visual object is configured to: detail a modification to an operation; and trigger application of the modification to the operation responsive to being activated; generating a model for identifying visual objects to display on the client device based on the at least one user selection; mapping the selected at least one visual object to an operation between the client device and a first computer system to trigger activation of the at least one visual object; receiving, from the first computer system, operation data after the activation of the at least one visual object; dynamically determining, using the operation data, a difference between an original execution of the operation and the modified execution of the operation; and transmitting, to a second computer system, program instructions that, when executed by the second computer system, trigger capturing of the difference based on the modified execution.

According to one embodiment, the method further comprises storing an identification of a user data profile associated with the first computer system. According to one embodiment, the method further comprises storing a mapping of the at least one visual object to the identification of the user data profile associated with the first computer system. According to one embodiment, mapping the selected at least one visual object to the operation to trigger activation of the at least one visual object comprises: mapping the at least one visual object to the operation based on the stored mapping of the at least one visual object to the user data profile associated with the first computer system. According to one embodiment, the method further comprises communicating, to the first computer system, information identifying the mapping of the at least one visual object to the user data profile associated with the first computer system.

According to another aspect, a computer-implemented method is provided. The method comprises: receiving at least one user selection of at least one visual object displayed on a client device, wherein the at least one visual object is configured to: detail a modification to an operation; and trigger application of the modification to the operation responsive to being activated; generating a model for identifying visual objects to display on the client device based on the at least one user selection; mapping the selected at least one visual object to an operation between the client device and a first computer system to trigger activation of the at least one visual object; receiving, from the first computer system, operation data after the activation of the at least one visual object; dynamically determining, using the operation data, a difference between an original execution of the operation and the modified execution of the operation; and transmitting, to a second computer system, program instructions that, when executed by the second computer system, trigger capturing of the difference based on the modified execution.

According to one embodiment, the method further comprises storing an identification of a user data profile associated with the first computer system. According to one embodiment, the method further comprises storing a mapping of the at least one visual object to the identification of the user data profile associated with the first computer system. According to one embodiment, mapping the selected at least one visual object to the operation to trigger activation of the at least one visual object comprises: mapping the at least one visual object to the operation based on the stored mapping of the at least one visual object to the user data profile associated with the first computer system. According to one embodiment, the method further comprises communicating, to the first computer system, information identifying the mapping of the at least one visual object to the user data profile associated with the first computer system. According to one embodiment, the method further comprises generating a user interface screen on a display of the client device showing the at least one visual object; and receiving the at least one user selection via the user interface screen.

According to another aspect, a system is provided. The system comprises: at least one processor; a user interface component, executed by the at least one processor, configured to: generate a first user interface screen configured to: display a visual object to a user, wherein the visual object details a modification to an operation and triggers application of the modification to the operation; receive a first user input to store the visual object in a data store associated with the user; dynamically generate a first movement of the visual object in the first user interface screen responsive to receiving the first user input; receive a second user input to discard the visual object; dynamically generate a second movement of the visual object in the first user interface screen responsive to receiving the second user selection; receive a third user input to transmit the visual object to communicate the visual object to a recipient; and dynamically generate a third movement of the visual object in the first user interface screen responsive to receiving the third user selection.

According to one embodiment, the first user interface screen is configured to display a second visual object in the first user interface screen responsive to receiving the first, or third inputs. According to one embodiment, the user interface component is configured to generate a second user interface screen responsive to the second user input, the second user interface screen configured to: display one or more selectable identifiers, each of the one or more identifiers associated with a user; and receive a selection of one of the one or more selectable identifiers. According to one embodiment, the first user interface screen is configured to: display a filter button in the first user interface screen; and display a plurality of selectable filter type options on the first user interface screen responsive to a selection of the button. According to one embodiment, the user interface component is configured to generate a third user interface screen configured to: display a list of a set of visual objects stored in the data store associated with the user. According to one embodiment, the third user interface screen is configured to: receive a user selection of a visual object in the list of the set of visual objects; and dynamically display a selectable option to share the selected visual object responsive to the user selection of the visual object. According to one embodiment, wherein the third user interface screen is configured to: display a plurality of selectable filter options; receive a selection of one of the plurality of filter options; and dynamically display a subset of the set of visual objects stored in the data store responsive to the selection. According to one embodiment, the third user interface screen is configured to: display an estimated sum value, the estimated sum value indicating a sum of differences that would result from application of all visual objects stored in the subset of visual objects. According to one embodiment, the user interface component is configured to generate a fourth user interface screen configured to: display an estimated sum value, the estimated sum value indicating a sum of differences that would result from application of all visual objects stored in the data store associated with the user; and display a total sum of differences resulting from prior application of one or more modifications by one or more visual objects. According to one embodiment, the user interface component is configured to generate a fourth user interface screen configured to display one or more discarded visual objects. According to one embodiment, the first user input comprises a swipe to the right; the second user input comprises a swipe up; and the third user input comprises a swipe to the left.

According to another aspect, a computer-implemented method is provided. The method comprises: generating, by at least one processor, a first user interface screen in a display of a client device; displaying, in the first user interface screen, a visual object to a user, wherein the visual object details a modification to an operation and applies the modification to the operation in response to activation; receiving, via the first user interface screen, a first user input to store the visual object in a data store associated with the user; generating a first movement of the visual object in the first user interface screen responsive to receiving the first user input; receiving, via the first user interface screen, a second user input to discard the visual object; generating a second movement of the visual object in the first user interface screen responsive to receiving the second user input to discard the visual object; receiving, via the first user interface screen, a third input to communicate the visual object to a recipient; and generating a third movement of the visual object in the first user interface screen responsive to receiving the third user selection.

According to one embodiment, the method further comprises displaying a second visual object in the first user interface screen responsive to receiving the first or third inputs. According to one embodiment, the method further comprises generating a second user interface screen responsive to the second user input; displaying one or more selectable identifiers, each of the one or more selectable identifiers associated with a recipient; and receiving a user input specifying a selection of one of the one or more identifiers to communicate the visual object to a recipient associated with the selected identifier. According to one embodiment, the method further comprises displaying a selectable filter button in the first user interface screen; and displaying a plurality of selectable filter type options on the first user interface screen responsive to selection of the filter button. According to one embodiment, the method further comprises generating a third user interface screen; and displaying a list of a set of visual objects stored in the data store associated with the user in the third user interface screen. According to one embodiment, the method further comprises receiving a user selection of a visual object in the list of the set of visual objects; and dynamically displaying a selectable option to share the selected visual object responsive to the user selection of the visual object. According to one embodiment, the method further comprises displaying a plurality of selectable filter options; receiving a selection of one of the plurality of filter options; and displaying a subset of the set of visual objects in the data store responsive to the selection of the filter option.

According to another aspect, at least one non-transitory computer readable medium storing processor-executable instructions is provided. The instructions when executed by at least one processor cause the at least one processor to perform a method comprising: generating, by at least one processor, a first user interface screen in a display of a client device; displaying, in the first user interface screen, a visual object to a user, wherein the visual object details a modification to an operation and applies the modification to the operation in response to activation; receiving, via the first user interface screen, a first user input to store the visual object in a data store associated with the user; generating a first movement of the visual object in the first user interface screen responsive to receiving the first user input; receiving, via the first user interface screen, a second user input to discard the visual object; generating a second movement of the visual object in the first user interface screen responsive to receiving the second user input to discard the visual object; receiving, via the first user interface screen, a third input to communicate the visual object to a recipient; and generating a third movement of the visual object in the first user interface screen responsive to receiving the third user selection.

According to one embodiment, the method further comprises displaying a second visual object in the first user interface screen responsive to receiving the first or third inputs.

According to another aspect, a machine learning system for generating and applying test variables for client matching is provided. The machine learning system is configured to: determine a value of a test variable correlated to a user of a computing device for a visual object for display, the determining comprising: calculating a value of an external factor parameter, the external factor parameter equal to a count variable multiplied by a square root of a sum of a plurality of variables, the plurality of variables including a generation variable, an identification variable, a stage variable, and a region variable; calculating a value of an internal factor parameter, the internal factor parameter equal to a sum of a plurality of variables divided by a distance variable, the plurality of variables including a semantic variable, a classification variable multiplied by a communication variable, and at least one third party variable; calculating a value of a cognitive parameter, the cognitive parameter equal to a sum of a plurality of variables including an event variable, a product of a face variable and a semantic variable, and a character variable; and calculating the value of the test variable using the values of the external factor parameter, the internal factor parameter, and the cognitive parameter; and communicate the visual object to a user computing device for displaying responsive to the value of the test variable exceeding a threshold.

According to another aspect, a machine learning system for generating and applying test variables for client matching is provided. The machine learning system is configured to: determine a value of a test variable correlated to a user of a computing device for a visual object for display, the determining comprising: calculating a value of a cognitive parameter based on a plurality of variables including an event variable, a face variable, a semantic variable, and a character variable; and calculating the value of the test variable using the value of the cognitive parameter; and communicate the visual object to a user computing device for displaying responsive to the value of the test variable exceeding a threshold.

According to one embodiment, the machine learning system is further configured to determine the event variable based on a status of one or more event indicators. According to one embodiment, the machine learning system is further configured to determine the face variable based on a reward associated with activation of the visual object for display. According to one embodiment, the machine learning system is further configured to determine the semantic variable based on weights associated with one or more keywords. According to one embodiment, the machine learning system is further configured to determine the character variable based on correlation of characters to one or more visual object activations by the user. According to one embodiment, the machine learning system is further configured to set the value of the cognitive parameter to a sum of a first plurality of variables including the event variable, a product of the face variable and the semantic variable, and the character variable.

According to another aspect, a machine learning system for generating and applying test variables for client matching is provided. The machine learning system is configured to: determine a value of a test variable correlated to a user of a computing device for a visual object for display, the determining comprising: calculating a value of an internal factor parameter based on a plurality of variables including a distance variable, a semantic variable, a classification variable, a communication variable, and a third party variable; and calculating the value of the test variable using the calculated value of the internal factor parameter; and communicate the visual object to a user computing device for displaying responsive to the value of the test variable exceeding a threshold.

According to one embodiment, the machine learning system is further configured to determine the distance variable based on a distance between a location associated with a respective user and a location associated with execution of a visual object. According to one embodiment, the machine learning system is further configured to determine the semantic variable based on a correlation of textual information in a dynamic database. According to one embodiment, the machine learning system is further configured to determine the classification variable based on a class associated with the visual object. According to one embodiment, the machine learning system is further configured to determine the communication variable based on a communication trigger setting. According to one embodiment, the machine learning system is further configured to set the value of the internal factor parameter to a sum of a first plurality of variables divided by a distance variable, the first plurality of variables including the semantic variable, the classification variable multiplied by the communication variable, and the third party variable. According to one embodiment, determining the value of the test variable further comprises: calculating a value of an external factor parameter, the external factor parameter based a count variable, a generation variable, an identification variable, a stage variable, and a region variable; and calculating the value of the test variable using the calculated value of the external factor parameter. According to one embodiment, the machine learning system is further configured to determine the count variable based on a frequency of activation of the visual object for display. According to one embodiment, the machine learning system is further configured to determine the generation variable based on a correlation of generation information in a data profile of the respective user to information in a data profile of the visual object for display. According to one embodiment, the machine learning system is further configured to determine the identification variable based on a correlation of identity information in the data profile of the respective user to information in a data profile of the visual object for display. According to one embodiment, the machine learning system is further configured to determine the stage variable based on correlation of stage information in a data profile of the respective user to information in the data profile of the visual object for display. According to one embodiment, the machine learning system is further configured to set the value of the external factor parameter to a count variable multiplied by a square root of a sum of a second plurality of variables, the second plurality of variables including the generation variable, the identification variable, the stage variable, and the region variable.

Other aspects, embodiments and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment. References to “an embodiment,” “an example,” “some embodiments,” “some examples,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. The appearances of such terms herein are not necessarily all referring to the same embodiment or example.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a block diagram of an example environment for automated visual object interactions;

FIG. 2 is a flow diagram illustrating an example process for capturing a difference from activation of one or more visual objects;

FIG. 3 is a flow diagram illustrating a process for selecting third parties to receive earned savings;

FIG. 4 is a data flow diagram illustrating data flow between various entities;

FIG. 5 is a flow diagram of an process of triggering activation of a visual object during an operation with another computer system;

FIG. 6 is a flow chart of an process according to which a system can process a visual object based on user inputs in a dynamic user interface;

FIG. 7 is a flow diagram illustrating a by which a system can be configured to store a value associated with a keyword;

FIG. 8 is a data flow diagram illustrating a process by which a system can be configured to generate an initial set of guessed keywords;

FIG. 9 illustrates an example a home user interface screen;

FIG. 10 illustrates example user interface screens for registering a user;

FIG. 11 illustrates example user interface screens for registering a user;

FIG. 12 illustrates an example user interface screen for adding a user data profile associated with an external computer system;

FIG. 13 illustrates an example user interface screen for presenting a matched visual object to a user;

FIG. 14 illustrates an example user interface screen for displaying additional information about a visual object;

FIG. 15 illustrates dynamic visualizations generated by the system in response to user inputs;

FIG. 16 illustrates an example user interface screen showing one or more filter options;

FIG. 17 illustrates an example user interface screen for displaying one or more discarded visual objects;

FIG. 18 illustrates an example user interface screen via which a user can perform a search;

FIG. 19 illustrates an example user interface screen showing one or more menu options;

FIG. 20 illustrates an example user interface screen that allows a user to select one or more visual object attribute preferences;

FIG. 21 illustrates an example user interface screen that allows a user to select one or more visual object classification preferences;

FIG. 22 illustrates an example user interface screen that allows a user to select one or more compute systems with which the user can create a data profile;

FIG. 23 is an illustration of an example user interface screen for selecting a user to whom to communicate a visual object;

FIG. 24 is an illustration of an example user interface screen for communicating a visual object to one or more other users;

FIG. 25 is an illustration of example user interface screens for displaying visual objects stored in a data store associated with a user;

FIG. 26 is an illustration of example user interface screens for displaying visual objects stored in a data store associated with a user;

FIG. 27 is an illustration of an example user interface screen for displaying visual objects specially designated by a user;

FIG. 28 is an illustration of example user interface screens for displaying identification information of data profiles that user has with external computer systems;

FIG. 29 is an illustration of example user interface screens for displaying information about one or more people associated with a user;

FIG. 30 is a schematic diagram of an exemplary computer system that may be specially configured to perform processes and functions disclosed herein; and

FIG. 31 is an illustration of example user interface screens for selecting recipients of portions of captured differences.

### DETAILED DESCRIPTION

Various embodiments provide an intelligent visual object management system that can be configured to generate a model of a user for use in matching one or more visual objects to the user. In some embodiments, the intelligent visual object management system includes an artificial intelligence/machine learning system (also referred to as “machine learning system” herein) for matching the visual object(s) to a user of a computing device. The system can be configured to determine a test variable for a visual object, where analysis of the test variable can be used by the system to dynamically select visual objects for display on the computing device. In various examples, the selection of the visual objects evolves with new information on the user (e.g., internal factors), new information collected from external sources, and new information on cognitive parameters. Each element can be used to dynamically build a model, that when execute by the system enables dynamic and evolving displays in the user interface.

According to various embodiments, the visual object management system can be configured to incorporate internal factor parameters, external factor parameters, and/or cognitive parameters for matching the visual object(s) to the user. In some embodiments, the intelligent visual object management system provides a user interface that enables real time tracking of user actions that previously could not be tracked. Various conventional systems fail to capture information about visual objects that a user is not interested in as conventional systems do not provide a mechanism by which a user can interact with those visual objects.

In some embodiments, the system can be configured to use stored tracking data about the user to train a machine learning system (e.g., an artificial intelligence or machine learning model). In matching the visual object(s) to the user, the system can be configured to input information about a respective visual object and/or user to the machine learning model to determine values of the internal factor parameters, external factor parameters, and/or cognitive parameters. The system can be configured to use the values of the parameters to calculate a value of the test variable according to which the system can match the visual object to the user.

According to some aspects, the inventors have recognized that to generate an accurate and reliable artificial intelligence/machine learning model of a user and/or a user's preferences with respect to visual objects, a large amount of data that can be used to characterize the user is needed. It is recognized that conventional systems do not track user interactions with visual objects. For example, conventional systems do not track triggering of visual object activation, sharing of one or more visual objects, storing one or more visual objects for subsequent use, discarding visual objects, and/or other interactions. Thus the systems are unable to incorporate data associated with user interactions with the visual object for training an accurate machine learning model. It is further recognized that conventional systems are unable to collect data associated with user actions that provide sufficient data for training an accurate and reliable model (including, for example, a machine learning model). For example, conventional systems may display multiple visual objects in a display of a computing device giving users the flexibility to interact with particular ones of the visual objects while not interacting with other visual objects. By doing so, various conventional systems are unable to gain any insight about a user from those visual objects that the user chooses not to interact with.

Accordingly, various aspects provide a system that tracks user interactions with visual objects. The system is configured to track triggering of visual object activation, storing of visual objects for subsequent use, discarding of visual objects, communicating a visual object to one or more recipients, and/or other interactions with visual objects. The system stores data related to a user's interactions with one or more visual objects. Using data tracking the interactions, the system can generate an accurate artificial intelligence or machine learning model. Additionally, storing a data record of user interactions provides a real time, and current set of data associated with the user to maintain and evolve with the user as a user's computer interaction patterns change.

Some aspects include systems that provide a user interface via which a user of a computing device can efficiently interact with visual objects that are displayed to the user, even if the visual objects are not of interest to the user. In various embodiments, the system dynamically adjusts the user interface and respective displays according to the user model. Further, the system updates the model based on interactions. Various conventional systems only allow for user interactions with visual objects of interest to the user and do not track data for visual objects that are not accessed or reviewed by a user, and thus fail to provide a model that incorporates data about visual objects that a user is not interested in. These conventional approaches simply do not have a mechanism for a user to interact with visual objects that are not of interest to the user. As a result, any respective modelling by these conventional approaches is not as accurate and in some cases completely fails to address visual objects the user finds uninteresting. According to some embodiments, the system can collect data about the user based on visual objects of interest to the user and visual objects that are not of interest to the user.

In some embodiments, executional efficiency of the system is vastly improved over conventional approaches by generating more accurate models of a user using data records of user interactions with one or more visual objects. A machine learning system can incorporate this data to generate one or more visual object matching models that are more accurate than those of other conventional systems, and therefore reduce execution cycles and eliminate wasted computation with respect to management of visual object(s). For example, the more accurate model(s) eliminate a need for a computing device to render graphical representations of visual objects that are not likely to match the user (e.g., not be of interest to the user). In some embodiments, an improved user interface provides for a system that requires fewer interactions to perform functions associated with visual object(s) (e.g., storing, and/or discard visual objects). This may reduce processing required of a user's computational device, and thus make the device more efficient. In some embodiments, the system is further able to incorporate real time user interactions into a matching model. The system can store data logs of user interactions in real time and, in response to the user interactions, update one or more variables (e.g., in real time) to implement more accurate matching of visual objects to users.

According to some aspects, the inventors have recognized that conventional systems do not allow for triggering and/or capturing of a difference in an operation resulting from activation of one or more visual objects. For example, conventional systems do not allow a user's computing device to automatically trigger activation of the visual object(s) during the operation nor to determine a difference in the operation resulting from activation of the visual object(s). In some embodiments, the user is able to store multiple visual objects (e.g., in an object container). The system can be configured to monitor activity being executed by the user or on the system, and dynamically determine if any one or more of the visual objects apply to actions being executed. If the system determines that any one or more of the visual objects apply, the system can automatically trigger their activation and a respective action. Further, the system is configured to dynamically determine what the result of the triggered action is, and using the result of the triggered action, select additional executions. In one example, a difference between an operation before the execution of the visual object and the operation after execution of the visual object is determined by the system. The system can trigger transmission of the difference to one or more recipients by one or more third party computer systems.

Accordingly, it is realized that there is a need for a system that enables a computing device to trigger activation of one or more stored visual objects during an operation, and to determine a difference in the operation resulting from the activation of the visual object(s). By triggering activation of the visual object(s), and capturing the difference in the operation resulting from the activation, the system can be configured to perform additional computer functions that conventional systems are unable to perform. For example, the system can be configured to transmit program instructions to other computer systems that trigger capturing of a portion of the determined difference in an operation resulting from the activation of the visual object(s).

In some embodiments, the system can be configured to automatically map a visual object to a particular interaction with another computer system. For example, the system can be configured to automatically map the visual object to an operation that a user is performing. The user may be performing the operation via a computing device. The visual object management system can be configured to identify one or more visual objects that apply to the operation and trigger activation of the visual object(s).

In some embodiments, the visual object management system can be configured to enable a client device to perform various computing functions in response to activating a visual object in a computer interaction. The system can be configured to trigger an automatic transmission of portions of a difference. Various embodiments of the system further facilitate automatically transmitting portions of the difference to one or more recipients by one or more third party computer systems. In accordance with some embodiments, systems and methods are described that allow users to easily trigger activation of visual objects while automatically capturing a difference resulting from activation of the visual objects.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

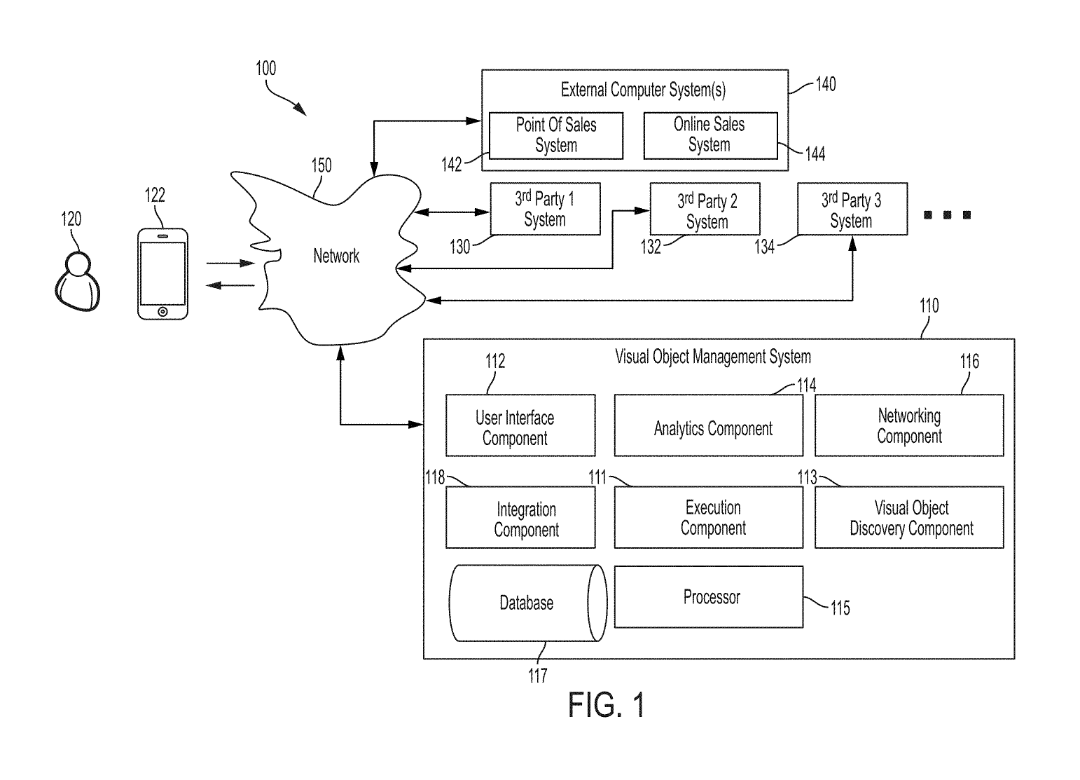

FIG. 1 shows an illustrative system 100 in which computer interactions may take place, in accordance with some embodiments. The system 100 includes a visual object management system 110, a user 120 along with a user device 122, a plurality of third party computer systems (130, 132, 134), an external system 140, and a network 150. The visual object management 110 may carry out various computer interactions with the user device 122, the external computer system 140, and third party computer systems (130, 132, 134) over network 150 in order to provide a user 120 with an intelligent visual object management system. In some embodiments, the user device 122 can be a portable device. For example, user device 122 can be a smart phone, a laptop computer, a tablet computer, a personal digital assistant, a smartwatch, and/or any other type of portable device capable of communicating over a network interface.

The various entities of exemplary system 100 shown in FIG. 1 can be configured to communicate through a network 150. The network 150 can comprise of the Internet or other network interface. It should be appreciated that each of the systems illustrated in exemplary system 100 may engage in other types of computer interactions and activities in addition to, or instead of, those mentioned above, as aspects of the technology described herein are not limited to the analysis of any particular type of digital interactions. Also, computer interactions are not limited to interactions that are conducted via an Internet connection. For example, computer interactions may take place over wired connections and other wireless connections (e.g. Bluetooth, Near Field Communication, radio frequency channels, etc.).

Furthermore, it should be appreciated that any number of suitable devices can be used to implement each of the systems described herein. The system can be configured to include any combination of suitable devices to engage in the digital interactions.

In some embodiments, the visual object management system 110 can be configured to engage in different types of interactions with a user device 122. The system 110 can be configured to generate information for a user interface that is displayed on the user device 122 or an interface through which a user 120 can be configured to interact with the visual object management system 110. In some embodiments, the system 110 can be configured to generate information for user interface screens through which a user 120 can be configured to register with the system 110. In some embodiments, the device can be configured to access user interface screens hosted by the system 110. In some embodiments, the system 110 can be configured to generate user interface screens and/or information that are configured to present various visual objects to the user 120 on device 122. The system 110 can be configured to receive the user's inputs from device 122 to select visual objects to store in a data store (e.g., also referred to as a wallet), share visual objects with another user, and/or discard visual objects (e.g., indicate to delete them).

In some embodiments, the user device 122 may be a portable device. For example, user device 122 may a laptop computer, a table computer, a smartphone, a personal digital assistant, a smartwatch, and/or any other type of portable device. In some embodiments, the user device 122 may be a fixed device. For example, user device 122 may be a desktop computer, a rack-mounted computer, and/or any other type of fixed device.

In some embodiments, the visual object management 110 can be configured to interact with an external computer system 140. The visual object management system 110 can be configured to exchange information with the external computer system 140 during a computer interaction (e.g., an operation) in order to activate one or more visual objects during an operation and receive information that the system 110 can be configured to use for other processes.

In some embodiments, the system 110 can be configured to interact with one or more third party computer systems (130, 132, 134). The system 110 can be configured to interact with the third party computer systems (130, 132, 134) in order to manage transmission of program instructions. For example, the system 110 can be configured to transmit program instructions to capture a difference resulting in an operation from activation of one or more visual objects (e.g., deposit, withdraw, transfer, etc.). In some embodiments, the system 110 can include application programming interfaces configured to communicate and/or manage with specific third party services. For example, in some embodiments, the system 110 can be configured to transmit program instructions to the third party computer systems (130, 132, 134) to trigger transmission of a portion of a difference to a recipient.

In some embodiments, the user 120 can be configured to interact with the external computer system 140. For example, the user 120 can be configured to interact with the external computer system 140 in order to complete an operation. For example, the user 120 can conduct an in person operation through a physical system 142 or purchase the product through an online system 144. A physical system 142 can include a computing system that the user 120 can access physically (e.g., a computer system). An online system 144 can include an Internet website, mobile application, or other network system through which the user 120 can interact with the external computer system 140.

In some embodiments, the visual object management system 110 comprises a plurality of components to execute various processes. In some embodiments, the system 110 includes an execution component 111, a user interface component 112, a visual object discovery component 113, an analytics component 114, a networking component 116, an integration component 118, and a processor 115 to execute the various components. The system 110 further includes a dataset such as database 117 to store data. The various components of the system 110 can be configured to utilize database 117 to store and access information.

In some embodiments, the system 110 can be configured to execute the user interface component 112 to generate a plurality of display screens on device 122. In some embodiments, the display screens can be configured to receive registration information from a user 120 of device 122. The system 110 can be configured to receive and store user input profile data. In some embodiments, the user interface component 112 can be configured to generate display screens through which the user 120 can select one or more recipients to whom portions of differences resulting from activation of visual objects are to be transferred. The user interface component 112 can be configured to generate display screens through which the system 110 receives a specification of an allocation of the differences to the recipient(s).

In some embodiments, the display screens can be configured to display visual objects to a user 120 on device 122. The system 110 can be configured to receive user selections of visual objects that the user 120 is interested in. In some embodiments, the user interface component 112 can be configured to detect that a user 120 swiped in a first direction (e.g., right) on device 122 to indicate that the user is interested in a presented visual object. The system 110 can be configured to store one or more selected visual objects in a data store (e.g., an object container) associated with the user 120. The user interface component 112 can be configured to detect that the user 120 swiped in a second direction (e.g., left) on device 122 to indicate that the user is not interested in a presented visual object. The system 110 can be configured to then discard the presented visual object.

In some embodiments, the system can be configured to further receive a user input specifying a request from the user 120 to share a presented visual object with another user. The user interface component 112 can be configured to, for example, detect that the user 120 swiped in a third direction (e.g., upward) on the device 122 requesting to share the visual object with another user. The user interface component 112 can be configured to then generate another display screen through which the user 120 can select a recipient to share the visual object with. The system 110 can be configured to send a communication to the recipient indicating the visual object by executing the networking component 116. For example, the system 110 can be configured to transmit a message (e.g., email, SMS) recommending the visual object to the other user.

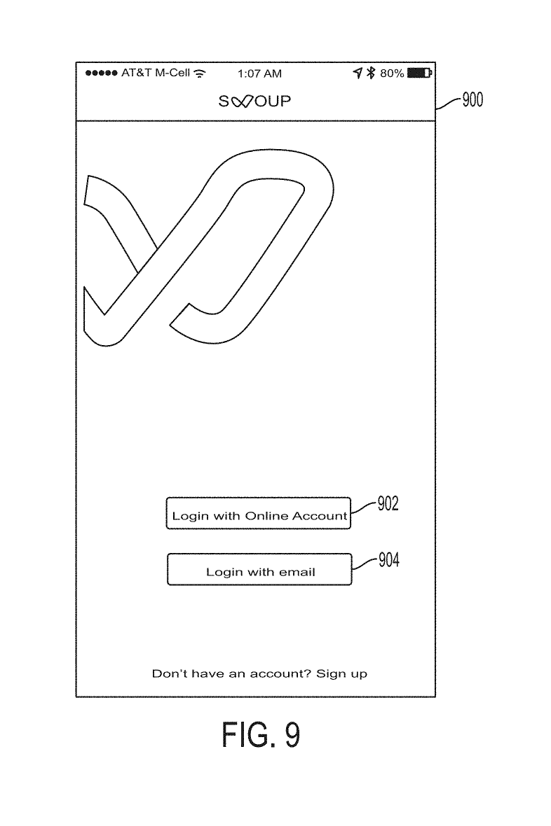

Some embodiments of user interface screens in accordance with the technology described herein are described herein with references to FIGS. 9-29, and 31.

In some embodiments, the system 110 includes an execution component 111 to manage activities associated with performing operations. In some embodiments, the execution component 111 can be configured to identify association of one or more visual objects with an operation. When the user 120 initiates the operation at a physical system 142 of the retailer system 140, the system 110 can be configured to activate the execution component 111. For example, the system 110 can be configured to generate a user interface screen displaying identification information of a data profile of the user 120 associated with the external computer system 140. For example, the system 110 can be configured to display a membership ID and/or a bar code of a user's data profile in the external computer system 140. The identification information can be configured to scan at the physical system 142. In response, the execution component 111 can be configured to identify one or more visual objects associated with the operation. In some embodiments, the system 110 can be configured to store a mapping of one or more visual objects that are applicable to the external computer system 140 to a record of a user's data profile associated with the external computer system 140. For example, the system 110 can be configured to store a mapping of visual object identifiers to a data profile identifier of a data profile of the user associated with the external computer system 140. In some embodiments, during an operation with the external computer system 140, the system 110 can be configured to transmit information about one or more visual objects mapped to the data profile of the user associated with the external computer system 140 and, in turn, trigger activation of one or more visual objects to the operation. In some embodiments, the external computer system 140 can automatically activate, using the information provided from the system 110, one or more visual objects that apply to the operation.

In some embodiments, upon identifying the relevant visual objects to an operation, the execution component 111 can be configured to determine a difference applied to the operation as a result of activation of one or more visual objects. The execution component 111 can be configured to then calculate the difference between an original operation (e.g., without activation of the visual object(s)) and the modified operation. In some embodiments, the execution component 111 can be configured to receive data from the external computer system 140 and use it to determine a resulting difference in the operation. In some embodiments, execution component 114 can be configured to then store information specifying the difference associated with the operation in the database 117.

In some embodiments, the execution component 111 can be configured to generate information for use in modeling user behavior (e.g. operation, user selections to discard/store visual objects, and/or user selections to share visual objects). In some embodiments, the execution component 111 can be configured to store data indicating that a user 120 has selected to store a presented visual object (e.g., in an object container). In some embodiments, the execution component 111 can be configured to store data indicating that a user 120 has activated a set of one or more visual objects during an operation. For example, the execution component 111 can be configured to store a particular product, category, keyword, and/or other information about a visual object involved in a user action. This information can be used, for example, by the system's analytics component 114 to update generate and/or update a visual object matching model for the user 120.

In some embodiments, the system 110 includes an integration component 118 configured to trigger capturing of differences by one or more third party computer systems (130, 132, 134). For example, a third party computer system can comprise computer systems associated with one or more recipients. In some embodiments, during a registration process, the system 110 can be configured to give a user 120 an option to specify one or more third party computer systems to which the user wants to instruct to capturing portions of one or more differences resulting from activation of one or more visual objects. The user 120 can, for example, specify one or more computer systems associated with one or more recipients to which the user wants to instruct to retrieve the portion of the difference(s). Examples of recipients are discussed herein. In some embodiments, the system 110 can be configured to request for a user to specify a percentage of the difference(s) to be transferred to each of the designated recipients.

In some embodiments, after a user 120 has completed an operation and the system 110 has triggered activation of one or more visual objects, the integration component 118 can be configured to manage transmission of the difference(s) by one or more third party computer systems (130, 132, 134). For example, the integration component 118 can be configured to manage a transfer of a difference resulting from activating one or more visual objects from an integrated account storing funds associated with the user to one or more accounts associated with the third party computer systems (130, 132, 134). In some embodiments, the integration component 118 can be configured to communicate (e.g., transmit) program instructions to a third party computer system instructing the system to transfer the difference between the original operation and the modified operation after application of the visual object(s). The recipient can be configured to receive the difference. In some embodiments, the user can specify a portion (e.g., a percentage) of the difference to be transferred to the recipients. The integration component 118 can be configured to manage transfer of difference to each designated recipient according to the specified percentage. In some embodiments, the integration component 118 can comprise an integration application program interface (API) to manage crediting of differences to one or more third parties. The integration API can be configured to transfer the difference between the pre-offer price of a purchase and the price of the purchase after activation of one or more visual objects. For example, the system 110 can be configured to use the integration API to communicate instructions to each third party to withdraw an amount from an account authorized by the user.

In some embodiments, the system 110 includes an analytics component 114 configured to generate a model of the user using information about user actions including purchases, interactions with visual objects, product interests, and/or other information related to the user. The analytics component 114 can be configured to then use the model to personalize visual objects that are presented to the user via a generated user interface on user device 122. In some embodiments, the analytics component 114 can be configured to generate a model of behavior and interests of the user 120 based on profile data, the user's selection and/or discarding of presented visual objects, and application of the visual objects. The analytics component 114 can be configured to use this model to select visual objects to present to the user 120 that the user 120 is likely to use and/or be interested in. In some embodiments, the analytics component 114 can configured to maintain a continuously evolving model of users interacting with the system 110 in real time based on actions of the users and other information collected about the users. The analytics component 114 can be configured to incorporate a plurality of parameters into the model including the following:
1. External factors captured by parameters (e.g., variables) such as gender, region, generation, stage in life, and/or visual object activations.
2. Internal factors captured by information entered by the user, user preferences, loyalty cards added, data from stored and/or discarded visual objects, visual object activations, and/or searches.
3. Cognitive factors such as life events, special characters in the visual object, and/or face value of visual objects.
4. Parameters associated with visual objects such as time, location, expiration, and/or other parameters.

In some embodiments, the analytics component 114 can include an artificial intelligence/machine learning system configured to utilize an algorithm that incorporates learned parameters in order to match a visual object to a user (e.g., to determine whether a visual object is to be presented to a user 120). For example, the analytics component 114 can be configured to utilize the following formula to quantify how likely a user is to select a given visual object:

W=Fₑ+Fᵢ+P_{f}

The output parameter W is calculated as a sum of three parameters (Fₑ, Fᵢ, P_{f}) that quantify external factors, internal factors, and cognitive factors respectively. In some embodiments, the analytics component 114 can be configured to receive values of several variables and then calculate a value for each parameter using those variables in a hidden layer. In some embodiments, the analytics component 114 can be configured to compare the final value of the output W to a predetermined threshold value. If the calculated value of W for a particular visual object is greater than the threshold, the analytics component 114 can be configured to designate the visual object as one to present to a user.

In some embodiments, the machine learning system can be configured to generate one or more models with which the analytics component 114 can determine values of one or more variables used to calculate the parameters (Fₑ, Fᵢ, P_{f}). In some embodiments, the system can be configured to train a neural network which the analytics component 114 can be configured to use to determine values of the variable(s). Embodiments of the machine learning system are described herein.

In some embodiments, the analytics component 114 can be configured to use information about the user and/or information about user actions to populate various inputs used to calculate the parameters used in the formula above. For example, the analytics component 114 can be configured to set a certain variable in an equation to calculate Fₑ based on detecting occurrence of a life event. In another example, the analytics component 114 can be configured to detect that the user has moved into a new home, married, started a new hobby or other life event. The analytics component 114 can be configured to set a variable responsive to detection of the life event. In another example, the analytics component 114 can be configured to correlate certain special characters that exist in a visual object to a probability that the user will select the visual object. This determination can be used to populate a variable that is used to calculate P_{f}. For example, the analytics component 114 can be configured to analyze a plurality of previously selected visual objects to determine any patterns of special character occurrences in them.

In some embodiments, the analytics component 114 can be configured to maintain a data set of key words with associated weights. The analytics component 114 can be configured to adjust these weights based on various user actions. For example, the analytics component 114 can be configured to increase weights of a set of keywords based on detecting that a user has selected a visual object that includes the set of key words or includes words related to the set of key words. The analytics component 114 can be configured to then determine that one or more visual objects (e.g., natural language descriptions) including the set of key words have an increased likelihood of being selected by the user. In one example, the analytics component 114 can be configured to add weights associated with key words in a visual object as a variable to calculate one or more of the parameters (Fₑ, Fᵢ, P_{f}). Keywords can be captured from different sources including keywords entered by the user 120 in a search function, words that appear in visual objects that the user has already selected to store, and from other sources. For example, the analytics component 114 can be configured to assign weights to keywords entered in the search function based on the user's interaction with visual objects presented to the user 120 from the search.

In some embodiments, the analytics component 114 can be configured to also use a face value of a visual object to set a variable used to calculate one or more of the parameters. A face value of a visual object can comprise a value of a difference produced by the offer as a result of a modification to an operation the visual object applies when activated. The analytics component 114 can be configured to correlate a particular face value with a user's selection of one or more visual objects and the system's 110 application of the visual object(s). The analytics component 114 can be configured to then set a value of a variable associated with the face value based on detecting a preferred face value in a visual object.

In some embodiments, the system 110 can be configured to determine a face value of a visual object based on operation data received from one or more external computer systems. In some embodiments, the system 110 can be configured to determine the face value of the visual object based on one or more items associated with the visual object. For example, the system 110 can be configured to identify one or more products associated with the visual object. The system 110 can be configured to determine a result of an original unmodified operation, and then determine an effect that activation of the visual object would have on the operation to determine the face value. In some embodiments, the system 110 can be configured to access information from the external computer system(s) for determining a result of an original unmodified operation and/or a result of a modified operation.

In some embodiments, the analytics component 114 can be configured to process visual objects to extract details specific to visual objects such as, but not limited to: retailer, manufacturer, purchased quantity requirement, product, offer, a visual object's ability to be combined with another visual object, and other relevant information to correlate multiple different visual objects. In some embodiments, the analytics component 114 can be configured to determine from the extracted information a relation between one or more visual objects. For example, the analytics component 114 can be configured to determine that one or more visual objects can be combined. The execution component 111 can be configured to then automatically combine the multiple visual objects according to the determination to optimize a difference that a user 120 can obtain. This automated processing and application of artificial intelligence not only improves over conventional systems but provides execution that a human user may find difficult with even a few visual objects.

In some embodiments, the analytics component 114 can be configured to determine one or more locations at which to activate one or more visual objects to optimize a difference obtained as a result of activation of the visual object(s). For example, the system can be configured to determine a location at which to trigger activation of the visual object to optimize a modification in an operation. In some embodiments, to determine the location(s), the analytics component 114 can be configured to use information about one or more visual objects stored in a data store (e.g., an object container) associated with the user 120. The analytics component 114 can be configured to use information from the external computer system 140 to determine the location(s). For example, the system can be configured to use information about product availability to determine the location(s). In another example, the system can be configured to use a face value, quantity of items required, brand, product, and/or other information to determine the location(s).

In some embodiments, the system 110 can be configured to execute a networking component 116 to generate a model of connections and relationships of a user 120. The networking component 116 can be configured to receive requests from user 120 through user device 122 to share visual objects with other users. The networking component 116 can be configured to share visual objects with other users specified by the user 120. The networking component 116 can be configured to allow the user 120 to receive shared visual objects from other users. The networking component 116 can be configured to use the sharing of visual objects to generate a network identifying connections between a plurality of users. The networking component 116 can be configured to then generate and maintain a model of connections of the user 120. The system 110 can be configured to use this model to further personalize presented visual objects and also identify common interests between various users. In some embodiments, the networking component 116 can be configured to provide a friends list for users and can be configured to suggest friend connections by detecting similar interests of different users.

In some embodiments, the system 110 can use a user input specifying communication of a visual object to a recipient to model the user and recipient. The networking component 116 can be configured to generate the model using the identified network of connections between various users. For example, the networking component 116 can be configured to then generate information about a user that may be utilized by the analytics component 114 to determine which visual objects to present to the user. For example, the networking component 116 can be configured to generate and store information associating a user with a second user based on a sharing of visual objects between the two users. The analytics component 114 can be configured to utilize this information as an indication that visual objects selected by one of the two users may also be visual objects of interest to the other user. For example, the analytics component 114 can be configured to use this information to populate a variable with a value that influences an overall decision of whether to present a visual object to a user.

In some embodiments, the visual object management system 110 includes a visual object discover component 113. The visual object discover 113 can be configured to identify additional visual objects to add and/or present to a user 120 on device 122. In some embodiments, the visual object discovery component 113 can be configured to receive a visual object comprising a photo of a product from device 122. The visual object discovery component 113 can be configured to identify the product and search for related visual objects. In some embodiments, the visual object discovery component 113 can be configured to receive images of paper or other physical visual objects. The visual object discovery component 113 can be configured to extract information from the photos and digitize the visual objects for storage and use in system 110.

In some embodiments, the visual object discovery component 113 can be configured to convert physical visual objects into digital visual objects through the use of OCR (Optical Character Recognition) technology. With this technology, the discover component 113 can be configured to translate information that appears on a physical visual object and convert it into a digital representation of the visual object. In doing so, the system can be configured to capture images and text and reconfigure the information into a digital mobile object that stylistically aligns with how the system displays offers (e.g., in a user interface). In some embodiments, when a barcode exists on the physical visual object, the discovery component 113 can be configured to translate the information the barcode contains and embed it into digital visual object. By doing this, the discovery component 113 can be configured to pass the necessary information required to activate the visual object to an external computer system. By doing so, this will eliminate a user from having to scan the barcode during an operation, which removes any unnecessary steps or added friction at the operation. In some embodiments, the bar code can be stored as part of or associated with the visual object. In some embodiments, the bar code may be visible when a representation of the visual object is displayed on a user device. In some embodiments, the bar code may not be visible when a representation of the visual objects is displayed on a user device. Once a physical visual object is converted into a digital visual object, the digital visual object can be presented to the user 120 in a user interface as described herein.

In some embodiments, the discovery component 113 can be configured to retrieve visual objects using an image of an object (e.g., a product). In some embodiments, the system can be configured to analyze the image via OCR or other technology and convert into a digital format. In some embodiments, the system can be configured to query against one or more online databases (e.g., product information databases). When possible matches are found, the system can be configured to present potential matches to the user 120 and the user 120 can select visual objects and/or products that align with the physical object. In some embodiments, the discovery component 113 can be configured to continue searching if a matching product and/or visual object is not found.

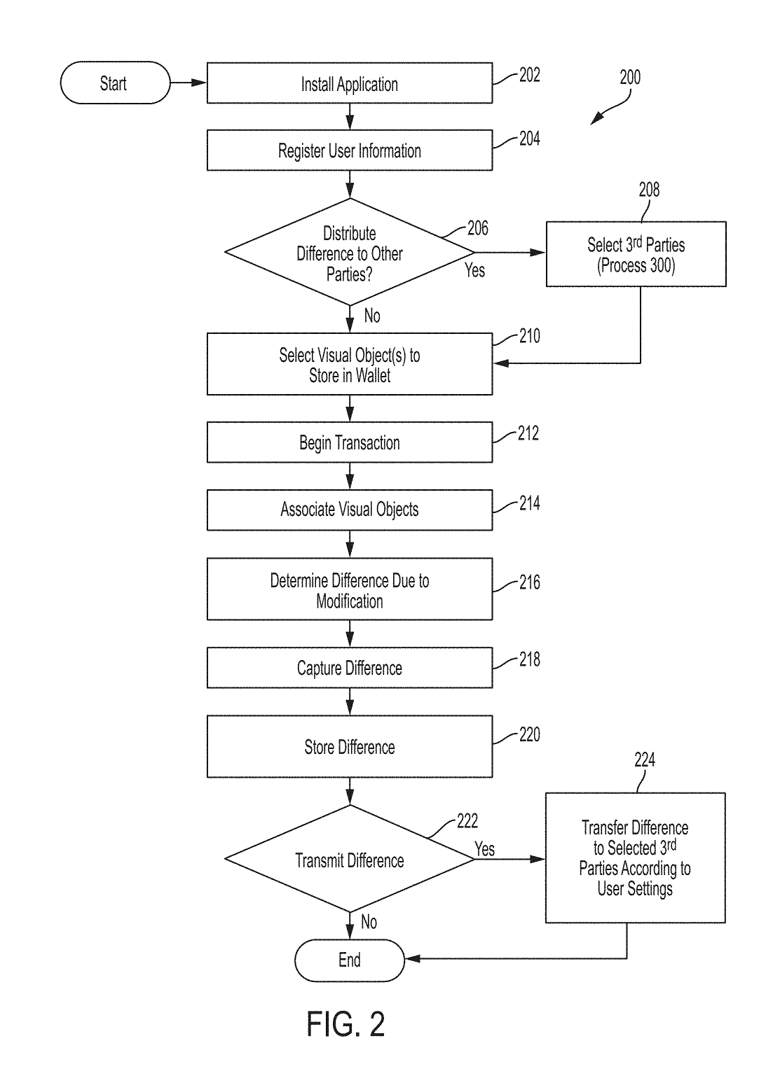

FIG. 2 illustrates an exemplary process flow 200 to trigger activation of one or more visual objects to an operation, in accordance with some embodiments of the technology described herein. Process 200 may be executed by a system such as exemplary system 110 discussed above with reference to FIG. 1.

Exemplary process flow 200 starts with act 202 wherein a user (e.g. user 120) installs a an application on a device (e.g. device 122). The user may access the application from an online repository such as an app store, Internet website, or other source.

After installation of the application, exemplary process flow 200 proceeds to act 204 in which the system presents the user with various registration steps. In some embodiments, the system can be configured to require the user to enter personal information to generate a data profile of the user. In other embodiments, the system can be configured to further request information about interests and preferences from the user. The system can be configured to also request information from the user to integrate a third party computer system. For example, the system can be configured to integrate a checking account associated with the user as part of the user's profile. In some embodiments, the system can be configured to generate a plurality of user interface display screens to display on the device and collect the registration information.

After collecting basic profile information from the user, the system may proceed to act 206 where the system determines whether the user wants to distribute differences earned from activation of visual objects. For example, the system can be configured to determine whether the user wants to distribute savings to accounts associated with one or more third party computer systems. If the user indicates yes (206, Yes), the system proceeds to act 208 to execute a process (e.g. process 300) to selected third parties (e.g., recipients) to whom differences may be transferred. Examples of recipients are discussed herein.

If the system receives an indication that the user does not want to distribute differences to other parties (206, No) or after the system has received third party selections at act 208, exemplary process flow 200 proceeds to act 210 in which the system presents one or more visual objects to a user. In some embodiments, the system can be configured to generate user interface display screens presenting the visual object(s). In some embodiments, the system can be configured to receive input from the device causing the system to store a presented visual object. In some embodiments, the system can be configured to receive an input from the device causing the system to discard the presented visual object. In some embodiments, the system can be configured to receive an input indicating a request to share the presented visual object. In some embodiments, each action available to a user is chosen and detected by the system according to a different detected user input. For example, a user may swipe right to store the visual object in the wallet, swipe left to discard the visual object, and swipe up to request to share the visual object. In some embodiments, the system can be configured to add additional user inputs and associated functions, modify functions associated with existing user inputs, and/or remove existing user inputs and/or associated functions.

Next, exemplary process flow 200 proceeds to act 212 where the system executing the process determines that a device of the user is involved in an operation (e.g., interacting with a computer system to perform an operation). In some embodiments, the system can be configured to detect an operation by receiving a request to use a loyalty card stored in the system. In some embodiments, the system can be coupled to a retailer system and automatically detect initiation of a product purchase. In some embodiments, the system can be configured to provide information for or can be configured to generate an interface through which the user can perform operations with various computer systems directly through the installed application. For example, the system can be configured to determine a purchase is being conducted by detecting that the user has added an item to a cart or executed another action indicating initiation of a purchase. Additionally, the system can be configured to recommend application of savings based on detecting that a user is viewing a certain product.

In some embodiments, a user can supply a variety of information, which can include: name, phone number, home address, bank account information, birthdate, etc. As such, system can have access to this information. The system can allow the user to place products and/or visual objects into a data store of the user (e.g., a wallet) and provide the option to add products and/or visual objects placed in her/his wallet to a shopping list. The products and/or visual objects can be associated with one or more different external computer systems. In some embodiments, the system can be configured to perform an operation for the products in the shopping list using the visual objects in the shopping list.

In some embodiments, the system can include a backend interface with one or more external computer systems (e.g., various retailer's ecommerce platforms). This interface will allow the system to perform operations with the external computer system(s). The system, through the backend interface, can be configured to submit the user's information (name, shipping address, etc.) along with the product, loyalty ID and any corresponding visual objects to each of the external computer system(s). In some embodiments, the system can be configured to pass payment information to the external computer system(s) via the back end interface. In some embodiments, the system can be configured to receive order confirmations from the external computer system(s) when an operation has been completed (e.g., when an order has been received, shipped, etc.). In some embodiments, the system can be configured to track the differences resulting from activation of one or more visual objects and trigger capturing of differences by one or more third party computer systems.

Next exemplary process 200 proceeds to act 214 where the system associated one or more visual objects to the operation. In some embodiments, the system can be configured to receive information from the retailer system about the operation and use the information to look up relevant visual objects. In some embodiments, the system can be configured to identify relevant visual objects according to a loyalty program account being used in the purchase. In some embodiments, the system may already have information about the product being purchased through the installed application and may identify relevant visual objects according to this information. In some embodiments, the system can be configured to store one or more mappings of the visual object(s) to the loyalty program account. The system can be configured to transmit information identifying the mapping(s) to a first computer system with which the system is interacting to perform the operation.

Next, exemplary process 200 proceeds to act 216 where the system triggers application of the visual object(s). For example, the system can be configured to automatically activate one or more visual objects. In some embodiments, the system can be configured to transit information about the visual object(s) a computer system with which the user device is interacting to enable the computer system to activate the visual object(s). In some embodiments, the system can be configured to perform an operation and trigger activation of the visual object(s) in a single interaction. For example, a user can hover a device over an external computer system and the system can be configured to transmit all information necessary to complete the operation and activate the visual object(s).

Next, exemplary process 200 proceeds to act 218 where the user completes the operation. In some embodiments, the user may complete the operation via a physical system or an online system. In some embodiments, upon completion of the operation, the system can be configured to receive redemption data from the system. The redemption data can include visual objects applied to the respective operation.

In some embodiments, the system executing the process 200 can be configured to charge the user. In some embodiments, the system charges the user a price of the product before activation of any of the identified visual objects. In some embodiments, the system can be configured to further determine a difference between the pre-activation execution of the operation and the result of the modified operation due to activation of the identified visual objects and then trigger capturing of the difference.

Next, exemplary process 200 proceeds to act 220 where the system determines a difference in the operation as a result of activation of the visual object(s). For example, the system can be configured to determine an amount of earned savings as a result of activation of the visual object(s). In some embodiments, the system can be configured to use data received from an external computer system to determine the earned savings from the operation. For example, the system can be configured to determine a difference between a pre-offer price of the product and a price of the product after application of identified visual object(s). In embodiments in which the system charged the user for the operation, the system may already have data specifying the earned savings.

Next, exemplary process 200 proceeds to act 222 where an evaluation is made to determine if the user had previously requested to trigger transfer of differences resulting from activation of the visual object(s). For example, the system can be configured to trigger transfer of earned savings from activation of the visual object(s). As described above at act 206, the system can be configured to present the user with an option to distribute earned savings to other parties (for example, at registration). If the user had indicated yes (222, Yes), then the process proceeds to act 224. At act 224 the system transfers earned savings from an integrated account of the user to one or more third parties designated by the user (e.g. through process 300). In some embodiments, the system can be configured to transfer a percentage of the earned savings to one or more third parties. For example, the system may have received a specification from a user to transfer different percentages of the savings to a charity, a savings account, and an investment account. The system can be configured to transfer, from an integrated account of the user, savings earned from application of visual objects to the specified entities according to the percentages. In some embodiments, the system can be configured to transmit program instructions to all the designated third parties instructing them to withdraw an amount of the earned savings. For example, the system can be configured to calculate an amount to be distributed to each third party according to user specified percentages, and transmit instructions to each third party to withdraw the amount.

In some embodiments, the system credits a separate account with the savings earned as a result of applying the identified visual objects. In some embodiments, the system can be configured to manage crediting a recipient with the difference between the original price of the purchase and the price of the purchase after application of the identified visual objects. For example, the system can be configured to credit the amount to a checking account integrated with the system by the user during registration. In some embodiments, the system can be configured to invoke an API to manage the transfer of funds to one or more recipients identified by the user. In some examples, this can occur through a system integrated account, and in others directly to a third party computer system and respective account.

If the system had not received a user preference to transfer earned savings (222, No) or after having transferred funds as specified by the user at act 224, exemplary process 200 ends.

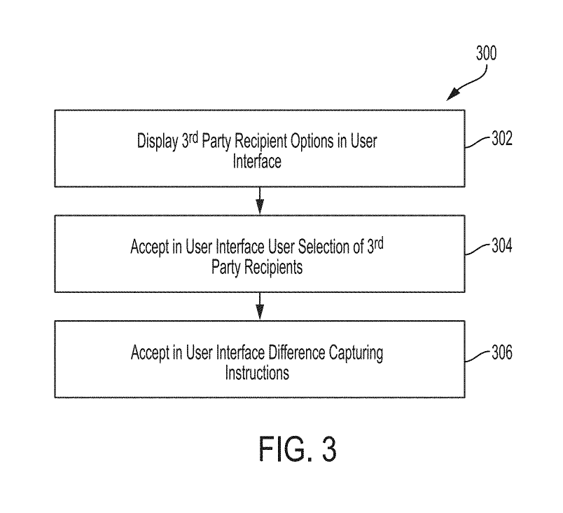

FIG. 3 illustrates an exemplary process flow 300 by which a system (e.g. system 110) can be configured to trigger a transfer of differences from operations to recipients (e.g., one or more third parties). Process flow 300 may, for example, be part of exemplary process flow 200 discussed above with respect to FIG. 2.

In some embodiments, a recipient can comprise one or more savings, checking, investment, and/or charitable giving accounts. In some embodiments, the recipient can comprise a system associated with a loan debt account (e.g., student loan debt), a savings plan (e.g., a college savings plan), a retirement account or other type of account. In some embodiments, the recipient can comprise an account associated with another individual, a real estate investment account, or other type of account. Some embodiments are not limited to any specific type of recipient. In some embodiments, the system can communicate with one or more third party computer systems associated with one or more recipients to manage transmission of portions of differences to the recipient(s).

Exemplary process flow 300 begins at act 302 in which the system can be configured to generate a user interface display screen of a device (e.g. device 122) presenting a user (e.g. user 120) with a list of third party recipient options. Examples of recipients are discussed herein. In some embodiments, the system can be configured to maintain predefined agreements to communicate with one or more third party computer systems. In some embodiments, the system includes one or more APIs for communicating with the third party computer system(s).

Next, exemplary process flow 300 proceeds to act 304 where the system accepts selection of the third party recipients by the user. In some embodiments, the system can be configured to receive user from the generated user interface display screen. The system can be configured to then store the information and associated destinations for communications regarding transfers of earned savings.

In some embodiments, in response to a selection of a recipient, the system can be configured to transmit user information to a third party system associated with the recipient. In some embodiments, the system can be configured to maintain a secure API for communicating with the third party system. In response to selection of the recipient, the system can transmit information to the third party system via the API. For example, the system can be configured to transmit encrypted information associated with the user via the API to the third party system. In some embodiments, the system can be configured to query the third party system (e.g., a database of the third party system) for particular information associated with the user. In some embodiments, the system can be configured to query the third party system for any matches of information about the user and information stored in the third party system. For example, the system can query for identification data, location data, and/or other data associated with the user. In another example, the system can identify one or more profiles in the third party system associated with the user. In some embodiments, the system can be configured to query the third party system for information for profile information of one or more users that the user may be associated with via an online network (e.g., Facebook friends, contacts).

In some embodiments, the system can be configured to generate and/or display additional user interface screens for adding a recipient. In some embodiments, the system can be configured to display information about one or more existing profiles (e.g., accounts) that are stored in the third party system. The system can be configured to provide a user interface screen via which the user can select one or more of the profile(s) as recipients. For example, the system can provide a user interface screen listing the profile(s) and the user can select one or more of the profile(s) as recipients (e.g., by tapping, swiping).

In some embodiments, the system can be configured to generate one or more user interface screens via which the user can register for a profile with the third party system. For example, the system can be configured to allow the user to enter identification information via which the third party system can generate a profile (e.g., an account) for the user. In some embodiments, the system can be configured to receive information from the user via the user interface screens and transmit the information to a third party system associated with a selected recipient. In some embodiments, the system can be configured to generate user interface screens via which the system can receive identification information about profiles in the third party system associated with the user. The system can be configured to use the information to query the third party system for information, and to configure the recipient to receive subsequent instructions for capturing of portions of differences in operations. For example, the system can receive a name, identity associated with the third party system, identification number (e.g., an account number) and/or other identifying information with which the system can identify a profile in the third party system.

Next, exemplary process flow proceeds to act 306 where the system can be configured to further accept a percentage of earned savings to distribute to each of the selected the third party recipients. For example, the system can be configured to receive a selection of only one third party recipient and a specification to transfer a percentage of captured differences in operations to the single third party recipient. Alternatively, the system may have accepted a plurality of third party recipients. In some embodiments, the system can be configured to further receive values of percentages of earned savings to distribute to each of the selected recipients. The system can be configured to then manage distribution of earned savings to the recipients according to the specified percentages. For example, the system can be configured to manage transmission of a percentage of captured differences in operations resulting from triggering activation of visual objects by the system.

In some embodiments, the system can be configured to determine additional information for each recipient. In some embodiments, the system can be configured to determine operation fees, difference (e.g., revenue) sharing amounts with the third party computer systems, and other amounts. For example, the system can be configured to calculate an operation fee and/or revenue sharing amount from an operation based on a stored agreement associated with a third party computer system. The system can calculate a fee or revenue sharing amount that is to be received by the system (e.g., visual object management system 110), manager of the system, and/or an account associated with the system.

In some embodiments, system can be configured to allow multiple user to select a single recipient of portions of captured difference. For example, the system can be configured to allow the multiple users to specify a particular recipient that is to receive portions of differences in operations resulting from activation of one or more visual objects.

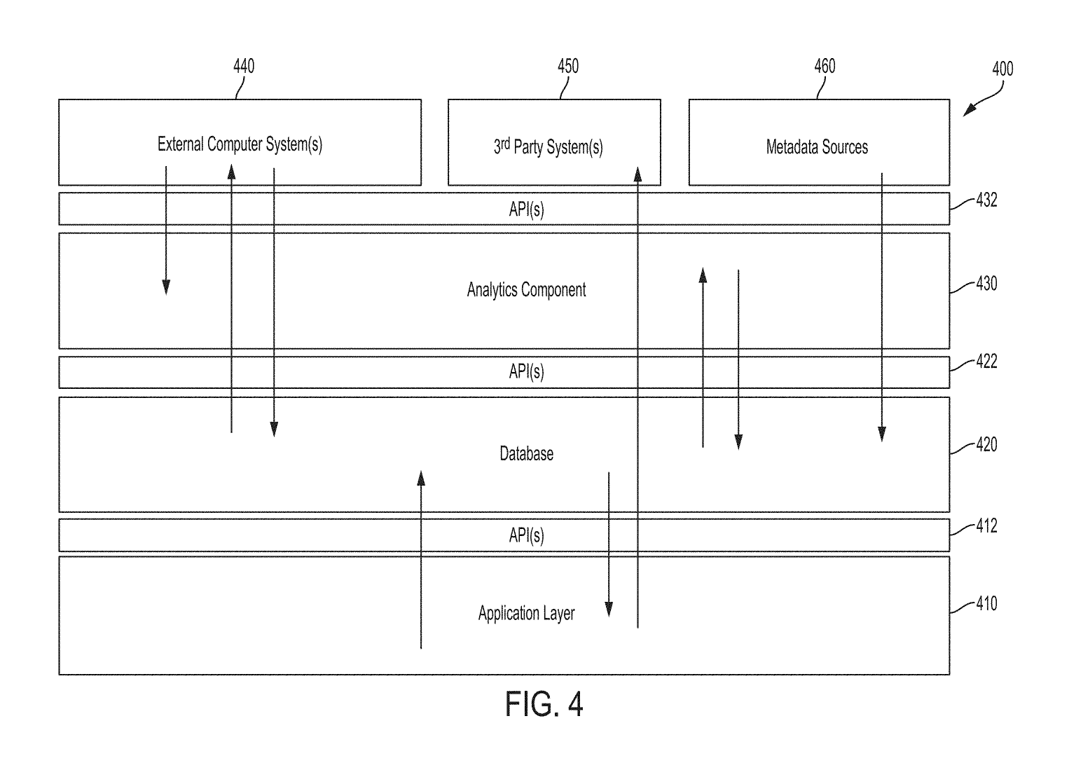

FIG. 4 illustrates a data flow diagram 400 illustrating data flows between various entities, in accordance with some embodiments of the technology described herein. In some embodiments, the system (e.g., visual object management system 110) can include an application layer 410, a database layer 420, and an analytics layer 430. In some embodiments, the system can be configured to interact with one or more external computer systems 440, one or more third party computer systems 450, and/or one or more metadata sources 460. In some embodiments, the system can be configured to interact with other systems and data sources not illustrated in FIG. 4.

In some embodiments, the application layer 410 can comprise a software application that is running on a client device. For example, the application layer 410 can comprise a mobile application on a mobile device, or desktop computer of a use, or other computing device. The application layer 410 can be configured to generate one or more user interfaces via which a user can interact with the system. In some embodiments, the application layer 410 can be used by the user to perform various actions. For example, the user can select visual objects to store, discard visual objects, share visual objects, and/or apply visual objects to one or more operations using the application layer 410. In another example, the user may interact with the application layer 410 to perform searches, configure settings, and/or view visual objects. In yet another example, the user can provide information via the application layer 410. Example interactions with the application layer are described herein.

In some embodiments, the application layer 410 can be configured to interact with a database layer 420. In some embodiments, the system can include one or more APIs via which the application layer 410 can interact with the database layer 420. For example, the application layer 410 can be configured to use one or more API calls to transmit and/or retrieve data from the database 420. In some embodiments, the API(s) can comprise software code implementing one or more functions by which the application layer 410 can interact with the database layer 420.

In some embodiments, the database layer 420 can be configured to receive data from the application layer 410. The application layer 410 can be configured to collect data and transmit the data to the database layer 420 for storage. For example, the application layer 410 can be configured to collect data about user actions. The application layer 410 can be configured to log a record of user actions such as selections to store visual objects, discard visual objects, sharing of visual objects, and/or applying visual objects to operations. In another example, the application layer 410 can be configured to log data of user searches. In yet another example, the application layer 410 can be configured to store data related to application settings. Application settings can include notification settings, user preferences (e.g., visual object feature preferences), and/or other types of information. The application layer 410 can be configured to transmit the collected and/or stored data to the database layer 420.

In some embodiments, the database layer 420 can be configured to transmit data to the application layer 410. In some embodiments, the database layer 420 can be configured to transmit one or more visual objects to display to the user. For example, the system can be configured to match the visual object(s) to the user as visual objects to display to the user. The database layer 420 can be configured to provide the matched visual object(s) to the application layer 410 where they can be presented to the user (e.g., in a user interface screen). In some embodiments, the database layer 420 can be configured to use the API(s) 412 to transmit data. The database layer 420 can be configured to use implemented functions to transmit the data.

In some embodiments, the database 420 can be configured to interact with an analytics component 430 of the system. The database 420 can be configured to transmit and receive data from the analytics component 430. In some embodiments, the database 420 may store data that is used by the analytics component 430 to perform various functions. For example, the analytics component 430 can be configured to use the stored data to train a machine learning systems (e.g., one or more machine learning models), use the machine learning system to determine values one or more parameters, determine values of one or more parameters, and/or use the stored data to match one or more visual objects to a user. In some embodiments, the analytics component 430 can be configured to transmit data to the database layer 420 for storage. For example, the analytics component 430 can be configured to determine outputs of a visual object matching algorithm. The analytics component 430 can be configured to transmit the determined outputs to the database 420. In some embodiments, the analytics component 430 can be configured to determine one or more visual objects matched to a user. The analytics component 430 can be configured to transmit data identifying those visual object(s) to the database 420. The application layer 410 can then access the visual object(s) and present the visual object(s) to the user. Example analytics components are discussed below in detail.

In some embodiments, the database layer 420 can be configured to interact with the analytics component 430 via one or more APIs 422. For example, the analytics component 430 can be configured to use one or more API calls to transmit and/or retrieve data from the database 420. The API(s) can comprise software code implementing one or more functions by which the application layer 410 can interact with the database layer 420.

In some embodiments, the system can be configured to interact with the external computer system(s) 440 to retrieve one or more new visual objects. For example, the computer systems can periodically provide new visual objects. The system can retrieve the visual objects and store them in the database 420. In some embodiments, the analytics component 430 can be configured to retrieve data from the computer system 440. For example, the analytics component 430 can be configured to retrieve information related to visual object attributes (e.g., brand, category) and other information. In some embodiments, the system can provide information to the computer system(s) 440. For example, the system can be configured to store data related to users (e.g., user action data, demographic data) in the database 420. The system can be configured to provide the data to computer systems for use. In another example, the system can be configured to store data associated with insights developed by the analytics component 430 (e.g., statistics, preferences of the user). The computer system(s) 440 can be configured to access the data for use in the computer system(s) 440.

In some embodiments, the system can be configured to interact with the external computers system(s) 440 to perform one or more operation. For example, the system can be configured to interact with the computer system(s) 440 to complete an operation to purchase a product. The system can be configured to interact with the computer system(s) 440 during the operation to activate one or more visual objects. In some embodiments, the system can be configured to store identification information of a user data profile associated with the external computer system(s) 440. For example, the system can be configured to store identification information of a user's loyalty program membership for a respective computer. For example, the information can include a membership ID number, bar code, address, name, and/or other information about the user's membership of the loyalty program. In another example, the system can be configured to store login information of a user to access the computer system(s) 440 such as a username, email, and/or password.

In some embodiments, the system can be configured to store a mapping of one or more visual objects to a user's identification information associated with the computer system(s) 440. The system can be configured to map visual objects that are associated with the computer system(s) 440 to the user's identification information. For example, the system can be configured to store a mapping for one or more visual objects that can be activated by an external computer system associated with the identification information.

In some embodiments, during an operation with a respective computer system, the system can be configured to transmit a user's stored identification information associated with the respective computer system (e.g., membership ID information). In some embodiments, the system can be configured to submit an API call transmitting the identification information. In some embodiments, the system can be configured to transmit information related to one or more visual objects mapped to the identification information associated with the respective computer system. For example, the system can be configured to transmit data identifying the visual object(s) mapped to the identification information. In some embodiments, the visual object(s) can be configured to activate during the operation and trigger a modification of the operation. For example, the visual object(s) can be configured to modify a price of a product involved in the operation. In some embodiments, the system can be configured to receive data from the respective computer system during and/or after the operation. In some embodiments, the received data can comprise information about one or more modifications applied to the operation by the visual object(s). The system can be configured to store the received data and/or use it for other computing processes.

In some embodiments, the system can be configured to transmit a user's stored identification information to a respective computer system without transmitting data related to visual objects. In some embodiments, the respective computer system determines one or more visual objects that are stored by the system (e.g. in database 420) that relate to an operation. The respective computer system can automatically apply the determined applicable visual object(s). For example, the computer system can activate the visual object(s) such that they apply a modification to the operation.

In some embodiments, the system can be configured to transmit data to enable execution of one or more visual objects to the computer system(s) 440 during an operation. In some embodiments, the system can be configured to transmit the data before the operation. In some embodiments, the system can be configured to transmit the data after the operation is complete.

In some embodiments, the system can be configured to interact with one or more third party computer systems 450. In some embodiments, the system can be configured to interact with the third party computer system(s) 450 as part of performing various user actions (e.g., applying of visual objects to operations) as described herein. For example, the application layer 410 can be configured to exchange information with the third party computer system(s) 450. The application layer 410 can be configured to transmit program instructions that cause the third party computer system(s) 450 to perform actions related to an operation such as transferring of funds from an account of a user to one or more other accounts. In some embodiments, the system can be configured to receive information from the third party computer system(s) 450. For example, the system can be configured to receive indications of one or more statuses associated with actions triggered by program instructions transmitted by the system to the third party computer system(s) 450.

In some embodiments, the system can be configured to interact with one or more metadata sources 460. The system can be configured to retrieve data and store it. For example, the system can be configured to retrieve synonyms for keywords associated with one or more visual objects from an online thesaurus system. In some embodiments, the system can be configured to retrieve semantic information for use by the analytics component 430. For example, the analytics component 430 can be configured to use the data to generate and/or update one or more machine learning models. In some embodiments, the system can be configured to retrieve information about one or more visual objects in the system from the metadata sources 460. In some embodiments, the metadata sources 460 can comprise sources of data related to users. For example, the metadata sources 460 can be social media systems from where the system can retrieve data about users to use in visual object matching. Some embodiments are not limited to any particular type of metadata sources 460. The system can be configured to store the information received from the metadata sources in the database 420.

In some embodiments, the system can be configured to interact with the external systems using one or more APIs 432. For example, the system can be configured to use the APIs to transmit and receive data from the computer system(s) 440 and/or the third party computer system(s) 450. In some embodiments, the system can be configured to maintain a secure channel of communication between the external systems. For example, the communications between the system and the external systems may be encrypted.

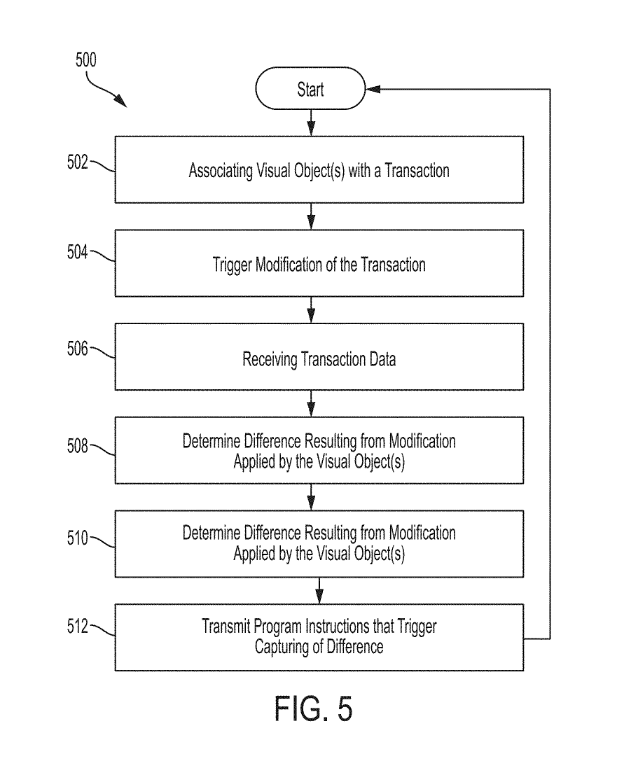

FIG. 5 illustrates a flow chart of an example process 500 of triggering activation of a visual object during an operation with another computer system, in accordance with some embodiments of the technology described herein. Exemplary process 500 can be performed, for example, by visual object management system 110 described above with reference to FIG. 1.

In some embodiments, the system executing process 500 can initiate process 500. For example, the system can be configured to receive an indication from a computer system with which the system is to interact with during an operation to initiate the process 500. In some embodiments, the system can be configured to transmit an indication to the computer system to initiate process 500. In some embodiments, the system can be configured to initiate process 500 in response to a user input in a client device. In some embodiments, the system can be configured to include a listener that is listening for a signal from a computer system to initiate the process 500. Some embodiments are not limited by the manner in which process 500 is initiated.

Process 500 beings at act 502 where the system associates one or more visual objects with an operation. In some embodiments, the system can be configured to identify stored identification information of a user's data profile associated with a computer system with which the system is interacting to perform the operation. In some embodiments, the system can be configured to transmit the identification information of the data profile to the computer system (e.g., via an API call to the computer system). In some embodiments, the system can be configured to transmit information identifying a mapping of the visual object(s) to the data profile to the computer system. In some embodiments, the system can be configured to transmit the information prior to initiation of the operation. In some embodiments, the system can be configured to transmit the information after initiation of the operation. For example, the system can be configured to transmit the information in response to detecting initiation of the operation.

In some embodiments, the system can be configured to transmit data for activating one or more visual objects to the computer system. For example, the system can be configured to transmit identifiers of the visual object(s) to the computer system. In some embodiments, the system can be configured to store a mapping of the visual object(s) to the identification information of the data profile. When the system identifies that the identification information is applicable to the operation, the system can be configured to transmit the data for activating the visual object(s) with the identification information and/or after transmitting the identification information. For example, when the system identifies that an operation is taking place with an external computer system with which a user's loyalty program membership is associated with, the system can be configured to transmit the data for activating the visual object(s).

Next, process 500 proceeds to act 504 where a modification to the operation is triggered. In some embodiments, by transmitting the identification information and/or the data for executing the visual object(s) the system can trigger modification of the operation. In some embodiments, the computer system can use information received from the system to activate the visual object(s). The visual object(s), in response to being activated, can be configured to automatically apply the modification to the operation. For example, the external computer system with which the system is interacting to perform the operation can have a database of stored visual object identification information for multiple visual objects associated with the retailer system. The system executing process 500 can be configured to transmit stored identification information of one or more visual objects to the computer system which can then look up the visual object(s) in the computer system. The computer system can then automatically activate the identified visual object(s) to apply the modification. For example, the visual object(s) can be configured to modify a price of one or more items involved in a purchase operation.

Next, process 500 proceeds to act 506, where the system receives operation data. In some embodiments, the system can be configured to receive operation data in response to the triggering of the modification to the operation (e.g., by activation of the visual object(s)). In some embodiments, the system can be configured to receive information about the operation. In some embodiments, the information can include information about the modification applied to the operation. The system can receive data indicating a result of the operation without any modification, and data indicating a result of the operation as a result of the modification. For example, the system can receive a price without the modification and a price actually paid as a result of the modification in a purchase operation.

Next, process 500 proceeds to act 508 where the system determines a difference resulting from modification applied by the visual object(s). In some embodiments, the system can be configured to use the received operation data to determine the difference. The system can be configured to compare a result of the operation without the modification (e.g., an original result) to an actual result of the operation (e.g., resulting from the modification). For example, the system can be configured to determine a difference in price between a price of a purchase without the modification and a price of the purchase after the modification.

Next, process 500 proceeds to act 510 where the system stores a record for the operation. In some embodiments, the system can be configured to store the determined difference in the record for the operation. In some embodiments, the system can be configured to store a record in a log of previously performed operations. In some embodiments, the system can be configured to store additional information about the operation. For example, the information can include a date, time, location, identification of one or more visual objects activated during the operation, and/or other information about the operation.

Next, process 500 proceeds to act 510 where the system transmits program instructions to a second computer system that, when executed, trigger capturing of the difference. In some embodiments, the program instruction trigger one or more actions in accordance with the difference. For example, the program instructions can trigger transmission of funds equivalent to a portion of difference in price of a purchase operation that resulted from activation of one or more visual objects. The program instructions can, for example, trigger transmission of funds to an account designated by the user. In some embodiments, the system can be configured to transmit the program instructions immediately after the operation is complete. In some embodiments, the system can be configured to transmit the program instructions a period of time after the operation is complete. For example, the system can be configured to transmit the program instructions an hour, a week, or a week after the completion of the operation.

In some embodiments, the system can be configured to automatically capture differences that can be captured after completion of an operation. For example, the system can be configured to automatically capture a difference resulting from use of a rebate offer. In some embodiments, system can be configured to get approval from a user to monitor his/her communications associated with the operation (e.g., emails). Upon receiving approval, the system can be configured to monitor the emails that come in looking for those that are tied to a purchase (essentially receipts). For example, the email receipts can contain information about the purchase (retailer, item, purchase date, amount, etc.). The system can be configured to capture information on rebates. The system can be configured to submit the necessary information on behalf of the user to the external computer system to obtain a rebate.

In some embodiments, the system can be configured to capture one or more additional amounts (e.g., a fee) for processing and/or distribution of the captured difference. In some embodiments, the system can be configured to trigger transmission of the additional amount(s) to respective recipients. For example, the system can be configured to trigger transmission of the additional amount(s) by the system, a third party system, or another system to accounts associated with the respective systems. In some embodiments, the system can be configured to determine an allocation of the additional amount(s) between one or more third parties, and to trigger transmission of the additional amount(s) accordingly. For example, the system can be configured to determine a portion that is to be transmitted to an entity managing the system, and a portion that is to be transmitted to an entity managing a third party system. The system can then transmit program instructions to the one or more systems to trigger transmission of portions of the additional amount(s).

In some embodiments, the system can be configured to determine whether a portion of a difference that is to be transmitted to a recipient meets a minimum required amount. For example, the system can be configured to determine whether a portion of a difference that is to be transmitted to a first recipient meets a minimum amount required for receiving transmissions by the first recipient. In some embodiments, if the portion of the difference does not the meet the minimum requirement, the system can be configured to accrue multiple portions of differences until the multiple portions sum to an amount that meets the minimum requirement. For example, the system can be configured to aggregate multiple differences that are to be transmitted to a recipient. In response to the aggregate differences meeting a minimum required amount, the system can be configured to transmit instructions to a third party system associated with the recipient to trigger transmission of the aggregated difference.

In some embodiments, after completion of the process 500 and/or after completion of an operation, the system can be configured to return to a start state. For example, the system can be configured to listen for another operation.

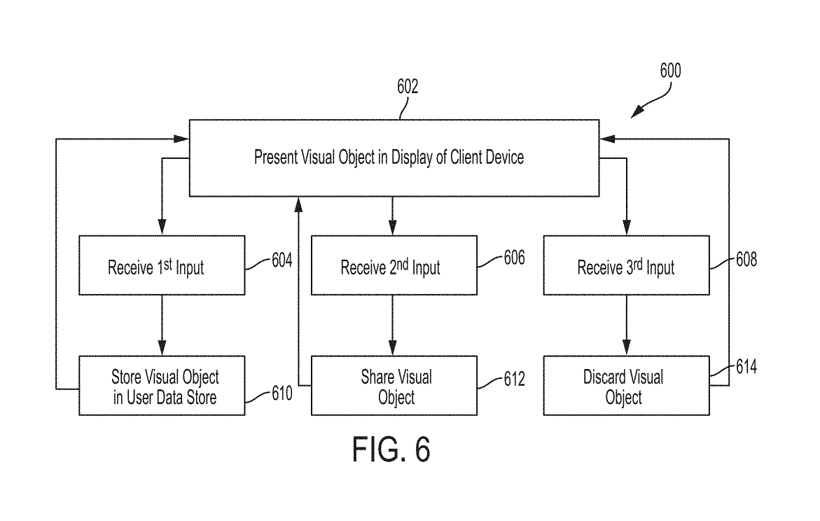

FIG. 6 illustrates a flow chart of an example process 600 according to which a system can process a visual object based on one or more user inputs available to a user in a dynamic user interface presented by the system. Process 600 can be performed, for example, by visual object management system 110 described above with reference to FIG. 1. Example user interfaces for implementing process 600 are discussed herein.

Process 600 begins at act 602 where the system presents a graphical representation of a visual object in a display of a client device. In some embodiments, the system can be configured to generate a user interface screen in an application executing on the client device. The system can display a graphical representation of the visual object within the user interface screen. The graphical representation can include an image of a portion of the visual object, a short textual description of the visual object, values one or more visual object features, and other information about the visual object. In some embodiments, the system can be configured to respond to multiple different user inputs. For example, the system can be configured to generate the user interface screen in an application executing on a touch screen device. In this example, the system can be configured to respond to different types of user touch inputs.

If the system receives a first input shown at block 604, the process 600 proceeds to block 610 where the system stores the visual object in a data store associated with the user. In some embodiments, the system can be configured to store a data store (e.g., a wallet) of visual objects which the user has selected to store. For example, the user can store the visual objects for use during subsequent operations. In some embodiments, the first input can comprise a swipe in a first direction on a screen of the client device. For example, the system can be configured to present an image representing the visual object in a user interface screen, and the user can swipe right on a touch screen of the client device. In another example, the first input can comprise a drag operation with a mouse or touch pad. In yet another example, first input can comprise a specific keyboard entry.

If at block 602 the system receives a second input shown at block 606, the process 600 proceeds to act 612 where the system allows sharing of the visual object. In some embodiments, the system can be configured to communicate the visual object to another user in response to the second input. The system can be configured to generate a second user interface screen in response to the second input, wherein the second user interface screen allows the user to select another user to whom to communicate the visual object. In some embodiments the second input can comprise a different type of input than the first input. In some embodiments, the second input can comprise a swipe in a different direction than that of the first input. For example, the second input can comprise a swipe in an upward direction. In another example, the second input can comprise a mouse or touch pad drag in a different direction than the first input. In yet another example, the second input can comprise a keyboard entry different from that of the first input.

If at block 602 the system receives a third input shown at block 608, the process 600 proceeds to act 614 where the system discards the visual object. In some embodiments, the system can be configured to allow a user to discard visual objects. For example, the user may not be interested in certain visual objects and may wish not to use them. The user can select to discard the visual object. In response to a user input to discard the visual object, the system can be configured to delete the visual object from a user data store, move the visual object to a different data store, or perform another action. In some embodiments, the third input can comprise a user input different than the first and second inputs. For example, the third input can comprise a swipe in a direction different from the direction of the first and second user inputs. In another example, the third input can comprise a mouse or touch pad drag in a different direction than those of the first and second inputs. In yet another example, the third input can comprise a keyboard input different than those of the first and second input.

In some embodiments, the system can be configured to generate an indication of a user input in the display of the client device. In some embodiments, the system can be configured to generate a dynamic movement of the graphical representation of the visual object within the user interface screen. For example, in response to the first input (e.g., a swipe to the right) the system can be configured to generate a first movement of the graphical representation of the visual object in the user interface screen (e.g., movement to the right), in response to the second input (e.g., a swipe up) the system can be configured to generate a second movement of the graphical representation of the visual object (e.g., movement upward), and in response to the third input (e.g., a swipe left) the system can be configured to generate a third movement of the graphical representation of the visual object (e.g., movement to the left).

In some embodiments, after a user has selected to store or discard a visual object (e.g., by first or second input), the system can be configured to display a graphical representation of a different visual object. This may allow a user to easily select visual objects to store, discard, and/or share. Further, this may allow the system to receive a user input with respect to every visual object that the system presents to the user. This allows the system to receive more data points for modeling user behavior (e.g., storing, discarding, and/or sharing). These data points can allow the system to generate more accurate models for matching visual objects to the user, and thus match more effectively. With more accurate models (e.g., neural network), the system can present visual objects to the user that are more likely to be related and/or of interest to the user.

### Artificial Intelligence/Machine Learning System

Some embodiments can include an artificial intelligence or machine learning system for matching visual objects to a user. The artificial intelligence or machine learning system may be referred to herein as “machine learning system.” In some embodiments, the analytics component 114 of the visual object management system 110 can comprise a machine learning system for determining which visual objects to suggest to a user. In some embodiments, the machine learning system can be configured to use a hypothetical function. The machine learning system can be configured to use a trained model to determine one or more inputs of the hypothetical function which can be used to determine a match of a visual object to a user. For example, the model can comprise a trained model (e.g., a neural network, support vector machine) that determines values of certain parameters (e.g., variables) based on a set of inputs. In some embodiments, the machine learning system can be configured to use the parameters to determine whether to match a visual object to a user. In this manner, the machine learning system can be configured to match one or more visual objects to a user that are more relevant to the user.

In some embodiments, the machine learning system can be configured to store information about visual objects, users, and/or user interactions involving the visual objects (e.g., in database 117). In some embodiments, the machine learning system can be configured to regularly update data based on data that the machine learning system retrieves about the visual objects (e.g., metadata), data received about users (e.g., social media data, data inputted by the user), and/or data related to user actions (e.g., selection, discarding, sharing, and/or activation of one or more visual objects). In some embodiments, the machine learning system can be configured to store data in real time in response to user actions (e.g., selecting, discarding, sharing, and/or activation of one or more visual objects). In some embodiments, the machine learning system can be configured to add data to the database in response to user actions.

In some embodiments, the system can be configured to receive data from one or more external computer systems (e.g., as described above with reference to FIG. 4). The machine learning system can be configured to use the data for matching visual objects. For example, the machine learning system can be configured to receive data associated with user actions (e.g., purchase history) from the external computer system(s). In another example, the system can be configured to receive data about one or more visual objects from the external computer system(s). In yet another example, the system can be configured to receive data about user preferences from the external computer system(s). In some embodiments, the received data can be used to train the machine learning system (e.g., a model used by the machine learning system) as described herein.

In some embodiments, the machine learning system can be configured to use stored data to train a machine learning model which the system can be configured to use to determine a correlation between one or more visual objects and a user. In some embodiments, the machine learning system can be configured to use the machine learning model to determine a correlation between the visual object(s) and the user with respect to one or more variables and/or parameters. For example, the system can be configured to feed data into one or more neural networks which output indications of how the visual object(s) correlate to the user with respect to a generation, identity (e.g., gender, age), stage in life, and/or a region. In some embodiments, the machine learning system trains one or more models based on data stored by the system. In some embodiments, the machine learning system can be configured to regularly train and/or update models with new data that is acquired by the system (e.g., by retrieving data, and/or data logged from user actions).

In some embodiments, the machine learning system can be configured to use the model to determine one or more attributes of a visual object. In some embodiments, the machine learning system can be configured to use the model(s) to determine a correlation of a visual object to a user with respect to one or more attributes. For example, the model(s) can indicate whether a match exists between the user and the visual object with respect to gender, a generation, a stage in life, a region, event and/or other attributes. In some embodiments, the machine learning system can be configured to use the output of the model(s) to determine values of one or more parameters which the system can use in matching the visual object(s) to the user. For example, the machine learning system can be configured to determine values of one or more variables which the system can be configured to use to populate values in a matching algorithm. In some embodiments, the system can be configured to use the variable values in one or more equations. The system can be configured to use one or more results of the equation(s) to match the visual object(s) to the user.

In some embodiments, the machine learning system can be configured to use one or more neural network models to determine values of one or more parameters. For example, the machine learning system can be configured to train the neural network(s) using data stored by the system. To match one or more visual objects to a user, the system can be configured to input values of features of the visual object(s) and/or the user into the neural network(s). The neural network(s) can then output values of one or more parameters. The system can be configured to use the values of the parameter(s) to populate variables in an algorithm determining whether the visual object(s) match to the user. For example, the system can be configured to populate variables of an equation for use in matching the visual object(s) to the user.

In some embodiments, the machine learning system can be configured to use a neural network such as a multi-view deep neural network (MVDNN). In some embodiments, the machine learning system can be configured to use deep structured semantic models (DSSM). In some embodiments, the machine learning system can be configured to use a support vector machine (SVM) based model. Some embodiments can be configured to use a nearest neighbor model, decision trees, linear regression, clustering, and/or other types of machine learning models. Some embodiments are not limited to any particular type of machine learning model.

In some embodiments, the system can be configured to use semi-supervised learning to train a model in which the system uses both data points labeled with a particular class and data points that are unlabeled. In some embodiments, to use the unlabeled data, the system can be configured to use one or more underlying assumptions about the data. For example, the system can assume that points closer to each other have a high likelihood of sharing the same label, data points can be divided into clusters that each share the same label, and/or that data points can be mapped to a lower dimensional manifold than the space of their input. In some embodiments, the system can be configured to train the model using Bayesian methods in which the system assumes a parameterization of data points and then chooses a parameter value by determining which parameter value fits the data points best. In some embodiments, the system can be configured to use support vector machine to label the unlabeled data and determine a decision boundary that maximizes the margin of the labeled data. In some embodiments, the system can be configured to use graph-based methods to train the model. In some embodiments, the system can be configured to use a heuristic approach to train the model in which the system first trains a first model using the labeled data, then labels the unlabeled data points using the first model, and then trains a second model using the originally labeled data and the newly labeled data points.

In some embodiments, the system can be configured to use supervised learning techniques to train a model. In these embodiments, the system can be configured to use data points labeled with a class. In some embodiments, the system can be configured to use unsupervised learning. For example, the system can cluster data points that are not labeled with any class. Some embodiments are not limited to any particular method of training the model.

In some embodiments, the system can be configured to input data into a trained model of the machine learning system to determine parameter values to use in matching one or more visual objects. The system can input data associated with a visual object into the model to determine the parameter values. For example, for a respective visual object, the system can input a values of attributes associated with the visual object such as a brand and/or a face value associated with the visual object. In some embodiments, the machine learning system can input into a machine learning model (e.g., a neural network) one or more keywords associated with a visual object and/or a user. The system can be configured to use one or more outputs of the model to assign a value (e.g., weight and/or priority) to each of the keyword(s).

In some embodiments, the machine learning system can be configured to determine weights of one or more keywords associated with a user based on user actions. Example methods of assigning weights are discussed herein. The machine learning model (e.g., neural network) can be configured to output an indication of matches between a visual object and the user with respect to one or more attributes. In some embodiments, the system can be configured to compare one or more keywords associated with a visual object to one or more keywords associated with a user. For example, the system can be configured to determine whether the keyword(s) associated with the visual object are also associated with the user. In another example, the system can be configured to compare stored values associated with the keyword(s) for the visual object to the stored values associated with the keyword(s) for the user. In some embodiments, the system can be configured to use the comparison to determine values of parameters for use in matching the visual object to the user. Example parameters are described herein.

In some embodiments, the system can be configured to determine parameter values to use in matching one or more visual objects to a user based on user inputs. For example, the system can be configured to use parameter values for training a machine learning model and/or populating variables of a matching algorithm. In some embodiments, the system can be configured to adjust parameter values responsive to user actions (e.g., triggering activation of visual objects, storing of visual object, discarding of visual object, sharing of visual object). In some embodiments, the system can be configured to determine parameter values based on information input by the user. For example, the system can be configured to determine parameter values based on identification information entered by the user, search strings entered by the user, and/or other information entered by the user. In some embodiments, the system can be configured to determine parameter values based on user settings. For example, the user can apply settings in an application on a client device, and the system can use those settings to set parameters that are used by the machine learning system to match the visual object(s) to the user.

In some embodiments, the system can be configured to find a combination of features that can be used to distinguish between two or more classes. For example, the system can be configured to use LDA to find a linear combination of features that can be used to determine whether a respective visual object is related to a user or not. The system can be configured to use a training set of data that includes a set of input vectors and a corresponding output result for each of the input vectors. For example, each input vector can include values of one or more features about a visual object (e.g., age of a user, location, salary), and the output result can include a classification (e.g., related to a user or unrelated to the user). The system can be configured to use the training set to determine a point that can be used to classify a given set of feature values (e.g., a vector). For example, the system can be configured to determine a threshold value of a hypothetical function that can be used to determine whether a user is likely to select a visual object for storage in a wallet or to discard the visual object.

In some embodiments, the hypothetical function can be configured to represent different aspects of a user. For example, the hypothetical function can include parameters representing cultural and social factors, internal factors, and psychological factors (e.g., related to motivation, perception, learning, and/or attitude). In some embodiments, the system can be configured to use the hypothetical equation can comprise a comparative equation to determine matching of a visual object to a user. The system can be configured to determine values of one or more variables of the comparative equation. For example, the values of the variable(s) can be determined by outputs of a machine learning system, a user's actions (e.g., purchase, activation of visual objects, selection of visual objects), information entered by the user, and/or a user's settings (e.g., in an application). An example comparative equation is shown in equation 1.0 below.

W=Fₑ+Fᵢ+P_{f} 1.0

In some embodiments, the parameter Fₑ in equation 1.0 can represent internal factors such as identity information about a given user. For example, the identity information can include gender, marital status, region, race, generation, and/or stage in life. In some embodiments, the parameter Fᵢ can represent external factors such as actions taken by the user via a computer system (e.g., a computer or mobile device). These actions can include searches performed by the user, notification settings set by the user, preferences set by the user, application settings set by the user, visual objects that the user has chosen to store, visual objects that the user has chosen to discard, and/or loyalty cards added by the user. In some embodiments, P_{f} can represent cognitive factors. For example, the cognitive factors can include motivation of the user, perception, learning, and/or an attitude of the user.

In some embodiments, the system can be configured to incorporate variables associated with different factors of a user's identity to incorporate the identity information to determine a value for the parameter Fₑ in equation 1.0. In some embodiments, the system can be configured to create a profile variable to combine multiple other variables. The profile variable can be configured to represent a how closely related a visual object is to a user with respect to internal factors (e.g., an identity of the user). For example, the system can be configured to determine a profile value Pᵤₛₑᵣ based on a generation variable G² (e.g., generation X, generation Y, baby boomer, senior), an identification variable g² (e.g., male or female), a stage variable Sₜ² (e.g., high school student, college student, parent), and/or region variable r² (e.g., country, continent, state, city). In some embodiments, the system can be configured to determine whether there is a correlation between a user and a visual object for each of the variables (e.g., using an output of a trained neural network model). For example, the system can be configured to input values of one or more features of a visual object for display and/or values of one or more features of a user into a trained neural network to determine correlation of the visual object and the user for one or more variables. In another example, the system can be configured to determine whether information in a data profile of the visual object for display correlates with information in a data profile of the user. The system can be configured to correlate generation information (e.g., generation identification), identification information (e.g., gender), life stage information (e.g., age, professional status), and/or region information (e.g., location). In some embodiments, if the system determines that there is a correlation for a variable, the system can be configured to assign a value (e.g., 2) to the variable. If the system determines that there is not a correlation for the variable, the system can be configured to assign a different value (e.g., 1) to the parameter. The system can then use values for each of the variables to determine the profile value Pᵤₛₑᵣ. For example, the system can be configured to use the equation 1.1 shown below:

Pᵤₛₑᵣ=\sqrt{G²+g²+Sₜ²+r²} 1.1

In some embodiments, the system can be configured to use additional or alternative parameters related to a user's identity than those described herein. For example, the system can be configured to use race, religion, ethnicity, and/or other parameters. Some embodiments are not limited to particular factors or types of information described herein.

In some embodiments, the system can be configured to adjust a profile value of a user based on frequency of use of the visual object using a count variable. For example, the system can be configured to adjust the profile value based on how often the visual object has been selected for storing and/or activated during an operation. The system can be configured to store a count variable U_{count} representing the frequency of use of the visual object. For example, U_{count} can represent how often the visual object has been stored and/or applied by other users. The system can be configured to use the value of the count U_{count} to determine a value of the parameter Fₑ representing an identity of the user. For example, the system can be configured to calculate Fₑ according to the equation 1.2 below:

Fₑ=U_{count}*Pᵤₛₑᵣ 1.2

In some embodiments, the system can be configured to determine a value of the parameter Fᵢ in equation 1.0 based on external factors such as user actions. For example, the system can be configured to determine Fᵢ based on one or more keywords associated with the user, whether the user requested a notification for an attribute associated with the visual object (e.g., a brand, retail, product), whether a class (e.g., a category) of the visual object was chosen by the user as a preferred category, whether the retailer and/or brand was selected by the user as a preferred brand, and/or a distance that a user is located from a location associated with execution of the visual object (e.g., location of an execution location). For example, the system can be configured to determine a value for Fᵢ according to equation 1.3 below:

$${F}_{i} = \frac{( {\sum }_{k = 0}^{5} ( \begin{matrix}5 \\ k\end{matrix} ) {K}_{i} ) + N * {C}_{p} + R + {B}_{p}}{{L}^{2}} \qquad 1.3$$

In some embodiments, the system can be configured to determine a semantic variable. The system can be configured to store one or more keywords to use in matching a visual object to a user. In some embodiments, the system can be configured to store a value (e.g., a weight) for each of the keyword(s). The keywords and associated values can be used to calculate the semantic variable. In some embodiments, the value can represent how closely related to the user the keyword(s) are. For example, the system can be configured to assign a value to each keyword. In some embodiments, the value can comprise a value in a range between 0-5, 0-10, 0-100, or value in another range. Some embodiments are not limited to a particular range of possible values associated with a keyword. A keyword can comprise a string of one or more characters.

In some embodiments, in equation 1.3, Kᵢ can represent presence of one or more key words associated with the user in a visual object. In some embodiments, the system can be configured to store keywords. In some embodiments, the system can be configured to store a value (e.g., 1-5) for each stored keyword. Some embodiments can use other values for each stored keyword (e.g., 0, 1, 2, 3, 4, 5). In some embodiments, the system can be configured to use keywords and their associated values for training one or more machine learning models (e.g., a neural network) used in determining correlation of a visual object with the user.

Keywords related to a visual object can include words actually present in the object (e.g., in text of the visual object), synonyms associated with words in the visual object, words related to a provider of a visual object (e.g., a retailer identity, brand identity, or other word), and/or keywords related to the visual object in other manners. Some embodiments are not limited to a particular method by which keywords are related to a visual object.

In some embodiments, the system can be configured to automatically set or modify values associated with keywords in response to a user's actions. In some embodiments, the system can be configured to set and/or update values in response to user interactions with the visual object management system (e.g., visual object management system 110). For example, the user can interact with the system via a user interface presented to the user on a display of a mobile device or computer. The system can be configured to update values associated with keywords in response to user actions. In some embodiments, the system can be configured to increase stored values, decrease stored values, or perform another operation to change stored values associated with keywords. For example, the system can be configured to add or subtract a certain amount to or from a value in response to particular user action. For example, the system can be configured to add/subtract 1, 2, 3, 4, or other number to/from values associated with one or more keywords in response to a user action.

In some embodiments, the system can be configured to update values of keywords present in a visual object when a user selects to store a visual object, discard a visual object, and/or apply a visual object (e.g., to an operation). The system can be configured to update values associated with one or more keywords that appear in the visual object in response to the user action. For example, if the user selects to store a visual object, the system can be configured to increase a value stored for one or more keywords related to the visual object. In another example, if the user selects to a discard a visual object, the system can be configured to decrease a value stored for the keyword(s) related to the visual object. In yet another example, if the visual object is activated (e.g., during an operation), then the system can be configured to increase values stored for the keyword(s) related the visual object.

In some embodiments, the system can be configured to update values associated with keywords in response to a user receiving a visual object via the visual object management system (e.g., visual object management system 110). For example, the user can receive a visual object shared with the user from a different user. In some embodiments, the system can be configured to update values associated with keywords in response to a user receiving a visual object. In some embodiments, the system can be configured to update the values associated with the keywords in response to a user's interaction with a visual object after receiving the visual object. For example, the system can be configured to increase values associated with one or more keywords related to a visual object when a user initially receives the visual object. Subsequently, the system can be configured to update the value associated with the keyword(s) in response to a user action (e.g., storing, deletion, sharing).

In some embodiments, the system can be configured to update values associated with one or more keywords based on one or more user settings. In some embodiments, the setting(s) can comprise communication trigger settings (e.g., notification settings). In some embodiments, the visual object management system can be configured, by a user, to generate a communication (e.g., a notification) in response to receiving or presenting a visual object that matches a set of one or more attributes. For example, the attributes may include a brand associated with the visual object, a face value of the visual object, a location associated with the visual object, a time associated with the visual object, or other attribute of the visual object. In some embodiments, the system can be configured to determine when a device of the user receives a notification related to a visual object. In response, the system can be configured to update values of one or more keywords related to the visual object as described herein.

In some embodiments, the system can be configured to update values associated with one or more keywords based on a visual object preference of the user. In some embodiments, the system can be configured to determine that the user has a preference for a particular attribute of one or more visual objects. For example, the system can be configured to determine that the user has a preference for visual objects associated with a particular brand, retailer, location, or other factor. In some embodiments, the visual object management system can be configured to receive a user selection specifying one or more preferred attributes (e.g., a preferred brand, preferred location). In some embodiments, the system can be configured to update one or more keywords associated with the preferred attribute(s). For example, the system can be configured to update the keyword(s) associated with a preferred brand, retailer, location, season, and/or other attribute of visual objects. In some embodiments, the system can be configured to increase a stored value for a word in response to determining an association of the word with a preference of the user.

In some embodiments, the system can be configured to update values associated with one or more keywords based on how recently a user has performed an action related to the keyword(s). In some embodiments, the system can be configured to decrease values associated with one or more keywords when the keyword(s) are not associated with a user action for a time period (e.g., one day, a week, a month). In some embodiments, the system can be configured to store a weight for each keyword. The system can be configured to adjust the weight based on how recently the user has performed an action related to the keyword. For example, if one or more keywords are not associated with any visual objects that a user has selected to store for a period of time (e.g., a day, a month, a year), the system can be configured to decrease a weight associated with the keyword(s). In another example, if the keyword(s) have been associated with multiple recent visual objects that a user has selected to store, the system can be configured to increase weights associated with the keyword(s). In some embodiments, the system can be configured to update the weights associated with the keyword(s) at a certain frequency (e.g., every day, every month, every year).

In some embodiments, in equation 1.3, a communication variable N can indicate whether the user requested a communication trigger (e.g., notification) for values of one or more features of the visual object (e.g., retailer, brand, product). For example, if the user requested a notification for visual objects associated with a particular brand identifier, the system can set N to (1) first value (e.g., 2) when the visual object for display has the brand identifier as the value of its brand feature, and (2) to a second value (e.g., 1) if the visual object for display does not have the brand identifier as the value of its brand feature.

In some embodiments, a classification variable Cₚ can represent whether the user selected a class (e.g., a category) associated with the visual object as a preferred class. For example, if the user selected category as a preferred category, the system can set Cₚ to a first value (e.g., 2), and if the user did not select the category as a preferred category then the system can set Cₚ to a second value (e.g., 1). In some embodiments, a third party variable R can represent whether the user selected a retailer associated with the visual object as a preferred retailer. For example, if the user selected retailer as a preferred retailer, the system can set R to a first value (e.g., 2), and if the user did not select the retailer as a preferred retailer, then the system can set R to a second value (e.g., 1). In some embodiments, a third party variable Bₚ can represent whether the user selected a brand associated with the visual object as a preferred brand. A third party variable can be determined based on an activation of a third party identifier. For example, if the user selected the brand as a preferred category, the system can set Bₚ to a first value (e.g., 2), and if the user did not select the brand as a preferred brand then the system can set Bₚ to a second value (e.g., 1). In some embodiments, the system can be configured to store a Boolean status for user preferences of values of various attributes (e.g., category, retailer, and/or brand). The system can be configured to use the Boolean status to assign values to variables (e.g., classification variable, and/or third party variables). In some embodiments, if the user has selected a value of an attribute (e.g., category, retailer, and/or brand) as a preferred value for the attribute, the system can be configured to store a Boolean status set to true for the value of the attribute. If the user has not selected the value of the attribute as a preferred value, the system can be configured to store the Boolean status as false. The system can be configured to use the stored Boolean status to assign values to one or more variables. For example, the system can assign a first value (e.g., 1) if the Boolean status is set to true, and assign a second value (e.g., 2) if the Boolean status is set to false.

In some embodiments, a distance variable L may represent a distance between the user and a location associated with the visual object (e.g., a retailer location, product location). For example, the system can be configured to calculate L according to equation 1.4 below:

$$L = \frac{1}{{d}^{2}} \qquad 1.4$$

In some embodiments, the system can be configured to determine values of one or more features (e.g., attributes) of a visual object. In some embodiments, the system can be configured to determine values of the feature(s) using information retrieved from one or more external computer systems. For example, the system can be configured to identify the values based on a source of a visual object, and/or information stored with the visual object when retrieved. In some embodiments, the system can be configured to determine the values based on one or more outputs of a machine learning model. For example, the system can be configured to input information about the visual object into the machine learning model and to use an output of the machine learning model to determine values of the feature(s).

In some embodiments, in equation 1.4, in some embodiments, d can be a distance between a user's location and a location associated with the visual object (e.g., associated with activation of the visual object). For example, the system can set d equal to a distance between the user's current location and a location of a retailer associated with the visual object. In some embodiments, the system can be configured to access the user location from a device (e.g., mobile device, computer). For example, the system can be configured to ping a GPS system of the device to retrieve a current location of the device. In some embodiments, the system can be configured to determine the location associated with the visual object based on an output of a machine learning model (e.g., neural network). The system can be configured to input information about the visual object into the machine learning model to determine the location associated with the visual object.

In some embodiments, the system can be configured to determine a value for the cognitive parameter P_{f} in equation 1.0. In some embodiments, the system can be configured to use unstructured data representing one or more cognitive factors including motivation, perception, learning, and/or an attitude of the user. In some embodiments, the system can be configured to determine P_{f} based on one or more indicators of the cognitive factor(s). For example, the system can be configured to determine P_{f} based on a life event (e.g., a graduation, new job, marriage, holiday), keywords that the system has associated with the user based on visual objects that the user has selected in the past, visual character preferences of the user, face value of a visual object, and/or a user's preferences for other aspects of a visual object. In some embodiments, the system can be configured to determine P_{f} based on an event variable E² representing one or more life events, a semantic variable K_{d} representing keywords associated with the user, a character variable S_{ch} representing one or more special character preferences of the user, and/or a face variable Mₙ representing one or more face value preferences of the user. For example, the system can be configured to calculate P_{f} based on equation 1.5 below.

$${P}_{f} = {E}^{2} + ( {\sum }_{k = 0}^{5} ( \begin{matrix}5 \\ k\end{matrix} ) * {K}_{d} ) * {M}_{n} + {S}_{ch} \qquad 1.5$$

In some embodiments, in equation 1.5, the system can be configured to determine E² based on presence of one or more life events using one or more event indicators. For example, the system can calculate E² according to equation 1.6 below.

E²={square root over ((e₁²+e₂²+e₃²+ . . . )} 1.6

In some embodiments, in equation 1.6, each of the parameters eₓ² can comprise an even indicator or identifier that indicates a status (e.g., occurrence or presence) of a corresponding life event. For example, e₁² can indicate that it is Christmas time, e₂² can represent the user having a child, and e₃² can represent the user graduating. In some embodiments, the system can be configured to set values for the individual life event indicators. The system can be configured to store a status of the life event indicators. For example, if the system determines that a life event is occurrence, the system can be configured store a first value (e.g., 2) for the corresponding life event parameter. If the system determines that a life event has not occurred or is not present, the system can be configured to store a second value (e.g., 1) for the corresponding life event parameter. In some embodiments, when the system determines P_{f} for a particular visual object, the system can be configured to access the stored values for each life event parameter.

In some embodiments, the system can be configured to determine the event variable based on a status of one or more event indicators. In some embodiments, the system can be configured to determine values of eₓ² based on an output of a machine learning model. For example, the system can be configured to input information about a visual object for display into a machine learning model and to use the output of the machine learning model to determine an association of the visual object with one or more life events. For life events that the visual object is correlated with, the system can be configured to set values of eₓ² based on whether the life event is also present for the user. For example, the system can be configured to use the output to determine that a visual object is associated with a graduation life event and that a graduation life event is present for the user. In this example, the system can be configured to set a value of e₁ equal to a first value (e.g., 2). If, however, it is determined that the life event is not present for the user, the system can be configured to set the value of e₁ to a second value (e.g., 1).

In some embodiments, in equation 1.5, K_{d} can represent correlation of one or more key words associated with the user to a visual object. In some embodiments, the system can be configured to store preferred keywords for a user based on a user's selection of visual objects. For example, if the user selects to store a visual object, the system can be configured to store one or more words present in the visual object as preferred keywords of the user. In some embodiments, the system can be configured to store a value (e.g., 1-5) for each stored preferred keyword. In some embodiments, the system can use other values (e.g., 0, 1, 2, 3, 4, 5, 6-10, 10-100). For example, the value can comprise a weight associated with the keyword. In some embodiments, the system can be configured to calculate K_{d} based on values associated with the keyword(s) associated with the user. For example, the system can be configured to calculate K_{d} as a sum of stored values for one or more preferred keywords that are present in a visual object.

In some embodiments, the system can be configured to add keywords and values (e.g., weights) associated with the keywords to a stored collection of keywords (e.g., in database 117 of system 110). In some embodiments, the system can be configured to store new keywords based on one or more actions performed by the user. In some embodiments, the system can be configured to store new keywords based on searching performed by the user. For example, the user may search for visual objects, products, or other information. The system can be configured to store the user's search keywords and/or related words. In some embodiments, the system can be configured to store keywords based on a user's profile settings. For example, the user can specify various interests, a location, age, birthday, and/or other information about the user. The system can be configured to store words related to the user's profile information. These words may include words from the profile itself, and/or words related to characteristics of the user (e.g., interests, age, location).

In some embodiments, the system can be configured to store new keywords in response to a user's actions. In some embodiments, the system can be configured to store new words and values with the visual object management system (e.g., visual object management system 110). For example, the user can interact with the system via a user interface presented to the user on a display of a mobile device or computer. The system can be configured to add keywords and associated values based on the user's actions in the user interface.

In some embodiments, the system can be configured to add keywords and associated values related to a visual object when a user selects to store a visual object, discard a visual object, and/or apply a visual object (e.g., to an operation). The system can be configured to add the keywords and associated values in response to the user action. For example, if the user selects to store a visual object, the system can be configured to store one or more keywords related to the visual object and associated values for the keywords. In another example, if the user selects to a discard a visual object, the system can be configured to store keywords related to the visual object and values associated with the word (e.g., negative values for deletion). In yet another example, if the visual object is applied (e.g., to an operation), then the system can be configured to store the keyword(s) related the visual object.

Keywords related to a visual object can include words actually present in the object (e.g., in text of the visual object), synonyms associated with words in the visual object, words related to a provider of a visual object (e.g., a retailer identity, brand identity, or other word), and/or keywords related to the visual object in other manners. Some embodiments are not limited to a particular method by which keywords are related to a visual object.

In some embodiments, the system can be configured to store one or more new keywords in response to a user receiving a visual object via the visual object management system (e.g., visual object management system 110). For example, the user can receive a visual object shared with the user from a different user. In some embodiments, the system can be configured to store the keyword(s) and associated value(s) in response to a user receiving a visual object. In some embodiments, the system can be configured to add the keyword(s) and value(s) in response to a user's interaction with a visual object after receiving the visual object. For example, the system can be configured to add one or more keywords related to a visual object when a user initially receives the visual object. Subsequently, the system can be configured to update the value associated with the keyword(s) in response to a user action (e.g., storing, deletion, sharing).

In some embodiments, the system can be configured to store one or more keywords and associated values based on one or more user settings. In some embodiments, the setting(s) can comprise notification settings. In some embodiments, the visual object management system can be configured, by a user, to generate a notification in response to receiving or presenting a visual object that meets a set of one or more attributes. For example, the attributes may include a brand associated with the visual object, a face value of the visual object, a location associated with the visual object, a time associated with the visual object, or other attribute of the visual object. In some embodiments, the system can be configured to determine when a device of the user receives a notification related to a visual object. In response, the system can be configured to store one or more keywords related to the visual object and associated values.

In some embodiments, the system can be configured to store one or more new keywords and associated values based on a visual object preference of the user. In some embodiments, the system can be configured to determine that the user has a preference for a particular attribute of one or more visual objects. For example, the system can be configured to determine that the user has a preference for visual objects associated with a particular brand, retailer, location, or other factor. In some embodiments, the visual object management system can be configured to receive a user selection specifying one or more preferred attributes (e.g., a preferred brand, preferred location). In some embodiments, the system can be configured to store one or more keywords associated with the preferred attribute(s) and associated values. For example, the system can be configured to store the keyword(s) associated with a preferred brand, retailer, location, season, and/or other attribute of visual objects. In some embodiments, the system can be configured to store a word in response to determining an association of the word with a preference of the user.

In some embodiments, in equation 1.5, a character variable S_{ch} can represent a special character preference of the user. For example, the user may have a preference for certain brands, logos, colors, or other aspects of a visual object. The system can be configured to store information indicating that user's preferences. In some embodiments, if the special character is present in the visual object, the system can be configured to set S_{ch} to a first value (e.g., 2). If the special character is not present in the visual object, the system can be configured to set S_{ch} to a second value (e.g., 1). In some embodiments, the character variable can be determined based on correlation of characters to one or more visual objects. For example, the system can be configured to determine the character variable based on a correlation of character to visual objects triggered for activation and/or visual objects selected for storage by the user.

In some embodiments, in equation 1.5, a face variable Mₙ can represent a face value preference of the user. A face value may indicate a particular value of a visual object (e.g., a price, savings earned using the visual object, or other valuation). For example, the user may have a preference visual objects with a particular face value or range of face values. The system can be configured to store information indicating that user's preferences. In some embodiments, if the visual object has a preferred face value or is within a range of preferred face values, the system can be configured to set Mₙ to a first value (e.g., 2). If the visual object does not have the preferred face value or is not within a range of preferred face values, the system can be configured to set Mₙ to a second value (e.g., 1). In some embodiments, the character variable can be determined based on correlation of reward values (e.g., face values) to one or more visual objects. For example, the system can be configured to determine the character variable based on a correlation of one or more face values to visual objects triggered for activation and/or visual objects selected for storage by the user. A face value of a visual object can represent a difference in an operation obtained as a result of activation of a visual object for display.

In some embodiments, the system can be configured to store values of one or more parameters used by the system with metadata associated with a context in which the parameter(s) had a value. For example, the system can be configured to store values of the parameter(s) and an indication of a time, date, and/or location of the user when the parameter(s) had the values. In some embodiments, the system can be configured to store values of parameter(s) in a format that captures the values of the parameter(s) with respect to time, date, and/or location. For example, the system can be configured to store a multidimensional matrix in which the system stores values of the parameter(s) in a first dimension, a time at which the parameter(s) had the values in a second dimension, and/or a location at which the parameter(s) had the values in a third dimension.

In some embodiments, the system can be configured to determine which visual objects to suggest to a user based on metadata associated with values of one or more parameters. For example, the system can be configured to use the values of the parameter(s) associated with the most recent time and/or location, use the values of the parameter(s) associated with a particular range of time, and/or use the values of the parameter(s) associated with a particular location.

In some embodiments, the system can be configured to store new values or update existing values of one or more parameters in response to user actions. In some embodiments, the system can be configured to store values of the parameter(s) in real time in response to user actions. For example, in response to a user selection of a visual object, the system can be configured to store values of one or more keywords. In another example, the system can be configured to store a value of a parameter representing frequency of use of a visual object in response to users storing and/or applying the visual object to an operation. In yet another example, the system can be configured to store a value of a parameter representing a stage of life of a user in response to receiving information indicating a change in the stage of life of the user (e.g., a social media update).

In some embodiments, the system can be configured to collect both structured and unstructured data. In some embodiments, the system, to store unstructured data, the system can be configured to store data associated with user actions (e.g. interactions with visual object management system 110). The system can be configured to store data associated with user interactions along with metadata indicating a context of the interaction (e.g., time, date, location). In some embodiments, the system can be configured to store metadata associated with user actions in a log. For example, the system can be configured to maintain a log of user actions (e.g., selection, deletion, and/or application of visual objects) along with metadata associated with the user actions. In some embodiments, the system can be configured to store metadata related to visual objects from other sources. For example, the system can be configured to store metadata related to visual objects from a dictionary, thesaurus, and/or online encyclopedia. In some embodiments, the system can be configured to store parameters related to an expiration date associated with a visual object, a special character preference of a user, and/or location of a user.

In some embodiments, the system can be configured to store a data object for one or more visual objects. The system can be configured to store a status of whether the visual object has been matched to the user. In some embodiments, the system can be configured to store one or more keywords, combinations of the keyword(s) and associated values for the keyword(s) and combinations. In some embodiments, the system can be configured to store one or more keywords related to keywords in the visual object. For example, the system can be configured to store synonyms of the keywords in the visual object

In some embodiments, the system can be configured to store a data object for one or more locations. The system can be configured to store information about one or more entities associated with the location in the data object. For example, the system can be configured to store identities of one or more retailers, and/or products associated with the location.

In some embodiments, the system can be configured to store a data object for storing identification information of one or more data profiles of a user associated with external computer systems (e.g., loyalty cards). The system can be configured to store an indication of whether a user has membership for a particular loyalty program.

In some embodiments, the system can be configured to store a data object for one or more friends of a user. The system can be configured to store data related to visual objects communicated from the friend(s) and/or visual objects sent to the friend(s). For example, the system can be configured to store metadata related to the communicated visual objects. In some embodiments, the system can be configured to store one or more suggested friends of the user.

In some embodiments, the system is configured to store a data object for one or more communication trigger settings (e.g., notifications settings) of the user. The system can be configured to store notifications settings of the user in the data object. For example, the system can be configured to store indications that a user has selected to receive a notification for visual objects having a particular value of a feature (e.g., brand, retailer, location).

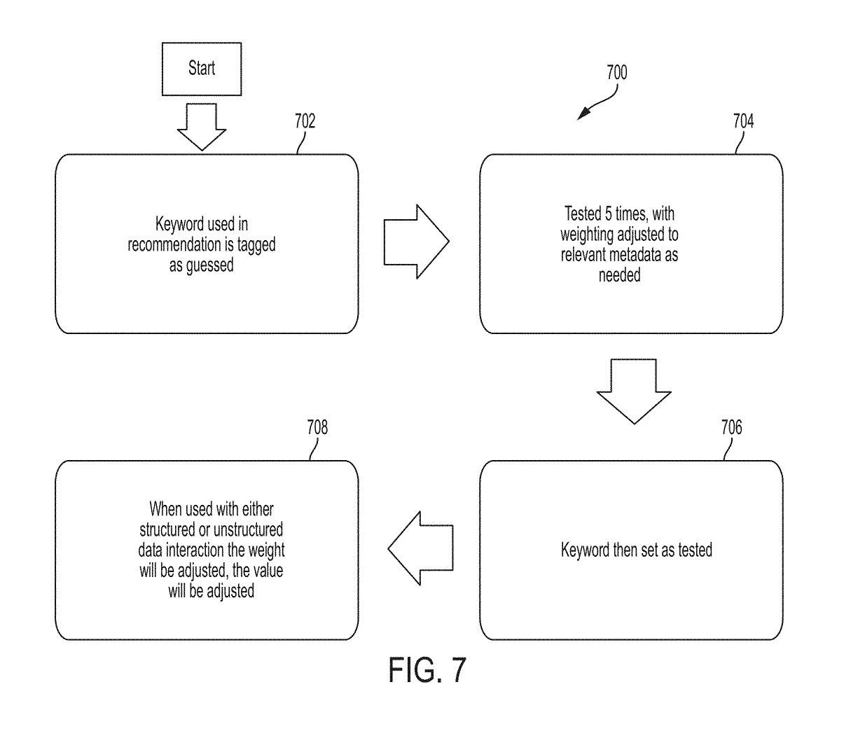

FIG. 7 illustrates an exemplary process flow 700 by which a system (e.g. system 110) can be configured to store a value associated with a keyword for use in matching a visual object to a user.

In some embodiments, process 700 can be initiated by one or more user actions. For example, a user may enter one or more keywords to be searched in a search user interface and the system, in response, presents one or more visual objects that match the keyword(s) in a results user interface. The user may then select one of the visual object(s) presented to the user. In another example, the process 700 can be initiated when a visual object is matched to a user and presented to a user in a user interface. The user may, for example, be able to store the visual object or discard the visual object.

Process 700 begins at act 702, where a keyword related to a visual object that has been matched to a user is tagged as guessed. In some embodiments, the keyword can be one or more words used in the visual object. For example, the word(s) may be present in text of the visual object. In some embodiments, the keyword can be one or more words related to the visual object. For example, the word(s) can be synonyms of one or more words present in text of the visual object.

In some embodiments, the system can be configured to store a status of keywords used by the system to match a visual object for the user. In some embodiments, the system can be configured to store information indicating a testing status of a keyword. For example, the system can be configured to store information indicating whether the keyword has previously been ranked or scored, whether the keyword has been tested or not, whether the keyword is one that was guessed by the system, and/or whether the keyword is a special case keyword. The

Next process 700 proceeds to act 704, where the system tests the keyword a number of times (e.g., 1, 2, 3, 4, 5). In some embodiments, to test the keyword, the system can be configured to determine a user action associated with the keyword, and determine a value to store based on the action. For example, when the keyword is related to a visual object matched to the user, the system can be configured to determine an action that a user takes with respect to the visual object. In another example, the system can be configured to test a keyword based on a user action with respect to a loyalty program membership, a communicated visual object from a contact of the user. In yet another example, the system can be configured to test the keyword based on a search performed by the user, a notification received by the user, preferences being set by the user, location of the user, a life event of the user, or other action or attribute of the user. In some embodiments, the system can be configured to use the specific action taken by the user to set a value (e.g., rank, score, weight) for the keyword for the particular test. In some embodiments, the system can be configured to use the action by the user to apply adjustments to a value associated with the keyword. For example, if the user selects to store a recommended visual object that is related to the keyword being tested (e.g., the keyword is present in text of the visual object), the system can be configured to increase the value associated with the keyword. The system can be configured to decrease the value associated with the keyword if the user selects to discard the recommended visual object. One example of adjustments that the system can be configured to apply in response to various user actions is shown in Table 1 below.

TABLE 1

| USER ACTION | DATA POINTS/LOGGED DATA | VALUE ADJUSTMENT |
|---|---|---|
| Visual Object Stored by User | Visual object metadata: time, date, | +3 for phrases, +2 for individual |
| | retailer associated, category | words and +1 for the top 3 |
| | Data from visual object: price, product type | synonyms, +2 for each associated |
| | and product, combination used, location, | value on the coupon such as brand, |
| | category type. Expire date will also be added. | category. |
| | | Location noted as a count towards |
| | | preferred location. |
| Visual Object Discarded | Visual object metadata: time, date, | −2 for phrases, −1 for individual |
| | retailer associated, category | words and −1 for the top 3 |
| | Data from visual object: price, product type | synonyms, −1 for each associated |
| | and product, combination used, location, | value on the visual object such as |
| | category of visual object. | brand, category. |
| | | Location noted as a negative |
| | | count towards preferred location. |
| Visual Object Applied to User | Visual object metadata: time, date, | +3 for phrases, +2 for individual |
| Action | retailer associated, category | words and +1 for the top 3 |
| | Data from visual object: price, product type | synonyms, +2 for each associated |
| | and product, combination used, location, | value on the coupon such as brand, |
| | category of visual object | category. |
| | | Location noted as a count towards |
| | | preferred location. |
| Loyalty card added | Categories of products, visual objects | +2 for associated values |
| | associated with loyalty card, location, brands, | |
| | visual object categories, retailer, location | |
| Loyalty cards declined | Categories of products, visual objects | −3 for associated values |
| | associated with loyalty card, location, brands, | |
| | visual object categories, retailer, location | |
| Loyalty cards removed | Categories of products, visual objects | −3 for associated values |
| | associated with loyalty card, location, | |
| | brands, visual object categories, retailer, | |
| | location | |

Next, process 700 proceeds to act 706 where the system determines that the keyword has been tested. In some embodiments, the system can be configured to determine that the keyword has been tested in response to determining that the keyword has been tested a minimum number of times (e.g., 1, 2, 3, 4, 5). In some embodiments, each test that the system performs for a keyword can comprise a user action that the system has determined relates to the keyword. For example, the test can comprise a user action with respect to a visual object or loyalty card related to the keyword, a loyalty card related to the keyword, or a notification related to the keyword, or other user actions discussed herein. In some embodiments, when the keyword has been tested a threshold number of times, the system can be configured to store a status for the keyword as tested. In some embodiments, when the system sets the status of a keyword as tested, the system can be configured to use the keyword value in matching one or more other visual objects to the user. For example, the system can be configured to use the value of the keyword for calculating one or more parameter values described herein.

Next, process 700 proceeds to act 708, where the system can be configured to continue adjusting a value associated with the keyword. In some embodiments, the system can be configured to store, update, and/or adjust the value associated with the keyword. For example, in response to user actions. In some embodiments, the system can be configured to adjust the value when the keyword is used with a data interaction involving the keyword (e.g., structured or unstructured data).

In some embodiments, the system can be configured to maintain a ranking of keywords for a user. In some embodiments, the system can be configured to maintain a ranking based on values associated with one or more keywords. For example, the system can be configured to maintain a ranking of the keywords based on a stored value associated with the keywords. In some embodiments, the system can be configured to use a set of top ranked words in matching a particular visual object to a user. For example, the system can be configured to use the top 10, 20, 30, 40, or 50 keywords associated with a user in matching the visual object to the user. The system can be configured to use the keywords along with their values as described herein. For example, the system can be configured to calculate one or more parameter values based on relation of keywords to a visual object.

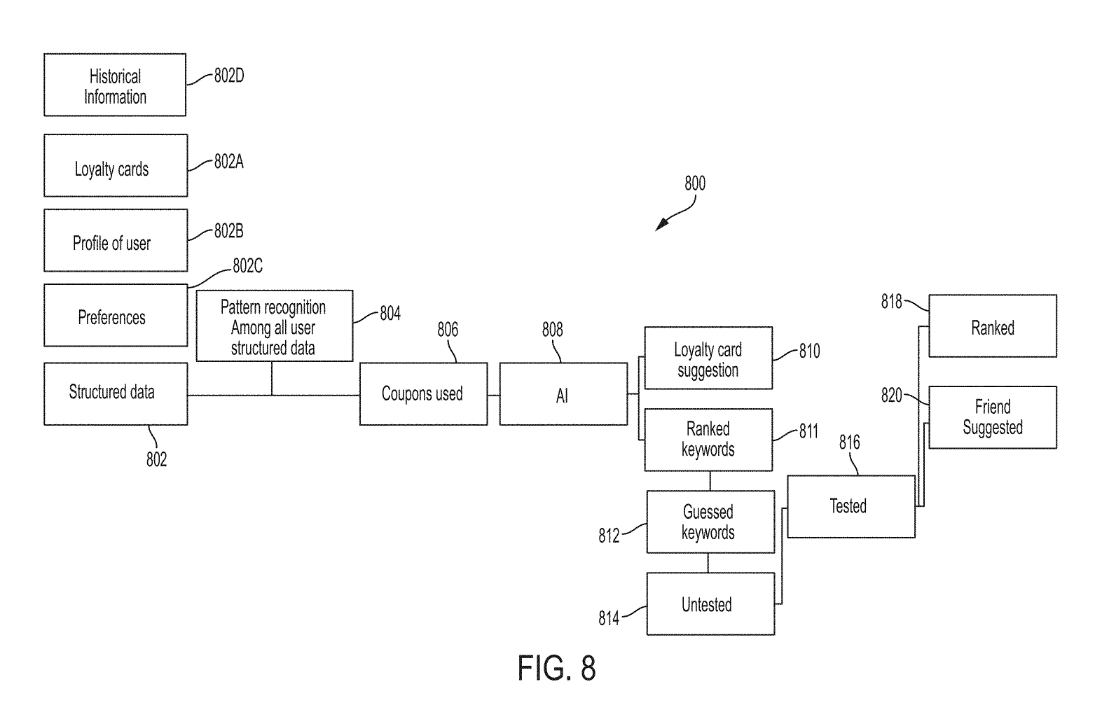

FIG. 8 illustrates an exemplary data flow diagram 800 by which a system (e.g. system 110) can be configured to generate an initial set of guessed keywords. For example, the system can be configured to generate a set of guessed keywords which the system can test using process 700 described above in reference to FIG. 7.

Process 800 begins at block 802 where the system receives data 802 from a user (e.g., during a registration process). The data can include (1) information about one or more loyalty cards 802A that the user has, (2) a profile of the user 802B, (3) user preferences 802C, and/or (4) historical information 802D about past user actions. In some embodiments, the loyalty card information 802A can comprise data about loyalty programs for which the user has membership. In some embodiments, the data can be in structured form. For example, an identification of the loyalty program, and a user membership identification for the loyalty program. In some embodiments, the profile of the user 802B can include personal information about the user. For example, the profile 802B can include a name, age, address of residence, interests, or other information about the user. In some embodiments, the user preferences 802C can include information about one or more user preferences. For example, the user preferences 802C can include data related to attribute preferences, brand preferences, visual object attribute preferences, and other preference data. In some embodiments, the historical information 802D can include information about actions of the user. For example, the historical information 802D can include data related to past purchase history of the user. In some embodiments, the system can be configured to retrieve the historical information 802D from one or more external computer systems. For example, the system can be configured to maintain an API with the external computer system(s), and receive data about actions of the user via the API.

Next, process 800 proceeds to block 804 where the system can perform pattern recognition on the received data at block 802. In some embodiments can be configured to identify items based on the pattern recognition. For example, the system can be configured to identify retailers based on the loyalty card data 802A. In another example, the system can be configured to identify information about a user such a generation of the user, life stage, or other information about the user based on the profile data 802B. In yet another example, the system can be configured to identify visual object attribute preferences of the user, notification settings, and other preferences based on the preference data 802C.

Next, process 800 proceeds to block 806 where the system determines one or more visual objects that have been activated in the past by the system. For example, the system determines one or more visual objects that the user has triggered activation of during an operation. Next, process 800 proceeds to block 808 where the system can be configured to use a system to suggest one or more visual objects to the user. Some embodiments of the system are described herein. The system can be configured to match one or more visual objects to the user as described herein.

Next, process 800 proceeds to block 808 where the system determine one or more loyalty card suggestions to provide to the user. In some embodiments, the system can be configured to determine visual objects that have been applied by the user to an operation, selected by the user to store, and/or discarded by the user. The system can be configured to use this information to match one or more loyalty cards to the user. Next, process 800 proceeds to block 811 where the system can be configured to generate a list of keywords based on user actions associated with one or more visual objects. For example, the system can be configured to generate a ranked list of keywords. In some embodiments, the system can be configured to use one or more keywords stored by the system along with stored values associated with the keywords. The system can be configured to rank the keywords based on the values stored by the system.

Next, process 800 proceeds to block 812 where the system determines one or more guessed key words. In some embodiments, the system can be configured to determine a keyword to guess based on the ranked list of keywords generated at block 811. For example, the system can be configured to select a top ranked keyword generated at block 811 and test the keyword.

Next, process 800 proceeds to block 814 where the system tests a keyword. In some embodiments, the system can be configured to test the keyword as described above with reference to process 500. At block 816, the keyword can be marked as tested. For example, during a testing phase, the system may have tested the keyword a threshold number of times (e.g., based on user actions associated with the keyword).

Next, process 800 proceeds to block 818 where the system can generate and/or update a ranking of tested keywords. In some embodiments, the system can be configured to maintain a ranking of keywords for a user. In some embodiments, the system can be configured to maintain a ranking based on values associated with one or more keywords. For example, the system can be configured to maintain a ranking of the keywords based on a stored value associated with the keywords (e.g., determined while performing process 500 described above with reference to FIG. 5).

At block 820, the system can be configured to determine one or more other contacts to suggest to the user as friends. For example, the system can be configured to use the results of keyword testing to determine friends that share interests with the user. In another example, the system can be configured to use loyalty card data, user profile data, and preference data to suggest friends. In yet another example, the system can be configured to determine friends to suggest based on user actions with respect to visual objects tracked by the system (e.g., storing, discarding, and/or sharing of visual objects).

In some embodiments, the system (e.g., visual object management system 110) can be configured to allow external computer systems to access stored data associated with one or more users. For example, the system can be configured to allow access to (1) keyword information (e.g., keywords and associated values), (2) brand preferences, (3) history of visual object selection, deletion, and/or sharing, and/or (4) loyalty card information. In some embodiments, the system can be configured to provide the data to retailer computer systems to provide insights on users. In some embodiments, the other computer systems can use the data to generate a profile of the user(s).

In some embodiments, the visual object management system can be configured to integrate with other computer systems to provide data. The system can be configured to connect to one or more server databases where the system can transmit data. For example, the system can be configured to connect with a server running a database management application to transmit data to the server for storage. In some embodiments, the system can be configured to generate reports based on data stored in the system and data received from other systems via which the system is in communication with.

### Visual Object Management Example Storage System Implementation

In some embodiments, the system (e.g., visual object management system 110) can be configured to store multiple different data points (e.g., in database 117). For example, the system can be configured to store data generated, collected, and/or used by the system described above for use in matching visual objects to users. In another example, the system can be configured to store data related to user actions. In yet another example, the system can be configured to store loyalty card data, user profile data, user contacts data, and data relating to external computer systems (e.g., retailer computer systems).

In some embodiments, the system can be configured to store a record of user search history. In some embodiments, the system can be configured to store a log of user searches. The log can include an identifier of a user, keywords used in a search, time of the search (e.g., date), location where the search was performed, and/or whether a notification was requested for the search. In some embodiments, the system can be configured to update the log in real time in response to user performing one or more searches.

In some embodiments, the system can be configured to store a record of communication trigger settings (e.g., notification settings) of a user. For example, the system can be configured to store data related to a notification (e.g., an application notification) received by the user. In another example, the system can be configured to store data related to a particular notification setting of the user (e.g., to receive a notification for visual objects having a certain attribute). In some embodiments, the system can be configured to store a user identifier, a time associated with the notification (e.g., date, hour, minute, second), and one or more keywords related to a visual object for which the user received a notification. For example, if the user received a notification for a visual object, the system can be configured to store one or more keywords related to the visual object (e.g., keywords in text of the visual object).

In some embodiments, the system can be configured to store user preferences. In some embodiments, the system can be configured to store one or more classes (e.g., categories) of visual objects that the user is interested in, and/or attributes (e.g., values of one or more features) of visual objects that the user is interested in. For example, the system can be configured to store categories of products that the user would like visual objects to have. In another example, the system can be configured to store one or more retailers to which the user would like visual objects to be associated with.

In some embodiments, the system can be configured to store a record associated with a user's interactions with a visual object. In some embodiments, the system can be configured to store data relating to the interaction. For example, the system can be configured to store a user identifier, a visual object identifier, a title of the visual object, a length of time that the user interacted with the visual object, an expiration date associated with the visual object, attributes (e.g., brand, retailer, category) associated with the visual object, and/or information in the visual object (e.g., special characters, keywords, keyword synonyms). Embodiments are not limited to any specific set of information that the system can store with respect to a user interaction with a visual object.

In some embodiments, the system can be configured to store data related to loyalty cards. For example, the system can be configured to store an indication of whether the loyalty card has been mapped to the user, a category of the loyalty card, one or more locations associated with the loyalty card, and/or a record of users of the loyalty card.

In some embodiments, the system can be configured to store data related to a profile of the user. The system can store a generation of the user, an age of the user, a region of the user, a stage of life of the user, and one or more life events associated with the user.

In some embodiments, the system can be configured to store a record for one or more visual objects that have been triggered for activation by a user. For example, the system can be configured to store one or more coupons activated by a user during an operation. In some embodiments, the system can be configured to store a visual object identifier, and/or a number of times that the visual object has been triggered for activation by users. In some embodiments, the system can be configured to store a log of keywords related to the visual object. In some embodiments, the system can be configured to store a title, value, date of application, and/or feature values (e.g., retailer, and/or brand) associated with the visual object.

In some embodiments, the system can be configured to store a network of user connections. For a given user, the system can be configured to store suggested friends, added friends, and/or users that are following the user. In some embodiments, the system can generate a map of user connections using user connection data for multiple users.

In some embodiments, the system can be configured to store one or more logs for different types of user actions. Table 2 below illustrates an example data structure for storing records in a log of user actions.

TABLE 2

| Name | Type | Description |
|---|---|---|
| User ID | [A-z], [a-z], [0-9], [_] | Unique identifier of a |
| | (Underscore), [-] (Dash) | user |
| Visual Object | [A-z], [a-z], [0-9], [_] | Unique identifier of |
| ID | (Underscore), [-] (Dash) | visual object |
| Time | YYYY/MM/DDTHH:MM:SS | Time of action |
| | (e.g. 2013/06/20T10:00:00) | |
| Action | Stored/Discarded/Applied/ | Description of action |
| | Shared | |

In some embodiments, the system can be configured to store a log of visual objects selected by a user for storage (e.g., by swiping right on a displayed visual object), visual objects matched to the user by the system, visual objects scanned by the user, visual objects declined by the user, and/or visual objects shared with other users. For a user action, the system can be configured to store a user identifier, an identifier of a visual object associated with the action, a time of the action, and a description of the action. Actions can include, for example, storing a visual object, discarding a visual object, triggering activation of a visual object (e.g., during an operation), and/or sharing a visual object.

In some embodiments, the system can be configured to store communication of a visual object from one user to a second user. In some embodiments, the system can be configured to track what the second user who receives the communication of the visual object does with the shared visual object. The system can be configured to store a record that the user shared the visual object which can include, for example, a time of the share, whom the visual object was shared with, an identifier of the shared visual object, one or more categories of the visual object, and/or other information about the visual object and the action of sharing. In some embodiments, the system can be configured to store a record of the second user receiving the communication of the visual object including, for example, a time of the share, whom the visual object was shared by, an identifier of the shared visual object, one or more categories of the visual object, and/or other information about the visual object and the action of receiving the communication.

In some embodiments, the system can be configured to store loyalty cards added by a user, matched to the user (e.g., by the system), and/or removed or declined loyalty cards. In some embodiments, the system can be configured to store a log of visual objects sent from another user accepted by the user, and/or a log of visual objects sent from another user that are rejected by the user. In some embodiments, the system can be configured to store a log of notifications received with respect to visual objects.

In some embodiments, the system can be configured to store data related to specific retailers. In some embodiments, the system can be configured to store categories of visual objects associated with a retailer, one or more keywords associated with a retailer, and/or one or more loyalty cards associated with a retailer. For example, the system can be configured to store keywords relating to products and/or services that are sold by a particular retailer.

In some embodiments, the system can be configured to store data related sets of keywords stored by the system. In some embodiments, the system can be configured to store a keyword set identifier and a user identifier for a user associated with the keyword set. For example, the keyword set may be used to match visual objects to a user. In some embodiments, the system can be configured to store a value (e.g., a weight) for keywords in the keyword set. In some embodiments, the system can be configured to store ranks for keywords in the keyword set. In some embodiments, the system can be configured to store one or more statuses associated with each keyword in the keyword set (e.g., tested, untested, matched, special case).

In some embodiments, the system can be configured to store data for each user of the visual object management system. In some embodiments, the system can be configured to store one or more unique identifiers for the user. For example, the system can be configured to store a user ID and/or a key ID. In some embodiments, the system can be configured to store one or more attribute preferences (e.g., feature value preferences) of the user. For example, the system can be configured to store a brand preference, a special character preference, and/or a face value preference for visual objects.

In some embodiments, the system can be configured to store data related to visual objects that have been matched to a user. In some embodiments, the system can be configured to store a unique identifier (e.g., a key ID) for each matched visual object. In some embodiments, the system can be configured to store data related to attributes of the matched visual object (e.g., brand, category). In some embodiments, the system can be configured to store one or more parameters calculated for matching the visual object to the user. For example, the system can be configured to store a special character related to the visual object, a number of times the visual object has been applied by users, and/or a profile value (e.g., Pᵤₛₑᵣ) indicating how closely the visual object is related to the user. In some embodiments, the system can be configured to store one or more loyalty cards associated with the matched visual object.

In some embodiments, the system can be configured to store a profile associated each visual object stored by the system. The system can be configured to store, in the profile, characteristics about users to whom the visual object can apply. For example, the system can be configured to store an identifier of the visual object (e.g., a visual object ID). In some embodiments, the system can be configured to store age, race, generation, and/or stage of life to which the visual object matches. For example, the system can store a indicators of age, race, generate, and/or stage of life. Table 3 illustrates an example data structure for storing a profile for a visual object, in accordance with some embodiments.

TABLE 3

| Name | Type | Description |
|---|---|---|
| ID | [A-z], [a-z], [0-9], [_] | Unique identifier of visual |
| | (Underscore), [-] (Dash) | object |
| Name | Any alphanumeric characters | Name of visual object |
| | Max length: 255 | |
| Category | Any alphanumeric characters | Categories of visual object |
| | Max length: 255 | |
| Description | Any alphanumeric characters | Keywords, descriptions, |
| | Max length: 4000 | synonyms |
| Attributes | Any alphanumeric characters | Brand identifier, special |
| | Max length: 4000; Max | character(s), face value |
| | number of features: 20 | |

### Example User Interface Implementation

FIG. 9 illustrates an example user interface home screen 900, in accordance with some embodiments of the technology described herein. In some embodiments, the home screen 900 provides an option for a user to sign up. In some embodiments, the home screen 900 includes options to sign up through an existing online account. For example, the user interface screen includes an option to sign up or login via an account associated with another online system (e.g., Facebook 902). In some embodiments, the system can be configured to receive information about the user from the online system associated with the account (e.g., from the user's Facebook account). In some embodiments, the home screen 900 also allows for existing users to log in using email 904.

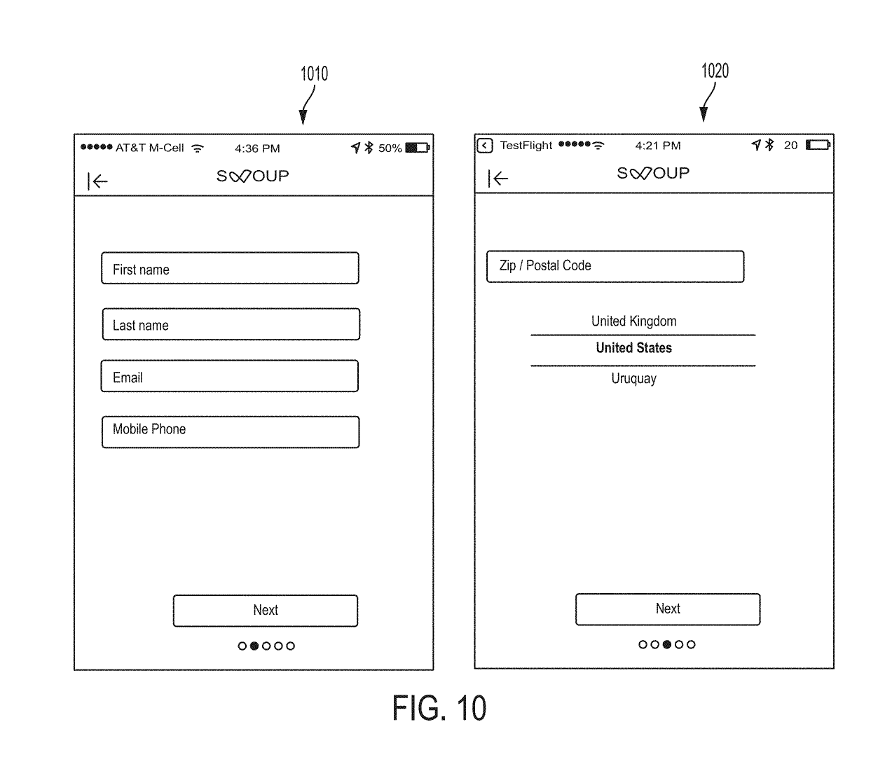

FIG. 10 illustrates example user interface screens 1010 and 1020 for registering a user, in accordance with some embodiments of the technology described herein. User interface screen 1010 is an example screen via which the system can receive information about the user during a registration or sign up. The information can include a name, email, phone number, and/or other information. In some embodiments, the system can be configured to receive, via user interface screen 1020, location information about the user such as a region (e.g., country, city, state, zip).

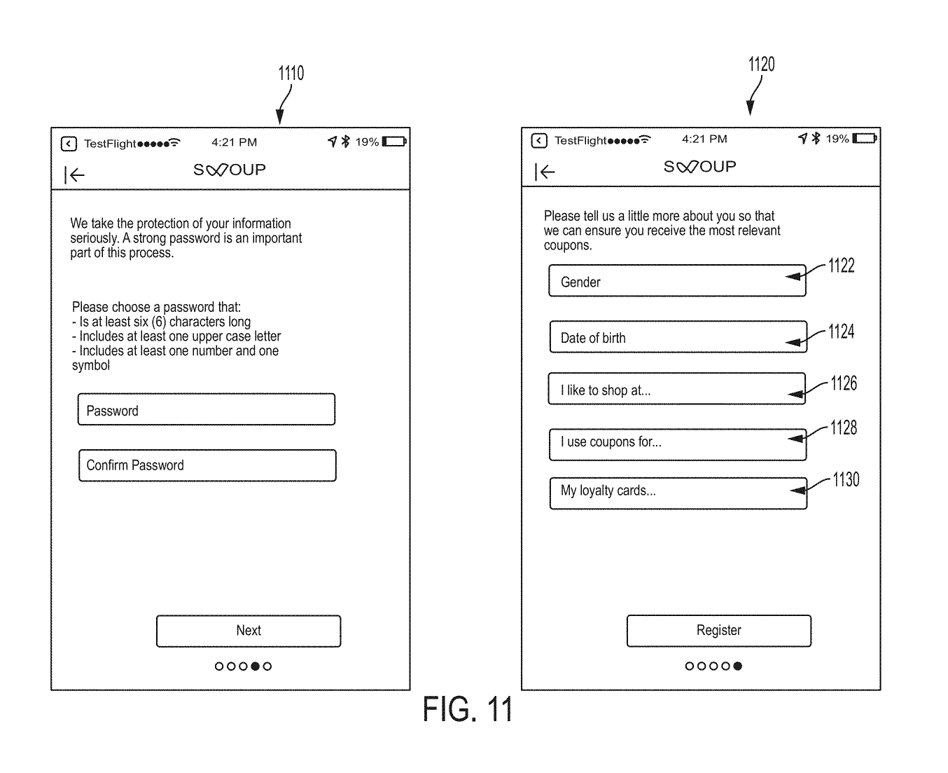

FIG. 11 illustrates example user interface screen 1110 and 1120 for registering a user, in accordance with some embodiments of the technology described herein. The system can be configured to allow the user to create a password via user interface screen 1110. The system can be configured to receive information about the user through user interface screen 1120. For example, the system can be configured to receive information such as gender 1122, date of birth 1124, a selection of where the user likes to shop 1126, categories that the user is interested in 1128, and adding of loyalty programs 1130. In some embodiments, the system can be configured to use the entered information in the machine learning system.

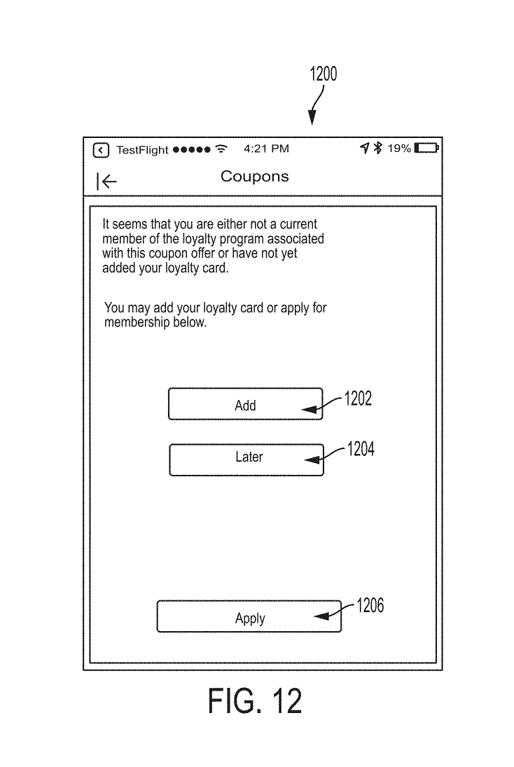

FIG. 12 illustrates an example user interface screen 1200 for adding a data profile associated with an external computer system (e.g., a loyalty program membership), in accordance with some embodiments of the technology described herein. In some embodiments, users have the option to add an existing loyalty card 1202. If selected, the user is taken to the section where the user can either manually type in the membership, number, scan a bar code of a physical card, do a phone number look up, or use another method. For phone number look up, the system can be configured to submit a phone number via code to an associated computer system and retrieve the membership information. In some embodiments, the user can select an option to add later 1204. In some embodiments, the system can be configured to require addition of loyalty programs at a later period. In some embodiments, when the loyalty program membership is added, the system can be configured to link to one or more external computer systems (e.g., via API(s)) and communicate visual objects to the external computer system(s) (e.g., during an operation). The visual object can be available and triggered for activation immediately during an operation by the system. The user interface screen 1200 includes an option to apply 1206. The system can be configured to redirect the user to apply for loyalty program membership.

In some embodiments, the system can be configured to apply for a data profile associated with an external computer system (e.g., a loyalty program membership) within an application of the system. The user may register The system communicates a user's registration information to the external computer system. The system can transmit data to the external computer system and is behind their firewall. A user can, for example, then create a username and/or password. The membership information is then shared with the system.

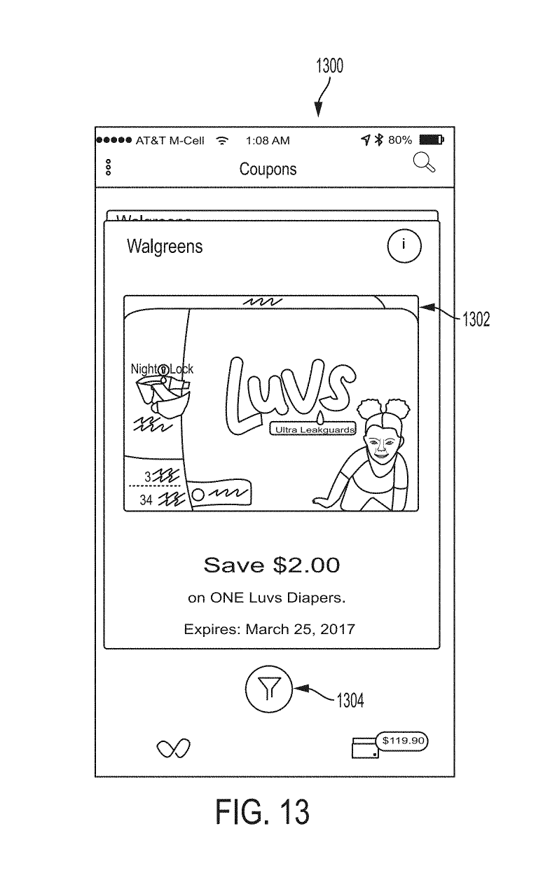

FIG. 13 illustrates a user interface screen 1300 for presenting a matched visual object to a user, in accordance with some embodiments of the technology described herein. In some embodiments, a visual object 1302 is served up to the user one at a time (e.g., when matched by the machine learning system). The user can interact with the presented visual object. In some embodiments, The user can swipe in one direction (e.g., right) to place the visual object 1302 in a data store (e.g., a wallet) of the user indicating an intent to purchase based on attributes of the visual object 1302. In some embodiments, the user can swipe in a second direction (e.g., left) to discard or place the visual object 1302 in a trash indicating disinterest with attributes of the visual object 1302. In some embodiments, the user can swipe in a third direction (e.g., up) to share the visual object 1032 with another user. In some embodiments, the system can store a record of each user action. In some embodiments, this may force a user interaction with every visual object matched to the user providing additional data to the machine learning system. This can provide data about the user's preferences (e.g., brand, retailer, price).

In some embodiments the user can access a menu (e.g., via three dots on screen). In some embodiments, the user can select an option on the screen (e.g., “I”) to reveal more information about the visual object 1302. In some embodiments the filter icon 1304 can reveal selectable options to filter the visual objects that are presented in the screen 1300. In some embodiments, the screen 1300 includes an option to take the user to a search function (e.g., a magnifying glass). In some embodiments, the screen 1300 can include options to toggle between a visual object selection screen and another screen (e.g., a wallet screen). For example, a “W” option indicating the visual object selection screen and a wallet icon indicating the wallet screen. In some embodiments, a bubble over a wallet icon can show a value associated with visual objects stored in the wallet. For example, the value can indicate a sum of face values of visual objects stored in the wallet. In some embodiments, the system can be configured to determine face values based on information received from external computer systems (e.g., via API(s)).

In some embodiments, the system can be configured to convert physical objects into digital visual objects. For example, the user can have physical paper visual objects. The user can take a photo of the visual objects and the system can be configured to digitize the image information and transform the image into a visual object. The user can then, for example, select to store the visual object in a wallet.

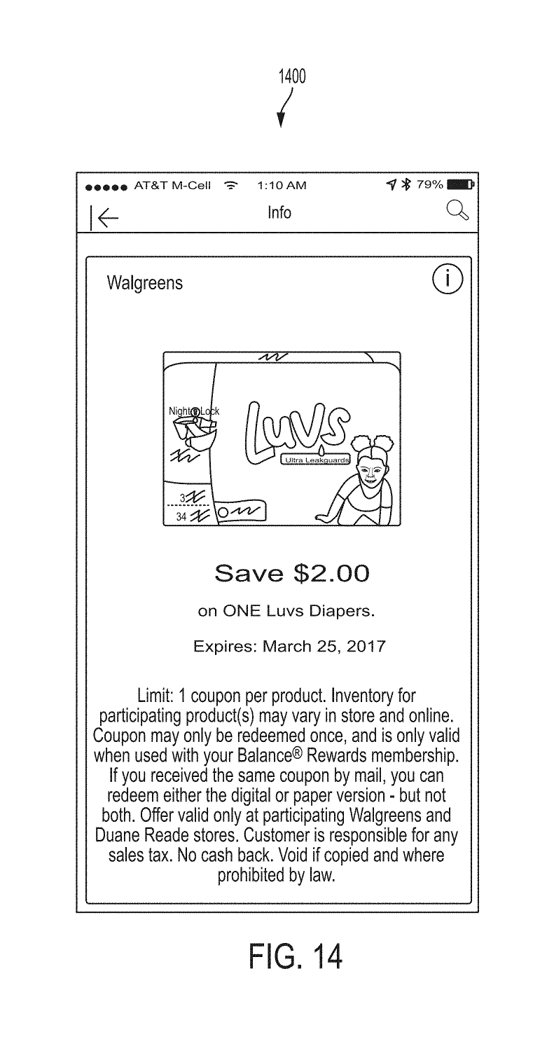

FIG. 14 illustrates a user interface screen 1400 for displaying additional information about a visual object, in accordance with some embodiments of the technology described herein. For example, the user can access the additional information by clicking an information button (e.g., “I”) in user interface screen 1300. In some embodiments, this may result in the visual object flipping to reveal more detailed information (e.g., text) about the visual object.

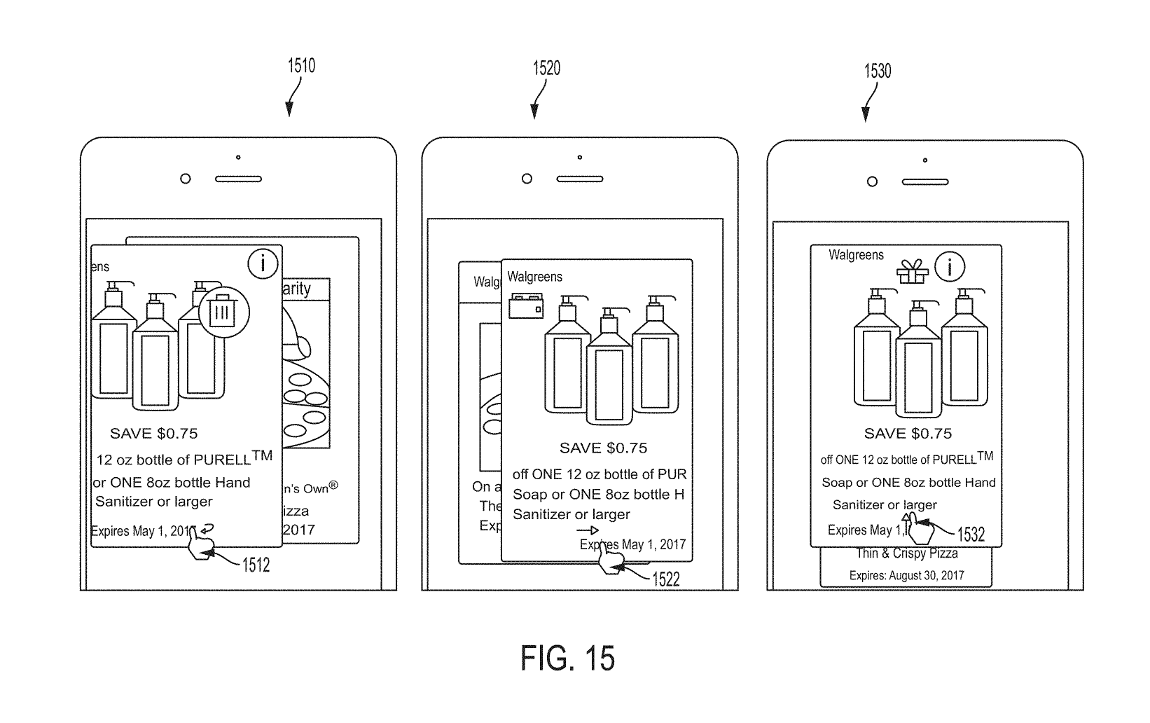

FIG. 15 illustrates dynamic visualizations generated by the system in response to user inputs, in accordance with some embodiments of the technology described herein. Screen 1510 illustrates a visualization within a user interface screen (e.g., screen 1300) in response to a first user movement. As shown in screen 1510, the use has swiped left 1502. In some embodiments, system can be configured to discard the visual object shown in the screen in response to the swipe left 1512. In some embodiments, the system can be configured to generate a movement of the visual object in the screen in response to the swipe left 1502. For example, a movement of the visual object to the left (e.g., off the screen).

Screen 1520 illustrates a visualization in a user interface screen (e.g., screen 1300) in response to a second user input 1522. For example, the user input 1522 can comprise a swipe to the right. In some embodiments, the system can be configured to place the visual object displayed in the screen in a data store (e.g., wallet) of the user and/or link the visual object to a loyalty identification stored in the system. In some embodiments the system can be configured to generate a visualization in the user interface screen in response to the user input. For example, for a swipe right 1522, the system can be configured to generate a movement of the visual object to the right in the user interface screen.

Screen 1530 illustrates a visualization in a user interface screen (e.g. screen 1300) in response to a third input 1532. For example, the third user input 1532 can comprise a swipe up. In some embodiments, the system can be configured to share the visual object displayed in the screen with another user in response to the third input 1532. In some embodiments, the system can be configured to generate a visualization in the user interface screen in response to the user input 1532. For example, the system can be configured to generate a movement of the visual object upward in the user interface screen.

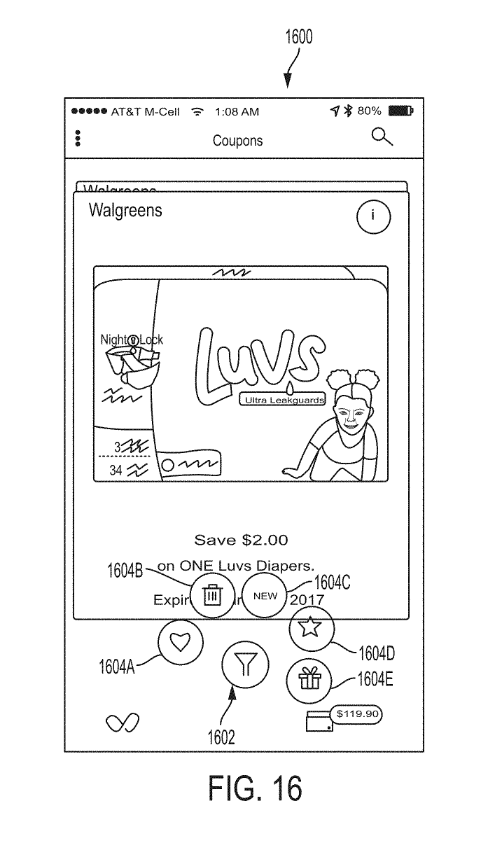

FIG. 16 illustrates an example user interface screen 1600 showing one or more filter options, in accordance with some embodiments of the technology described herein. In some embodiments, the system can be configured to display additional filter options 1604A-E in response to detecting a selection of the filter option 1602. For example, the system can be configured to display additional options to view favorites, trash/discarded visual objects, new or recommended visual objects, popular visual objects, visual objects shared to the user by others, and/or other types of filter options. The system can be configured to display visual objects in accordance with a selected filter.

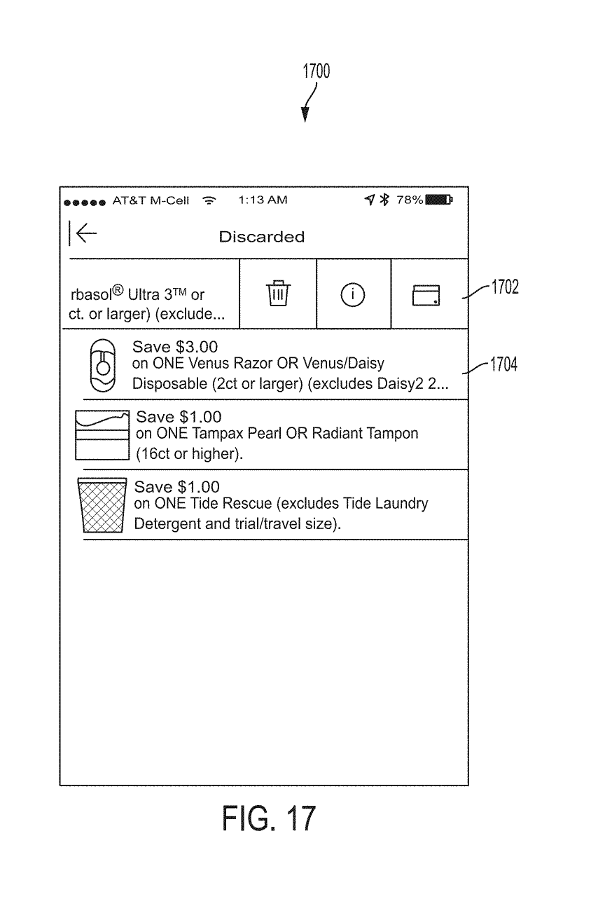

FIG. 17 illustrates an example user interface screen 1700 for displaying one or more discarded visual objects, in accordance with some embodiments of the technology described herein. For example, the screen 1700 can display one or more visual objects 1704 that a user has selected to discard (e.g., by swiping left). In some embodiments, the system can be configured to retain discarded visual objects for a period of time (e.g., 30 minutes, 1 hour, 1 day, 1 week, 1 year) in case a user mistakenly discarded the visual object. In some embodiments, after the period of time passes, the discarded visual object may be deleted. In some embodiments, the system can be configured to provide one or more other options for discarded visual objects as shown by reference number 1702 in screen 1700. For example, a user can select a discarded visual object to reveal options. In some embodiments, the system can be configured to allow a user to reveal the additional options 1702 by sliding a finger on the discarded visual object (e.g., from right to left, left to right). In some embodiments, the system can be configured to generate one or more options 1702 such as sending the visual object to the wallet, permanently deleting the visual object, and/or more information. Tapping on a revealed option 1702 can trigger performance of the action by the system. In some embodiments, a user can also tap a discard visual object to get more information about the visual object. In some embodiments, the user can swipe from left to right across a discarded visual object to reveal an option to share the discarded visual object. The system can communicate the visual object to another user in response to a tap of the revealed option.

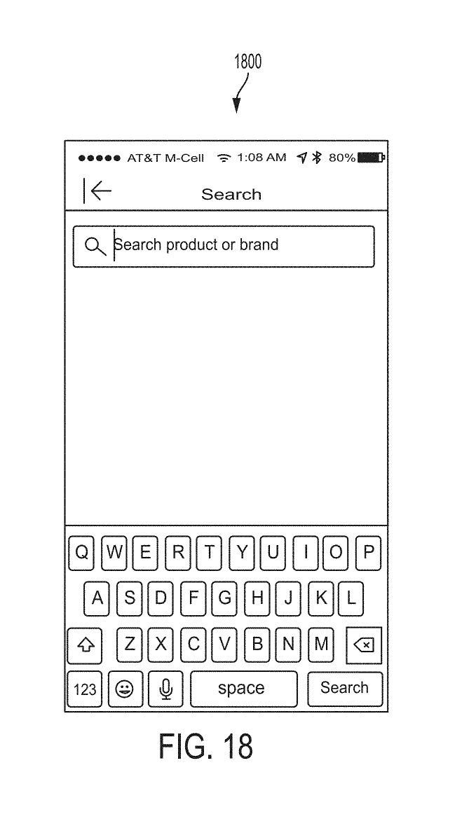

FIG. 18 illustrates an example user interface screen 1800 via which a user can perform a search, in accordance with some embodiments of the technology described herein. A user can reach the search screen 1800 by tapping a search icon (e.g., a magnifying class icon). In some embodiments, a user can search for one or more visual objects via screen 1800. For example, the user can type or speak input for the search. In some embodiments, the system can be configured to search inputted search words against words related to one or more visual objects (e.g., provided by external computer systems). The system can be configured to return visual objects that match the search term. In some embodiments, the system can list visual objects that match the search term. In some embodiments, a user can slide across a returned visual object to reveal an option to store the visual object (e.g., in a data store of the user). In some embodiments, if no visual objects that match the search term are found, the system can be configured to provide an option for the user to receive a communication (e.g., a notification) in response to the system finding a visual object related to the search terms. In some embodiments, user search inputs can be used by the machine learning system to train one or more models and/or to use in a matching algorithm (e.g., equation).

In some embodiments, the system can perform an image search. The system can be configured to access a device camera to scan, detect, or capture a photo of a product. The system can be configured to use the image and query it against product images and information to find related products. In some embodiments, the system can be configured to return matching products. A user can select a matching product and, in response, the system can be configured to find visual objects associated with the selected product. In some embodiments, the system can be configured to search for visual objects in response to receiving an image. The system can then present the visual objects to the user. In some embodiments, the system can be configured to asks the user if the user would like to receive notifications for visual objects found that match the image of the product.

In some embodiments, the system can include a voice search feature. A user can, for example, type a microphone icon and speak items or products that the user is looking for. In some embodiments, the system can be configured to convert voice into text which can appear in the screen. In some embodiments, a user can tap a mic icon to start a speech input and tap the mic icon again to stop the recording. The system can be configured to perform a search with the text input converted from the voice input as described above.

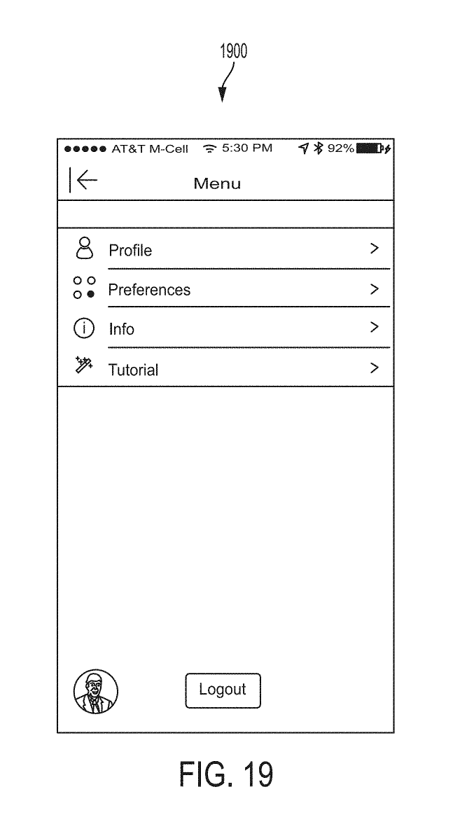

FIG. 19 illustrates a user interface screen 1900 showing one or more menu options, in accordance with some embodiments of the technology described herein. In some embodiments, the menu screen 1900 can be accessed by a user by tapping a menu icon (e.g., three stacked dots in another screen). The menu can include options such as profile, preferences, information, and/or tutorial. The profile option can include information about the user (e.g., entered during registration). The preferences option can include user preferences for attributes of visual objects (e.g., categories of products, loyalty program information, attributes of visual objects). The information selection can provide information about a provider of the visual object management system (e.g., Swoup). A tutorial option can provide a user with instructions about how to use the visual object management system. In some embodiments the system can be configured to have a log out option. The log out option can, when selected, log a user out of the visual object management system. In some embodiments, other menu options may be included in the user interface screen 1900 instead of, or in addition to example options discussed herein.

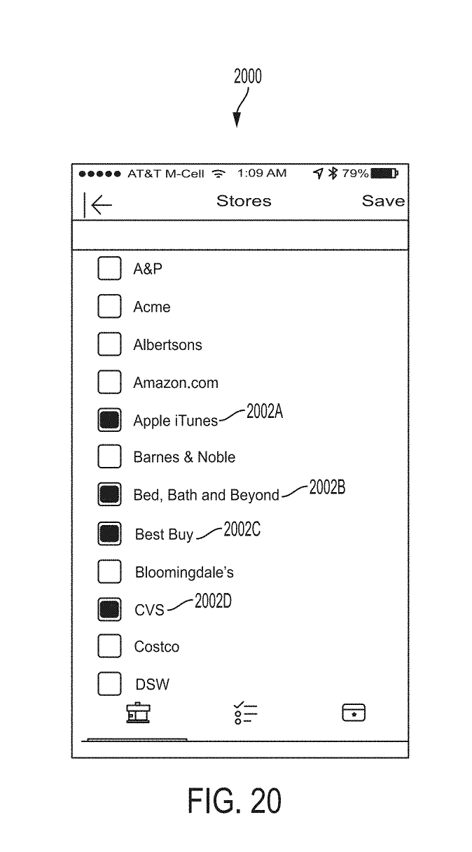

FIG. 20 illustrates a user interface screen 2000 that allows a user to select one or more attribute preferences, according to some embodiments of the technology described herein. In some embodiments, the user can specify, via user interface screen 2000, values of one or more features of visual objects that the user has a preference for. For example, a user can select one or more store feature values that the user has interest in. In some embodiments, the user interface screen 2000 may provide a user to select one or more values. In some embodiments, the user interface screen 2100 can provide one or more selectable options (e.g., a checkboxes) that the user can select. The value(s) can, for example, indicate an interest of the user. For example, as shown in FIG. 20, the user can select 2002A-D to specific that the user prefers visual objects that have a store value of Apple iTunes 2002A, Bed, Bath and Beyond 2002B, Best Buy 2002C, and CVS 2002D. In some embodiments a machine learning system can be configured to use the user selections in generating a visual object matching model for the user and/or matching visual objects to the user as described herein.

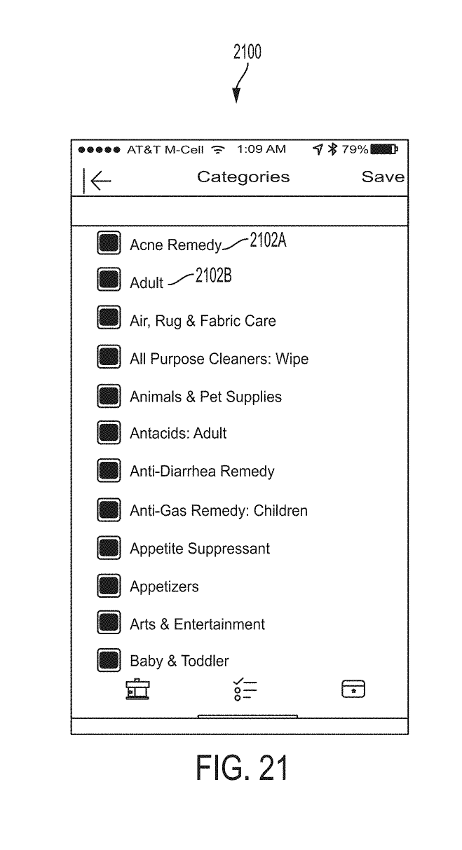

FIG. 21 illustrates a user interface screen 2100 that allows a user to select one or more classification (e.g., categories) preferences, in accordance with some embodiments of the technology described herein. In some embodiments, the user can specify, via user interface screen 2100, one or more classes (e.g., categories) that the user is selected in. In some embodiments, the user interface screen 2100 can provide a selectable option (e.g., a checkbox) that the user can select. For example, as shown in FIG. 21, the user has selected Acme Remedy 2102A and Adult 2102B as categories that the user is interested in. In some embodiments a machine learning system can be configured to use the user selection(s) in generating a visual object matching model for the user and/or matching visual objects to the user as described herein.

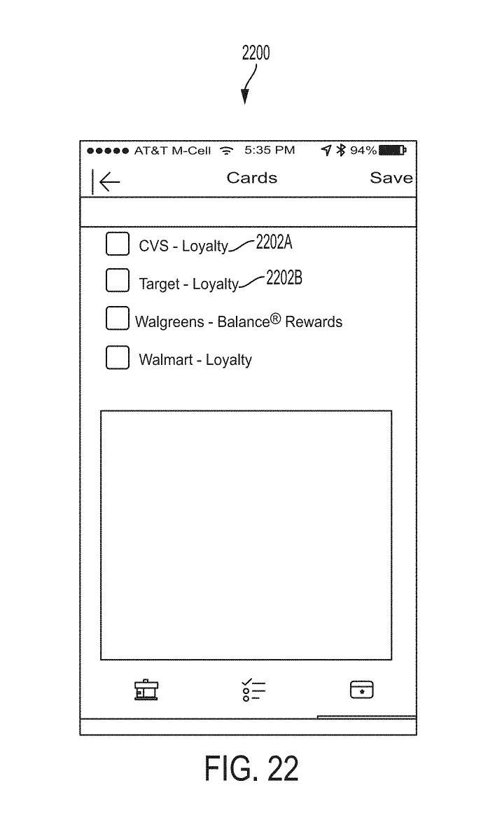

FIG. 22 illustrates a user interface screen 2200 that allows a user to select one or more computer systems with which the user can create a data profile (e.g., loyalty programs), in accordance with some embodiments of the technology described herein. The user can register to create one or more data profiles associated with the computer system(s). For example, the user can register for membership to a loyalty program and obtain a membership ID number. The system can be configured to store the user's membership identification information. The user interface screen 2200 can be configured to display one or more computer system identifiers (e.g., loyalty programs) that the user can register for. For example, FIG. 22 shows a CVS loyalty program 2202A and a Target loyalty program 2202B for which the user can obtain membership. In some embodiments, the user can select an option and, in turn, be directed to another site or application to complete registration. In some embodiments, the user can select an option and complete registration with the system (e.g., within an application of the system).

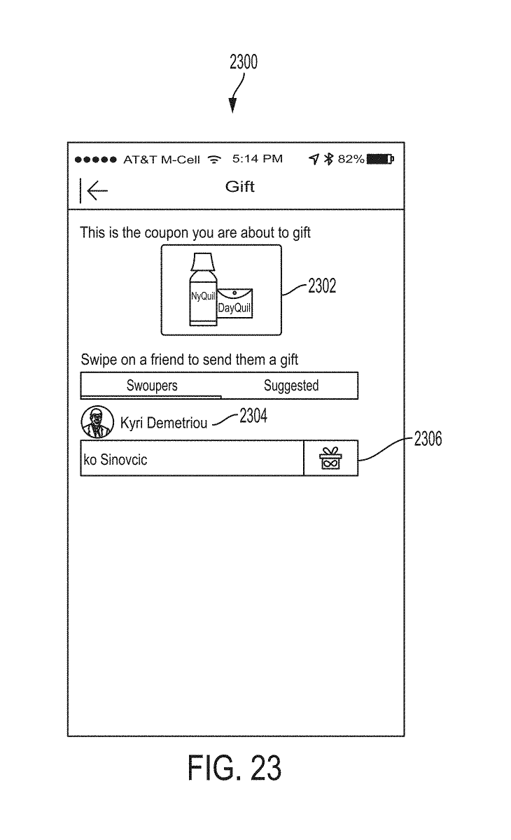

FIG. 23 illustrates an example user interface screen 2300 by which a user can select a second user to whom to communicate a visual object, in accordance with some embodiments of the technology described herein. For example, the user can reach screen 2300 by selecting to share a visual object (e.g., by swiping up in a visual object display screen). The system can be configured to present screen 2300 in response to receiving a user selection to share a visual object (e.g., a swipe up as described herein). In some embodiments, the system can be configured to prompt the user to allow the system to access information about the user (e.g., Facebook account information, mobile phone contacts). The system can be configured to access the information to determine existing users of the system that the user is connected with. The system can display one or more users 2304 that the user is connected with and that are registered with the system in screen 2300. In some embodiments, the system can also display one or more users that are not registered. For example, the screen 2300 provides a “Suggested” option which, if selected, can trigger the system to display one or more users who are not users of the system but whom the user can communicate a message to invite to use the system. In some embodiments, the system can be configured to determine if one or more people associated with the user are users of the system by querying a database of the system to determine if a user profile exists. For example, the system can be configured to query the database to determine if an email, phone number, or other identifying information exists in the system database. If so, then the system can determine that the user is a registered user. If not, the system can be configured to determine that the user is not a registered user and further display an identity of the user (e.g., a name and/or photo) as a suggested user.

In some embodiments, in user interface screen 2300, the user can provide an input that allows the user to communicate a visual object 2302 selected for sharing to a second user. In some embodiments, the user interface screen 2300 presents selectable options representing users to whom the visual object can be communicated (e.g., a list option showing a name and/or photo). In some embodiments, the user can select the second user 2304 from the list. The system, in response, can be configured to communicate the visual object to the second user (e.g., by displaying the visual object to the second user). In some embodiments, the user interface screen 2300 can be configured to receive a different action to communicate the visual object such as a slide in a first direction (e.g., left or right). In response to the slide, the user interface screen can be configured to display an option 2306 to communicate the visual object to the second user. In some embodiments, the system can be configured to communicate the visual object to the second user in response to the slide.

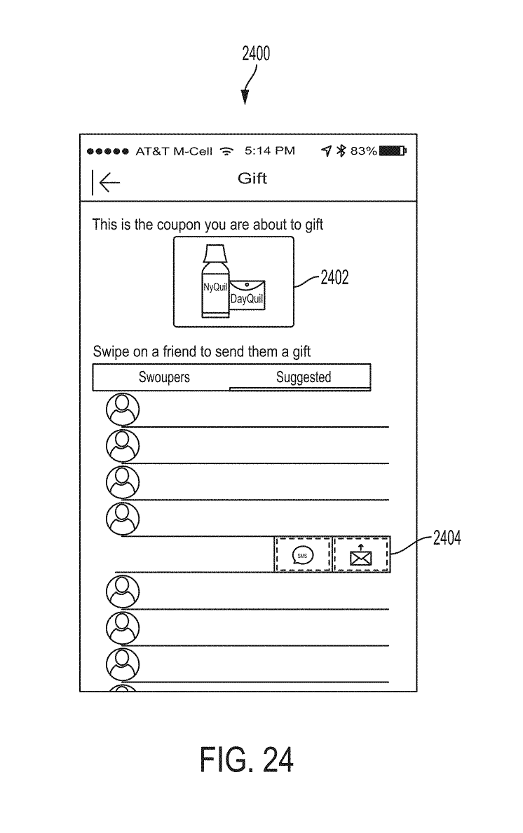

FIG. 24 illustrates an example user interface screen 2400 which may allow the user to communicate a visual object 2402 to one or more users that are not current users of the system, in accordance with some embodiments of the technology described herein. For example, the user can reach screen 2300 by selecting to share a visual object (e.g., by swiping up in a visual object display screen). The system can be configured to present screen 2400 in response to receiving a user selection to share a visual object (e.g., a swipe up as described herein). In some embodiments, the system can be configured to prompt the user to allow the system to access information about the user (e.g., Facebook account information, mobile phone contacts). The system can be configured to access the information to determine existing users of the system that the user is connected with. In this screen, the “Suggested” option has been selected displaying one or more users who the system has detected are not users of the system. The system can determine whether people are users of the system by querying a database as described above in reference to FIG. 23.

In screen 2400, a user can select a user who is not registered to communicate the visual object to. In some embodiments, when the user selects a recipient, the system can be configured to display selectable options for the user to send an invitation message to the user. In some embodiments, the system can be configured to display an option to either send a text message (e.g., an SMS message) or an email message. In response to receiving a user selection of an option, the system can be configured to send the communication (e.g., text message or email) to the recipient. In some embodiments, the communication transmitted to the recipient (e.g., a client device of the recipient), can be configured to alert the recipient of the visual object. In some embodiments, the communication can be configured to instruct the recipient to obtain access to the visual object management system. For example, the communication can be configured to instruct the recipient to download an application via which the recipient can access the visual object management system. In some embodiments, the system can be configured to allow the user to customize the communication sent to the recipient. For example, the system can allow a user to modify a textual message that appears as part of the communication.

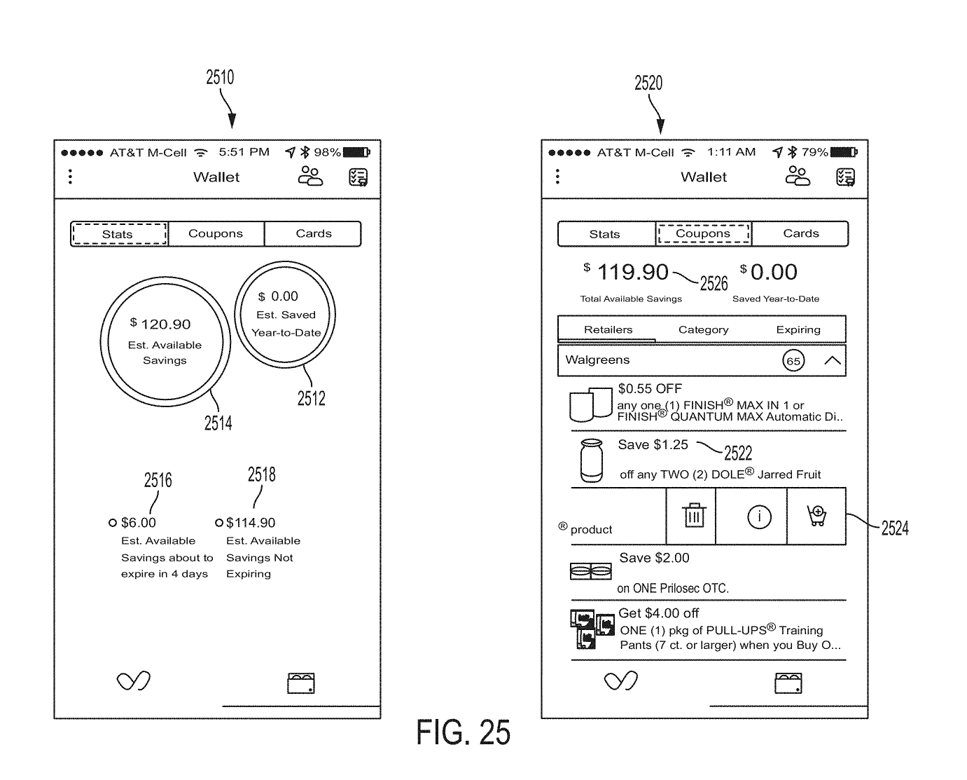

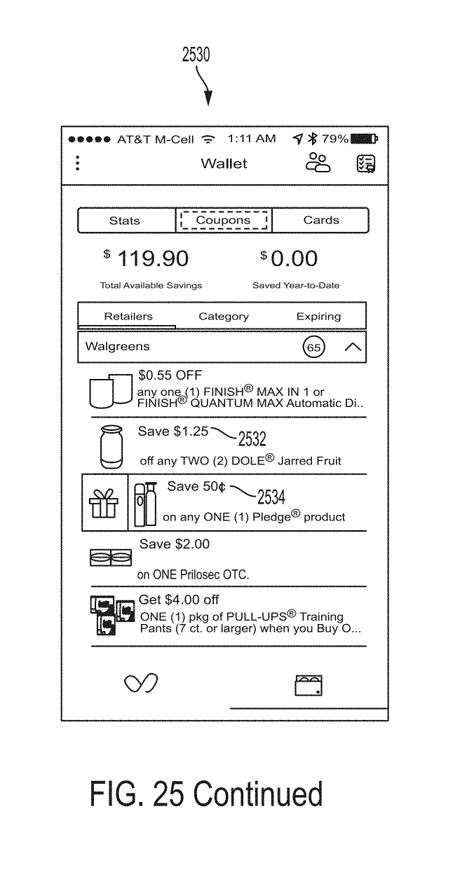

FIG. 25 illustrates user interface screens 2510, 2520, and 2530 associated with a data store (e.g., a wallet) of visual objects that a user has selected to store (e.g. by swiping right on a visual object presented to the user in as shown in FIG. 5), in accordance with some embodiments of the technology described herein. User interface screen 2510 can be configured to display one or more statistics characterizing a collection of visual objects in the data store. In some embodiments, the user interface screen 2510 configured to display visualization of the statistics. For example, the system can display a visualization 2512 indicating a total sum of differences obtained by the user as a result of visual object execution during past operations. For example, the visualization 2512 can indicate a total amount of money saved as a result of applying visual objects to during a past period of time (e.g., one year, one month). In some embodiments, the system can be configured to display a visualization 2514 providing an estimated sum of differences that would result from execution of visual objects stored in the data store (e.g., a sum of face values of the visual objects). For example, the visualization 2514 can indicate an amount of savings that are available from the stored visual objects. In some embodiments, the user interface screen 2510 can be configured to display an indication 2516 of an estimated sum of differences that would result from execution of stored visual objects for visual objects that are not expiring. In some embodiments, the user interface screen 2510 can be configured to display an indication 2518 of an estimated sum of differences that would result from execution of stored visual objects for visual objects that are going to expire in a certain period of time (e.g., 1 day, 1 week, 1 month).

In some embodiments, the user interface screen 2510 can be configured to display statistics about capturing of differences resulting from execution of visual objects. For example, the user interface screen 2510 can be configured to display an indication of a sum of differences captured as a result of execution of visual objects (e.g. a sum of savings from visual object execution transferred). In another example, the user interface screen 2510 can be configured to display an indication of how the captured differences were distributed to different sources (e.g., accounts, organizations, charities).

User interface screen 2520 illustrates a first view that the system can be configured to provide to a user to display visual objects stored in the user's data store. The user interface screen 2520 can be configured to illustrate a list of visual objects 2522 that the user selected to store in the data store. For example, the user interface screen 2520 can be configured to display visual objects that were presented to the user and that were selected for storage (e.g., by swiping right). In some embodiments, the visual objects can be organized and displayed according to values of one or more features of the visual objects. For example, as shown in user interface screen 2520, the visual objects can be organized and displayed according to values of a retail feature of the visual objects. The user interface screen 2520 can be configured to display one or more visual objects having a specific feature value (e.g., specific retailer) in response to a user input. For example, the user interface screen 2520 can provide a pull down selection that, when selected, causes the user interface screen 2520 to display one or more visual objects having the feature value to appear on the screen.

In some embodiments, the user can be allowed to perform actions with respect to visual objects stored in the data store. For example, the user interface screen 2520 can be configured to receive a first user input of a visual object. The first input can comprise, for example, a tap, slide in a first direction, or other type of input. In response to the input, the user interface screen 2520 can be configured to display one or more selectable options 2524 for a selected visual objects. For example, the user interface screen 2520 can be configured to display, in response to the first user input, options to discard the visual object (e.g., remove it from the wallet), view additional information about the visual object, and/or add the visual object to a list of visual objects that the user intends to use (e.g., a shopping list). In another example, the user interface screen 2520 can be configured to receive a second user input instead of, or in addition to, the first user input. The second user selection can comprise, for example, a tap, a slide (e.g., in a different direction than the first user selection), or other type of input. In response to the second user input, a different one or more selectable options that those in response to the first input can be displayed in the user interface screen as shown in user interface screen 2530. For example, the second input can result in the user interface screen showing an option 2532 to communicate the visual object to another user. In response to a user selecting the option, the system can be configured to display a user interface screen for communicating the visual object (e.g., as shown in FIGS. 23-24).

In some embodiments, the system can be configured to automatically remove one or more visual objects from the data store when the visual object(s) are no longer usable. For example, the system can be configured to store an expiration time (e.g., date) of the visual object(s). The system can be configured to determine if the current date has surpassed the I expiration date of the visual object(s). In response to determining that the current date has surpassed the expiration date of the visual object(s), the system can be configured to automatically delete the visual object(s) from the data store.

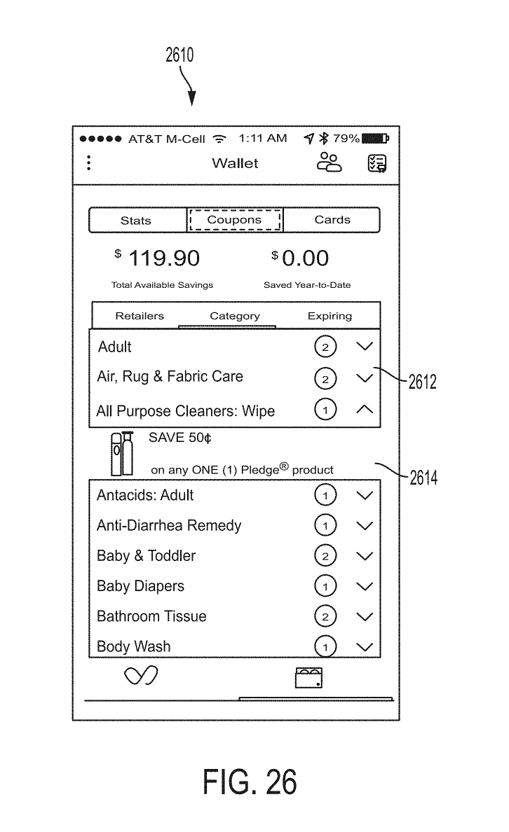

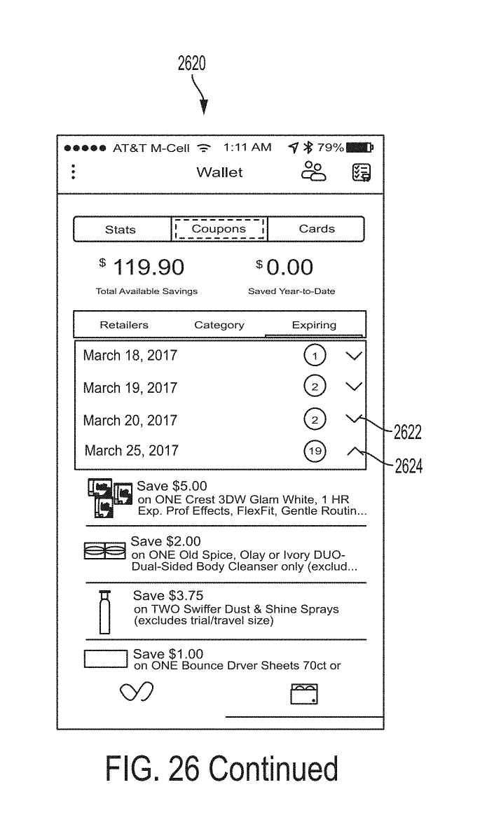

FIG. 26 shows user interface screens 2610 and 2620 of visual objects stored in the user's data store organized and displayed according to different features than the user interface screens 2510, 2520, and 2530. For example, the user interface screen 2610 shows a list of visual objects 2612 in the data store organized by a category of the visual objects. In some embodiments, the user interface screen 2610 can be configured to display category values of visual objects in the data store. The user interface screen 2610 can be configured to display one or more visual objects having the category in response to a user input. For example, the user interface screen 2610 can provide a pull down selection that, when selected, causes the user interface screen 2610 to display one or more visual objects 2614 having the category value to appear on the screen.

User interface screen 2620 illustrates a display of visual objects in the data store organized by an expiration date. The expiration date can comprise a time (e.g., date) by which the visual object must be executed in order to modify an operation. The user interface screen 2620 can be configured to display a list 2622 of one or more expiration times (e.g. dates). In some embodiments, the user interface screen 2620 can be configured to provide a pull down menu. A user can select a particular expiration time and the user interface screen 2620, in turn, can be configured to display one or more visual objects 2624 that will expire at that time. In some embodiments, user interface screens 2610 and 2620 can provide an ability for a user to perform actions for visual objects (e.g., as described above with reference to FIG. 25).

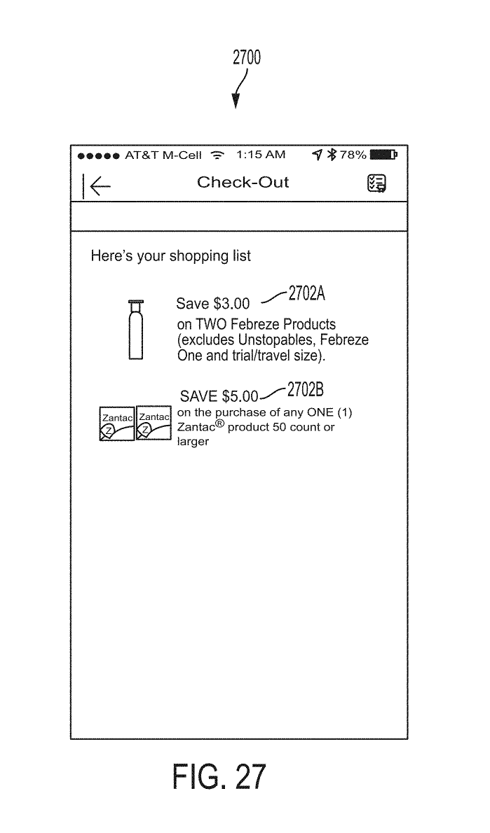

FIG. 27 illustrates a user interface screen 2700 displaying visual objects specially designated by a user. For example, the user interface screen 2700 can comprise a shopping list of one or more visual objects 2702A-B that the user intends to execute. In some embodiments, the system can be configured to specially designate a visual object in response to a user input. For example, a user input in a user interface screen displaying one or more visual objects stored in a data store of the user can trigger the system to special designate a visual object. In one example, the input can comprise a slide over the visual object to reveal an option to designate the visual object, and then a selection of the option. In some embodiments, the system can be configured to automatically remove a visual object from a collection of specially designated visual objects in response to execution of the visual object.

In some embodiments the system can be configured to allow users to perform operations within a user interface generated by the system. For example, the system can be configured to be communicatively coupled to one or more external computer systems such that a user can complete may with the external computer system(s) from within the user interface generated by the system. This may allow the user to perform actions without having to go outside of the visual object management system.

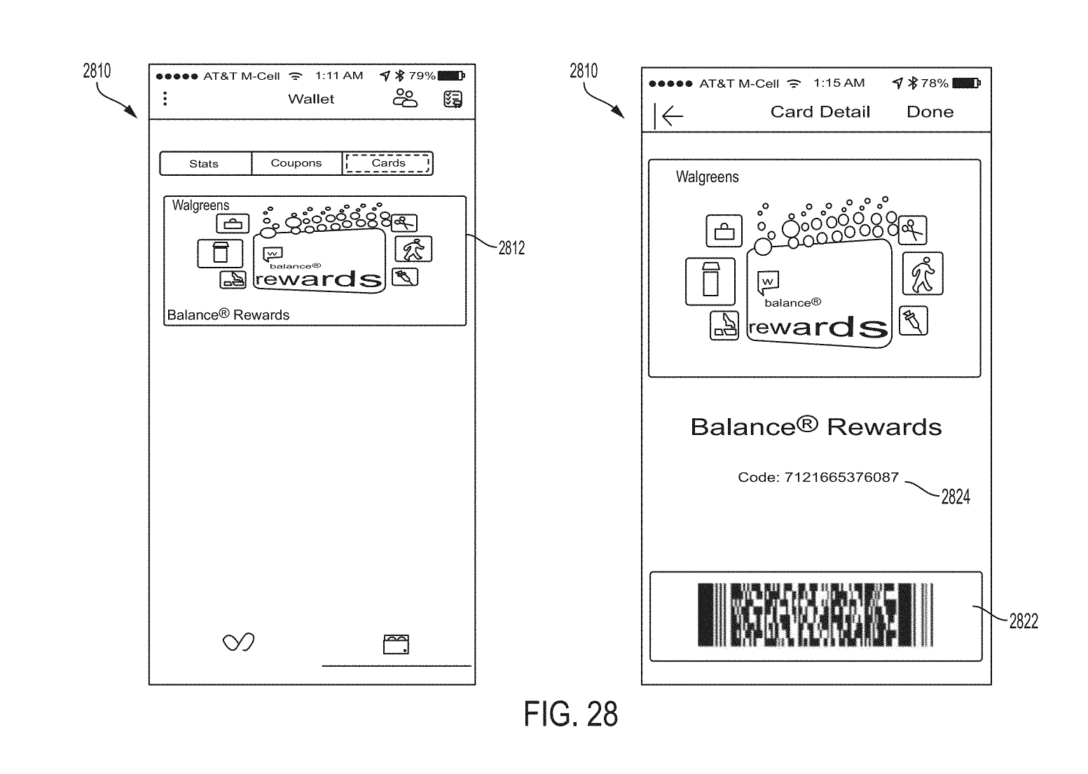

FIG. 28 illustrates user interface screens 2810 and 2820 for displaying identification information of data profiles that a user has with external computer systems. For example, the user interface screens 2810 and 2820 can be configured to display loyalty program membership information for one or more loyalty programs that the user is a member of. User interface screen 2810 can be configured to display visualizations 2812 of one or more memberships that that user has. For example, a user can have a membership to a Walgreen's loyalty program and the system can be configured to display a visualization of the membership in user interface screen 2810. In some embodiments, the system can be configured to present a selectable visualization. The system can receive a user selection of a presented visualization and, in response, display identification information associated with the data profile that the user has with the external computer system. In some embodiments, in response to receiving a selection of visualization 2812, the system can be configured to show specific information about the selected membership in user interface screen 2820. For example, the user interface 2820 can be configured to display an identification number 2824 and/or a bar code 2822 for the data profile. In some embodiments, the user can use the displayed information during an operation to trigger execution of one or more visual objects. For example, the user can scan a displayed bar code to allow an external computer system to apply visual objects associated with the data profile and/or the external computer system to an operation.

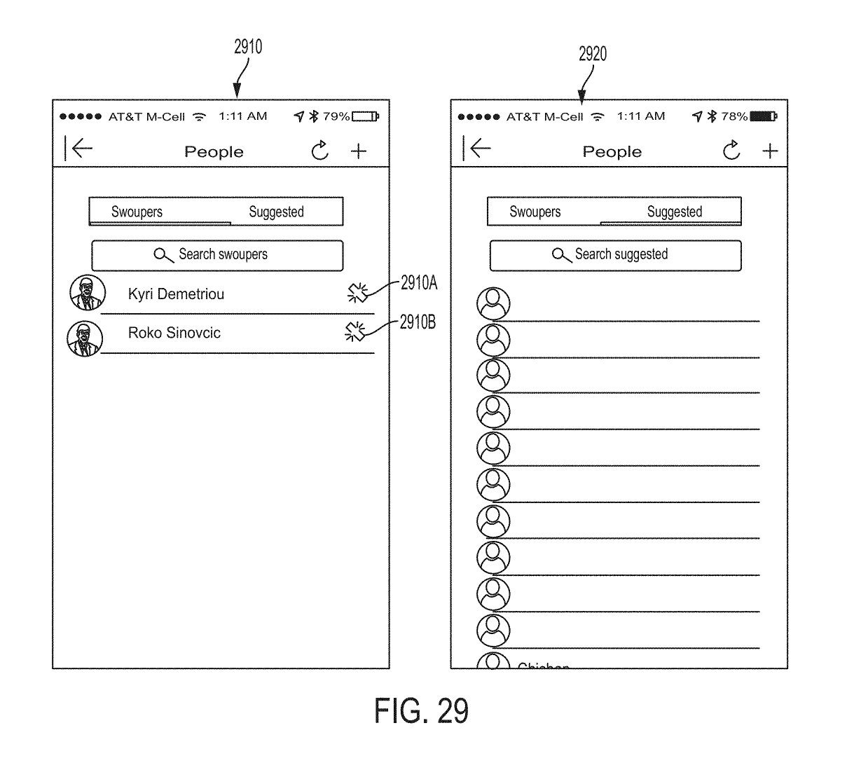

FIG. 29 illustrates user interface screens 2910 and 2920 for displaying information about one or more people associated with a user, in accordance with some embodiments of the technology described herein. User interface screen 2810 can be configured to display identifications 2910A-B of one or more people associated with the user who are also users of the visual object management system. For example, the people can be connected to the user via a social media system, be in a contacts list of the user, or be associated with the user in another manner. User interface screen 2820 can be configured to display identifications of one or more people associated with the user who are not users of the visual object management system. In some embodiments, the system can be configured to allow the user to communicate a message inviting the people to register with the system (e.g., as described above with reference to FIG. 24). In some embodiments, the system can be configured to display identifications of people not associated with the user as users to communicate visual objects to and/or as people to invite to use the system. For example, a machine learning system can be configured to identify correlated users and match them accordingly.

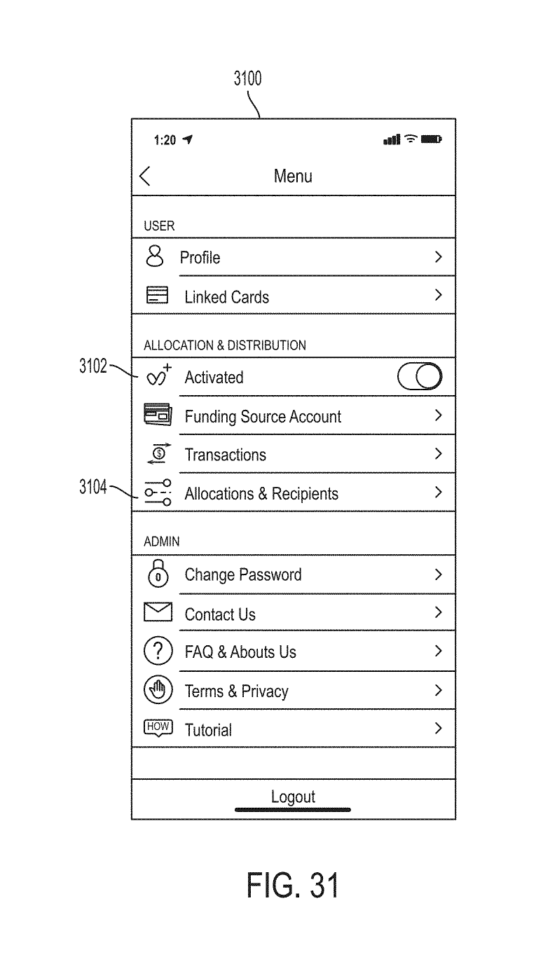

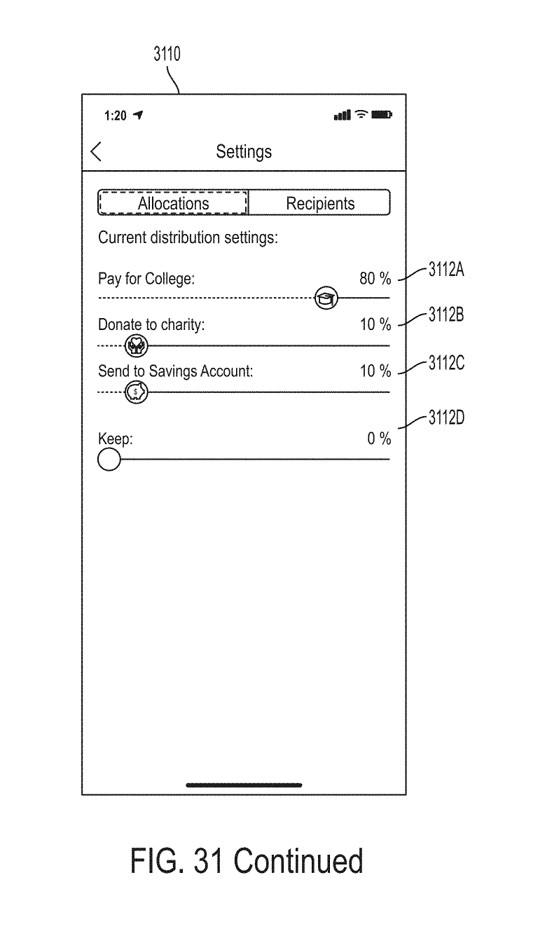

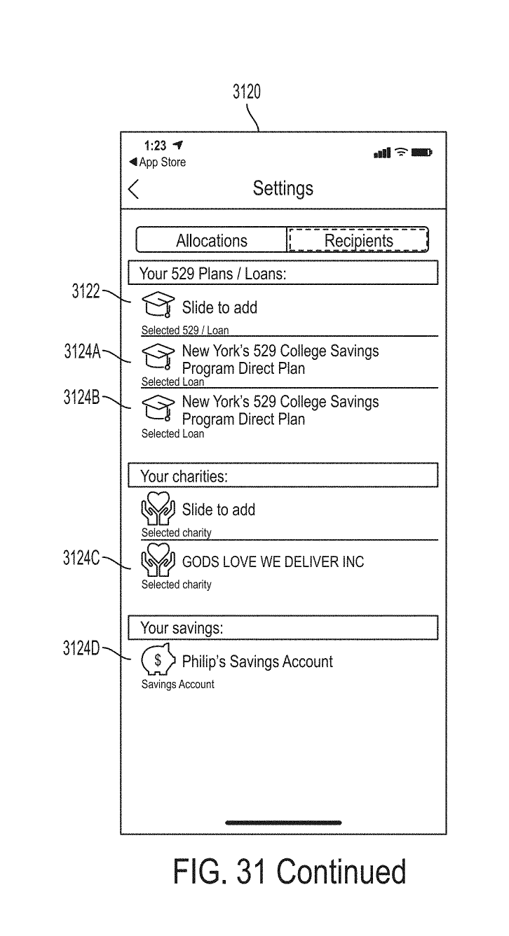

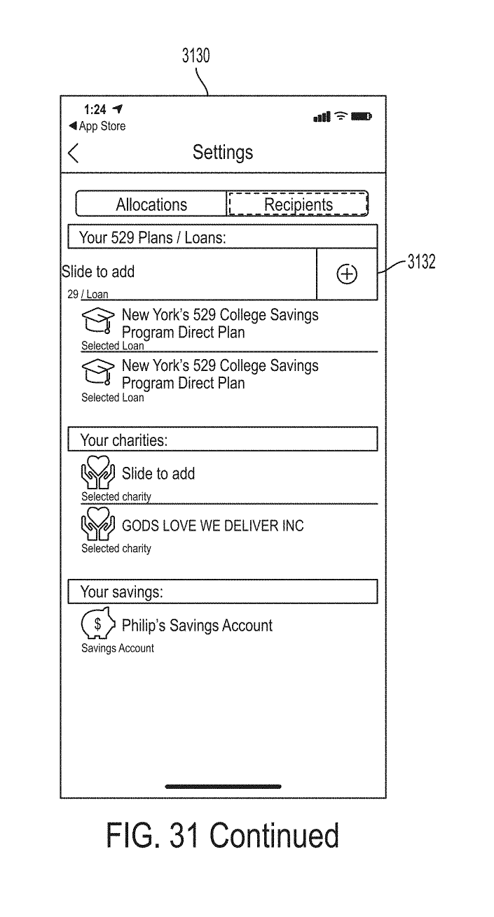

FIG. 31 illustrates user interface screens 3100, 3110, 3120, and 3130 for selecting recipients of portions of captured differences from operations and/or specifying an allocation of the portions of the captured differences, in accordance with some embodiments of the technology described herein. Some (e.g., all) of user interface screens 3100, 3110, 3120, and 3130 may be used by a system (e.g., visual object management system 110) for determining recipients and allocation of captured differences (e.g., in processes 200 and/or 300 described above with reference to FIGS. 2 and 3).

Screen 3100 illustrates a menu from which a user can access various options. In some embodiments, the user can access a selectable option 3102 by which the user can activate or de-activate transmission of captured recipients to one or more recipients. For example, the selectable option 3102 can comprise a user input that, when set to a first position, enables transmission of portions of a captured difference. When the selectable option 3102 is set to a second position, the system can be configured to stop transmission of portions of captured differences to recipients. In some embodiments, the screen 3102 can also be configured to provide an option 3104 which the user can select to reach one or more other user interface screens via which the user can specify recipients and allocations.

User interface screen 3110 is an example screen via which a system can receive user selections specifying allocation settings according to which the system can be configured to distribute portions of captured differences. In some embodiments, the user interface screen 3110 provides a plurality of inputs each associated with a recipient or category of recipient. For example, as illustrated in user interface screen 3110, the system provides options 3112A-D for a user to set allocations to each recipient. For example, the system provides an option for an allocation to pay for college 3112A, an allocation to donate to charity 3112B, an allocation to send to an account (e.g., a savings account) 3112C, and/or an allocation to keep 3112D. The system can be configured to receive a user input specifying an allocation to each of the recipients. For example, as shown in screen 3110, the input can comprise a sliding bar which the user can adjust to specify a particular percentage of a captured difference that is to be allocated to a respective recipient. Some embodiments are not limited to a particular method or user input mechanism. In some embodiments, the system can be configured to additionally or alternatively generate a user interface screen in which a user can enter (e.g., type in) allocations. Some embodiments can be configured to receive allocations in specific amounts (e.g., dollars). Some embodiments are not limited in the manner in which allocations are specified. Some embodiments are not limited to recipients illustrated in user interface screen 3110 as recipients and/or recipient categories can be added and/or removed.

User interface screen 3120 is an example user interface screen via which the system can be configured to receive specifications of specific recipients from a user, in accordance with some embodiments. The user interface screen 3120 can display one or more recipients 3124A-D that the user has already added and/or that the system has automatically added. For example, as shown in user interface screen 3120, the system displays college savings plans 3124A and 3124B selected as recipients, a charity recipient 3124C, and a savings account recipient 3124D. Some embodiments are not limited to any specific set of recipients or number of recipients. In some embodiments, the system can be configured to display recipients according to categories. For example, as shown in user interface screen 3120, the system can be configured to display plans/loans, charities, and/or savings accounts. Some embodiments are not limited to any set of categories of recipients. Categories of recipients can be added, modified, and/or removed.

In some embodiments, the system can provide a selectable option for adding additional recipients. As illustrated in user interface screen 3120, the system can provide an option 3122 to allow a user to add an additional recipient. For example, user input can comprise a slide action in response to which the system provides an option for a user to add a recipient. User interface screen 3130 illustrates an option 3132 for adding a recipient. In some embodiments, the option 3132 to add the recipient can appear in response to a user selection of the option 3122. For example, if the user slides over an area of the screen (e.g., slides from left to right, right to left, up to down), the system can be configured to reveal an option to add a recipient as shown in user interface screen 3130. Some embodiments are not limited in how the system receives selections of recipients. For example, in some embodiments, the system can be configured to additionally or alternatively provide a separate menu screen via which the user can add recipients. In some embodiments, the system can provide additional options. For example, the system can provide options to remove and/or modify recipients. Some embodiments are not limited in which options are provided with respect to recipients.

In some embodiments, the system can be configured to generate and/or present user interface screens in a computing device of a user for allocating and/or selecting recipients during a registration process. In some embodiments, the system can be configured to present user interface screens 3110 and/or 3120 during a registration process to receive allocation settings and recipient information. In some embodiments, the system can provide access to recipient settings via a menu as illustrated by user interface screen 3100. Some embodiments are not limited to when or how the system can be configured to provide access to recipient selection and/or allocation settings.

In some embodiments, aspects of the exemplary user interface screens described above can be implemented across different user interface screens described herein. A user interface screen is not limited to only those functions, displays, or other features described for the respective user interface screen. Features described with respect to different user interface screens than the respective user interface screen can be incorporated into the respective user interface screen.

According to various embodiments described herein, a visual object can comprise a digital object (e.g., a data structure) storing information about a modification to an operation and display information. In some embodiments, the operation can comprise an interaction between two or more computer systems for performing of the operation. In some embodiments, the visual object can comprise a data object storing information about a modification to an operation resulting from activation of the visual object. For example, a visual object can be configured to store modification information associated with a discount offer that modifies a price of one or more products during an operation to purchase the product. A discount offer can comprise a coupon, rebate, cash back, price match, points, and/or other types of offer. In some embodiments, the visual object, when activated, can be configured to apply a modification to an operation in accordance with the modification details. In some embodiments, the visual object can be configured to store identification information, information for matching the visual object to one or more users, description information about the visual object, and/or other information. For example, the visual object can be configured to store a unique ID, a name, a classification (e.g., a category), a semantic description, and/or values of one or more features of the visual object.

According to various embodiments described herein, an operation can comprise a transaction. For example, the operation can comprise a transaction between a user device and an online system to complete a purchase (e.g., for one or more products). In another example, the operation can comprise a transaction between a user device and a physical computer system (e.g., a point of sales computer system) to complete a purchase. In some embodiments, a visual object, when activated, can be configured to modify a transaction. For example, a visual object, when activated, can be configured to trigger modification of a price of one or more products during a transaction to purchase the product(s). In some embodiments, the system (e.g., visual object management system 110) can be configured to interact with one or more external computer systems during a transaction to trigger activation of one or more visual objects to modify execution of the transaction. For example, the system can be configured to trigger activation of the visual object(s) to modify a price of purchasing one or more products in the transaction. In some embodiments, a difference can comprise a difference in an amount to be paid in a transaction as a result of activation of one or more visual objects. For example, the difference can comprise a difference in price of one or more products purchased in a transaction resulting from activation of the visual object(s). In this example, transmission of a difference comprises transmitting of an amount of money saved (e.g., earned savings) as a result of activation of the visual object(s).

According to various embodiments described herein, a data profile of a user associated with an external computer system can comprise a membership of a user associated with the external computer system. For example, the data profile can comprise a membership of the user in a loyalty program for a specific retailer associated with the external computer system. In some embodiments, the data profile can comprise identification information for the user such as a unique identifier, name, address, retailer location, and/or other information. In some embodiments, the external system can be configured to store mappings of one or more visual objects (e.g., discount offers) to the data profile of the user. In some embodiments, the system can be configured to transmit information specifying the mappings to an external computer system to trigger activation of the visual object(s). In some embodiments, the data profile of the user can comprise an account associated with a credit card, a bank, a particular store, or other entity. Some embodiments are not limited to a specific type of data profile.

Various aspects and functions described herein may be implemented as specialized hardware or software components executing in one or more specialized computer systems. There are many examples of computer systems that are currently in use that could be specially programmed or specially configured. These examples include, among others, network appliances, personal computers, workstations, mainframes, networked clients, servers, media servers, application servers, database servers, and web servers. Other examples of computer systems may include mobile computing devices (e.g., smart phones, tablet computers, and personal digital assistants) and network equipment (e.g., load balancers, routers, and switches). Examples of particular models of mobile computing devices include iPhones, iPads, and iPod Touches running iOS operating systems available from Apple, Android devices like Samsung Galaxy Series, LG Nexus, and Motorola Droid X, Blackberry devices available from Blackberry Limited, and Windows Phone devices. Further, aspects may be located on a single computer system or may be distributed among a plurality of computer systems connected to one or more communications networks.

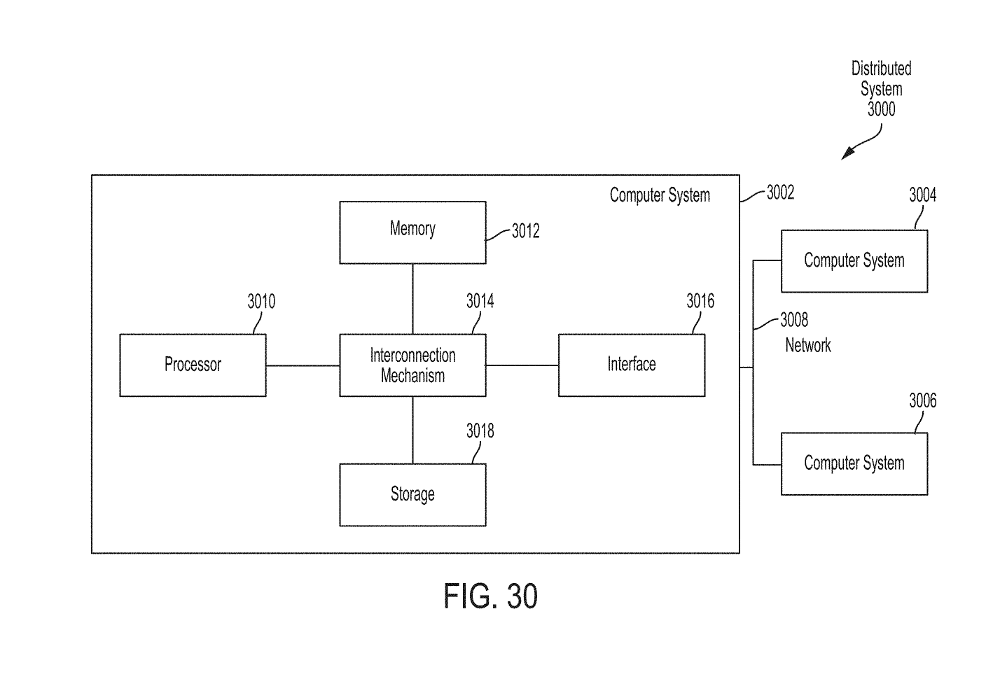

For example, various aspects, functions, and processes (e.g., presenting visual objects in a UI, adding, deleting or gifting visual objects responsive to UI actions, determining pre-offer price to charge, executing charges on pre-offer pricing, managing transfer of difference to third party providers (e.g., bank account, brokerage, charitable giving account, etc.), building AI models of users and/or preferences, filtering display selections based on modelling, etc.) may be distributed among one or more computer systems configured to provide a service to one or more client computers, or to perform an overall task as part of a distributed system, such as the distributed computer system 3000 shown in FIG. 30. Additionally, aspects may be performed on a client-server or multi-tier system that includes components distributed among one or more server systems that perform various functions. Consequently, embodiments are not limited to executing on any particular system or group of systems. Further, aspects, functions, and processes may be implemented in software, hardware or firmware, or any combination thereof. Thus, aspects, functions, and processes may be implemented within methods, acts, systems, system elements and components using a variety of hardware and software configurations, and examples are not limited to any particular distributed architecture, network, or communication protocol.

Referring to FIG. 30, there is illustrated a block diagram of a distributed computer system 3000, in which various aspects and functions are practiced. As shown, the distributed computer system 3000 includes one or more computer systems that exchange information. More specifically, the distributed computer system 3000 includes computer systems 3002, 3004, and 3006. As shown, the computer systems 3002, 3004, and 3006 are interconnected by, and may exchange data through, a communication network 3008. The network 3008 may include any communication network through which computer systems may exchange data. To exchange data using the network 3008, the computer systems 3002, 3004, and 3006 and the network 3008 may use various methods, protocols and standards, including, among others, Fiber Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST, and Web Services. To ensure data transfer is secure, the computer systems 3002, 3004, and 3006 may transmit data via the network 3008 using a variety of security measures including, for example, SSL or VPN technologies. While the distributed computer system 3000 illustrates three networked computer systems, the distributed computer system 3000 is not so limited and may include any number of computer systems and computing devices, networked using any medium and communication protocol.

As illustrated in FIG. 30, the computer system 3002 includes a processor 3010, a memory 3012, an interconnection element 3014, an interface 3016 and data storage element 3018. To implement at least some of the aspects, functions, and processes disclosed herein, the processor 3010 performs a series of instructions that result in manipulated data. The processor 3010 may be any type of processor, multiprocessor or controller. Example processors may include a commercially available processor such as an Intel Xeon, Itanium, Core, Celeron, or Pentium processor; an AMD Opteron processor; an Apple A4 or A5 processor; a Sun UltraSPARC processor; an IBM Power5+ processor; an IBM mainframe chip; or a quantum computer. The processor 3010 is connected to other system components, including one or more memory devices 3012, by the interconnection element 3014.

The memory 3012 stores programs (e.g., sequences of instructions coded to be executable by the processor 3010) and data during operation of the computer system 3002. Thus, the memory 3012 may be a relatively high performance, volatile, random access memory such as a dynamic random access memory (“DRAM”) or static memory (“SRAM”). However, the memory 3012 may include any device for storing data, such as a disk drive or other nonvolatile storage device. Various examples may organize the memory 3012 into particularized and, in some cases, unique structures to perform the functions disclosed herein. These data structures may be sized and organized to store values for particular data and types of data.

Components of the computer system 3002 are coupled by an interconnection element such as the interconnection mechanism 3014. The interconnection element 3014 may include any communication coupling between system components such as one or more physical busses in conformance with specialized or standard computing bus technologies such as IDE, SCSI, PCI and InfiniBand. The interconnection element 3014 enables communications, including instructions and data, to be exchanged between system components of the computer system 3002.

The computer system 3002 also includes one or more interface devices 3016 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 3002 to exchange information and to communicate with external entities, such as users and other systems.

The data storage element 3018 includes a computer readable and writeable nonvolatile, or non-transitory, data storage medium in which instructions are stored that define a program or other object that is executed by the processor 3010. The data storage element 3018 also may include information that is recorded, on or in, the medium, and that is processed by the processor 3010 during execution of the program. More specifically, the information may be stored in one or more data structures specifically configured to conserve storage space or increase data exchange performance. The instructions may be persistently stored as encoded signals, and the instructions may cause the processor 3010 to perform any of the functions described herein. The medium may, for example, be optical disk, magnetic disk or flash memory, among others. In operation, the processor 3010 or some other controller causes data to be read from the nonvolatile recording medium into another memory, such as the memory 3012, that allows for faster access to the information by the processor 3010 than does the storage medium included in the data storage element 3018. The memory may be located in the data storage element 3018 or in the memory 3012, however, the processor 3010 manipulates the data within the memory, and then copies the data to the storage medium associated with the data storage element 3018 after processing is completed. A variety of components may manage data movement between the storage medium and other memory elements and examples are not limited to particular data management components. Further, examples are not limited to a particular memory system or data storage system.

Although the computer system 3002 is shown by way of example as one type of computer system upon which various aspects and functions may be practiced, aspects and functions are not limited to being implemented on the computer system 3002 as shown in FIG. 30. Various aspects and functions may be practiced on one or more computers having a different architectures or components than that shown in FIG. 30. For instance, the computer system 3002 may include specially programmed, special-purpose hardware, such as an application-specific integrated circuit (“ASIC”) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 3002 may be a computer system including an operating system that manages at least a portion of the hardware elements included in the computer system 3002. In some examples, a processor or controller, such as the processor 3010, executes an operating system. Examples of a particular operating system that may be executed include a Windows-based operating system, such as, Windows NT, Windows 2000 (Windows ME), Windows XP, Windows Vista or Windows 7, 8, or 10 operating systems, available from the Microsoft Corporation, a MAC OS System X operating system or an iOS operating system available from Apple Computer, one of many Linux-based operating system distributions, for example, the Enterprise Linux operating system available from Red Hat Inc., a Solaris operating system available from Oracle Corporation, or a UNIX operating systems available from various sources. Many other operating systems may be used, and examples are not limited to any particular operating system.

The processor 3010 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, C# (C-Sharp), Python, or JavaScript. Other object-oriented programming languages may also be used. Alternatively, functional, scripting, or logical programming languages may be used.

Additionally, various aspects and functions may be implemented in a non-programmed environment. For example, documents created in HTML, XML or other formats, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user space application) or in a commonly shared data structure (such as an application registry that is defined by an operating system). In addition, some examples provide for both system and user interfaces that allow external entities to modify the parameters and thereby configure the behavior of the components.

Based on the foregoing disclosure, it should be apparent to one of ordinary skill in the art that the embodiments disclosed herein are not limited to a particular computer system platform, processor, operating system, network, or communication protocol. Also, it should be apparent that the embodiments disclosed herein are not limited to a specific architecture or programming language.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Use of at least one of and a list of elements (e.g., A, B, C) is intended to cover any one selection from A, B, C (e.g., A), any two selections from A, B, C (e.g., A and B), any three selections (e.g., A, B, C), etc., and any multiples of each selection.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A system comprising:
at least one processor;
an analytics component, executed by the at least one processor, configured to:
receive at least one user selection of at least one visual object displayed on a client device, wherein the at least one visual object is configured to:
detail a modification to an operation; and
trigger application of the modification to the operation responsive to being activated;
generate a model for identifying visual objects to display on the client device based on the at least one user selection;
an execution component, executed by the at least one processor, configured to:
map the selected at least one visual object to an operation between the client device and a first computer system to trigger activation of the at least one visual object;
receive, from the first computer system, operation data after the activation of the at least one visual object;
dynamically determine, using the operation data, a difference between an original execution of the operation and the modified execution of the operation; and
transmit, to a second computer system, program instructions that, when executed by the second computer system, trigger capturing of the difference based on the modified execution.

2. The system of claim 1, further comprising a user interface component, executed by the at least one processor, configured to:
generate a user interface screen on the display of the client device showing the at least one visual object; and
receive the at least one user selection via the user interface screen.

3. The system of claim 1, wherein the at least one processor is configured to store the at least one visual object in a data store responsive to receiving the at least one user selection.

4. The system of claim 1 further comprising a networking component, executed by the at least one processor, configured to:
receive, from the client device, a user input triggering communication of a visual object to a second user; and
communicating the visual object to a second client device responsive to receiving the request.

5. The system of claim 1, wherein the at least one processor is configured to receive a communication indicating a visual object communicated from a second client device.

6. The system of claim 1, wherein the at least one processor is configured to store an identification of a user data profile associated with the first computer system.

7. The system of claim 6, wherein the at least one processor is configured to store a mapping of the at least one visual object to the user data profile associated with the first computer system.

8. The system of claim 7, wherein mapping the selected at least one visual object to the operation to trigger activation of the at least one visual object comprises:
mapping the at least one visual object to the operation based on the stored mapping of the at least one visual object to the user data profile associated with the first computer system.

9. The system of claim 7, wherein the execution component is further configured to communicate, to the first computer system, information identifying the mapping of the at least one visual object to the user data profile associated with the first computer system.

10. At least one non-transitory computer readable medium storing processor-executable instructions, the instructions when executed by at least one processor cause the at least one processor to perform a method comprising:
receiving at least one user selection of at least one visual object displayed on a client device, wherein the at least one visual object is configured to:
detail a modification to an operation; and
trigger application of the modification to the operation responsive to being activated;
generating a model for identifying visual objects to display on the client device based on the at least one user selection;
mapping the selected at least one visual object to an operation between the client device and a first computer system to trigger activation of the at least one visual object;
receiving, from the first computer system, operation data after the activation of the at least one visual object;
dynamically determining, using the operation data, a difference between an original execution of the operation and the modified execution of the operation; and
transmitting, to a second computer system, program instructions that, when executed by the second computer system, trigger capturing of the difference based on the modified execution.

11. The method according to claim 10, further comprising:
storing an identification of a user data profile associated with the first computer system.

12. The method according to claim 11, further comprising:
storing a mapping of the at least one visual object to the identification of the user data profile associated with the first computer system.

13. The method according to claim 12, wherein mapping the selected at least one visual object to the operation to trigger activation of the at least one visual object comprises:
mapping the at least one visual object to the operation based on the stored mapping of the at least one visual object to the user data profile associated with the first computer system.

14. The method according to claim 12, further comprising communicating, to the first computer system, information identifying the mapping of the at least one visual object to the user data profile associated with the first computer system.

15. A computer-implemented method comprising:
receiving at least one user selection of at least one visual object displayed on a client device, wherein the at least one visual object is configured to:
detail a modification to an operation; and
trigger application of the modification to the operation responsive to being activated;
generating a model for identifying visual objects to display on the client device based on the at least one user selection;
mapping the selected at least one visual object to an operation between the client device and a first computer system to trigger activation of the at least one visual object;
receiving, from the first computer system, operation data after the activation of the at least one visual object;
dynamically determining, using the operation data, a difference between an original execution of the operation and the modified execution of the operation; and
transmitting, to a second computer system, program instructions that, when executed by the second computer system, trigger capturing of the difference based on the modified execution.

16. The method according to claim 15, further comprising:
storing an identification of a user data profile associated with the first computer system.

17. The method according to claim 16, further comprising:
storing a mapping of the at least one visual object to the identification of the user data profile associated with the first computer system.

18. The method according to claim 17, wherein mapping the selected at least one visual object to the operation to trigger activation of the at least one visual object comprises:
mapping the at least one visual object to the operation based on the stored mapping of the at least one visual object to the user data profile associated with the first computer system.

19. The method according to claim 17, further comprising communicating, to the first computer system, information identifying the mapping of the at least one visual object to the user data profile associated with the first computer system.

20. The method according to claim 15, further comprising:
generating a user interface screen on a display of the client device showing the at least one visual object; and
receiving the at least one user selection via the user interface screen.
